(19) United States
(12) Patent Application Publication
(10) Pub. No.: US 2011/0128478 A1
(43) Pub. Date: Jun. 2, 2011

(54) POLARIZING PLATE, LIQUID CRYSTAL DISPLAY, AND METHOD OF MANUFACTURING PROTECTIVE FILM FOR POLARIZING PLATE

(75) Inventor: Rumiko Yamada, Tokyo (JP)

(73) Assignee: KONICA MINOLTA OPTO, INC., Tokyo (JP)

(21) Appl. No.: 12/999,049

(22) PCT Filed: Jun. 8, 2009
(86) PCT No.: PCT/JP2009/060442

§ 371 Date: Dec. 14, 2010

(30) Foreign Application Priority Data
Jun. 18, 2008 (JP) 2008-158930

(51) Int. Cl. G02F 1/1335; G02B 5/30; G02B 1/08

(52) U.S. Cl. 349/96; 359/492.01; 264/1.34

(57) ABSTRACT

Provided is a polarizing plate which is free from occurrence of cloudy unevenness appearing blurry on a screen of a liquid crystal display under heat and humidity conditions. The polarizing plate of the invention is characterized in that it comprises a first protective film, a second protective film and a polarizer sandwiched between the first and second protective films, wherein the first protective film is a laminated film composed of a cellulose ester resin layer (A) and an acryl resin layer (B), the cellulose ester resin layer (A) being a layer containing from 55 to 99% by mass of a cellulose ester resin and from 1 to 45% by mass of an acryl resin, provided that the total content of the cellulose ester resin and the acryl resin in the cellulose ester resin layer (A) is 100% by mass, and the acryl resin layer (B) being a layer containing from 1 to 45% by mass of a cellulose ester resin and from 55 to 99% by mass of an acryl resin, and wherein the second protective film contains a cellulose ester resin and a retardation adjusting agent, the cellulose ester resin layer (A) facing the polarizer.

### FIELD OF THE INVENTION

This invention relates to a polarizing plate, a liquid crystal display, and a method of manufacturing a protective film for a polarizing plate, and particularly to a polarizing plate which is does not produce cloudy unevenness appearing blurred on the screen of a liquid crystal display under heat and humidity conditions.

### TECHNICAL BACKGROUND

A polarizing plate employing a cellulose ester film as the protective film is advantageous, since direct lamination can be carried out due to saponification of the cellulose ester film, which reduces the manufacturing process number of the polarizing plate.

An optical compensation sheet for VA use requires a retardation in plane (Ro) of from 30 to 200 nm and a retardation in the thickness direction (Rth) of from 70 to 400 nm. Examples adding a disc-shaped compound or a rod-shaped compound as a retardation developing agent are disclosed in Patent Document 1 described later.

However, when a cellulose ester film, prepared from a cellulose ester containing a retardation adjusting agent according to a conventional solution casting method, is used as the protective film of a polarizing plate, there is problem that cloudy unevenness appearing blurred occurs on the screen of a liquid crystal display. A countermeasure to solve this problem has been desired. Particularly, a polarizing plate employing a resin with high degree of moisture permeation such as cellulose ester on both sides of a polarizer prominently produces the unevenness as above-described, since it is greatly influenced by ambient heat and humidity.

### PRIOR ART

### Patent Documents

Patent Document 1: Japanese Patent O.P.I. Publication No. 2008-505195

### DISCLOSURE OF THE INVENTION

### Problems to be Solved by the Invention

In view of the above, a main object of the invention is to provide a polarizing plate which is free from occurrence of cloudy unevenness appearing blurred on the screen of a liquid crystal display under heat and humidity conditions.

### Means for Solving the Above Problems

The above object of the invention can be attained by any one of the following constitutions.

1. A polarizing plate comprising a first protective film, a second protective film and a polarizer sandwiched between the first and second protective films, wherein the first protective film is a laminated film composed of a cellulose ester resin layer (A) and an acryl resin layer (B), the cellulose ester resin layer (A) being a layer containing from 55 to 99% by mass of a cellulose ester resin and from 1 to 45% by mass of an acryl resin, provided that the total content of the cellulose ester resin and the acryl resin in the cellulose ester resin layer (A) is 100% by mass, and the acryl resin layer (B) being a layer containing from 1 to 45% by mass of a cellulose ester resin and from 55 to 99% by mass of an acryl resin, provided that the total content of the cellulose ester resin and the acryl resin in the cellulose ester resin layer (B) is 100% by mass, and wherein the second protective film contains a cellulose ester resin and a retardation adjusting agent, the cellulose ester resin layer (A) facing the polarizer.

2. A liquid crystal display, wherein the polarizing plate of item 1 above is provided on a liquid crystal cell, so that the second protective film of the polarizing plate faces the liquid crystal cell.

3. A method of manufacturing a protective film for a polarizing plate wherein the first and second protective films of the polarizing plate of item 1 above are manufactured according to a melt casting method.

### Effects of the Invention

The present invention can provide a polarizing plate which is free from occurrence of cloudy unevenness appearing blurred on the screen of a liquid crystal display under heat and humidity conditions.

### BRIEF EXPLANATION OF THE DRAWINGS

FIG. 1 is a schematic flow sheet showing one embodiment of an apparatus for carrying out a manufacturing method of the protective film in the invention.

FIG. 2 is a drawing in which the section from dice to cooling rollers is enlarged.

FIG. 3 is a schematic view of a preferred co-extrusion die melt casting film formation apparatus in the invention.

FIG. 4 is a schematic view of another preferred co-extrusion die melt casting film formation apparatus in the invention.

FIG. 5 is a schematic view of a die having a feed block.

FIG. 6 is a schematic view of a multi-manifold die.

FIG. 7 is a drawing of another embodiment of pulling a melted film.

### PREFERRED EMBODIMENT OF THE INVENTION

Next, the preferred embodiment of the present invention will be explained in detail, but the invention is not specifically limited thereto.

The polarizing plate of the invention is featured in that it comprises a first protective film, a second protective film and a polarizer sandwiched between the first and second protective films, wherein the first protective film is a laminated film composed of a cellulose ester resin layer (A) and an acryl resin layer (B), the cellulose ester resin layer (A) being a layer containing from 55 to 99% by mass of a cellulose ester resin and from 1 to 45% by mass of an acryl resin, provided that the total content of the cellulose ester resin and the acryl resin in the cellulose ester resin layer (A) is 100% by mass, and the acryl resin layer (B) being a layer containing from 1 to 45% by mass of a cellulose ester resin and from 55 to 99% by mass of an acryl resin, provided that the total content of the cellulose ester resin and the acryl resin in the cellulose ester resin layer (B) is 100% by mass; and wherein the second protective film contains a cellulose ester resin and a retardation adjusting agent, the cellulose ester resin layer (A) facing the polarizer.

The present inventor has found that a polarizing plate has the following problem which comprises a first protective film, a second protective film and a polarizer sandwiched between the first protective film and the second protective film, wherein the first protective film is a cellulose ester film which is greatly influenced by ambient heat and humidity and the second protective film is a cellulose ester film containing a retardation adjusting agent manufactured according to a conventional solution casting method. The distribution of a retardation adjusting agent in the film produced due to stress applied during film formation or film drying is enlarged due to stress generated due to dimensional change of a polarizing plate employing the film under ambient heat and humidity conditions, resulting in occurrence of cloudy unevenness appearing blurred on the screen of a liquid crystal display.

The present inventor has found that it is possible to manufacture a polarizing plate comprising a first protective film, a second protective film and a polarizer sandwiched between the first and second protective films, wherein the first protective film is a laminated film composed of a cellulose ester resin layer (A) and an acryl resin layer (B) and the second protective film contains a retardation adjusting agent, by providing the first protective film on the polarizer so that the cellulose ester resin layer (A) faces the polarizer, the polarizing plate being little affected by heat and humidity and being free from occurrence of cloudy unevenness appearing blurred on the screen of a liquid crystal display, and has completed the invention. It is possible that the cellulose ester resin (A) to be applied onto the polarizer is given saponification property.

Further, it has been found that it is preferable to manufacture the first protective film by a melt casting method in which a melt cellulose ester resin composition and a melt acryl resin composition are co-extruded to form a laminated film composed of a cellulose ester resin layer (A) and an acryl resin layer (B), and to manufacture the second protective film by a melt casting method which excels in homogeneous distribution of a retardation adjusting agent therein.

Next, the present invention will be explained.

### <<First Protective Film>>

The first protective film in the invention is preferably a protective film which is a laminated film composed of a cellulose ester resin layer (A) and an acryl resin layer (B) formed by co-extrusion of a melt cellulose ester resin composition and a melt acryl resin composition. The first protective film is a laminated melt cast film comprising a cellulose ester resin layer (A) containing from 55 to 99% by mass of a cellulose ester resin and from 1 to 45% by mass of an acryl resin, provided that the total content of the cellulose ester resin and the acryl resin in the cellulose ester resin layer (A) is 100% by mass, and an acryl resin layer (B) containing from 1 to 45% by mass of a cellulose ester resin and from 55 to 99% by mass of an acryl resin, provided that the total content of the cellulose ester resin and the acryl resin in the cellulose ester resin layer (B) is 100% by mass.

Firstly, the acryl resin layer (B) will be explained.

### <Acryl Resin Layer (B)>

When the total content of a cellulose ester resin and an acryl resin in the cellulose ester resin layer (B) is 100% by mass, the content of the acryl resin in the cellulose ester resin layer (B) is from 55 to 99% by mass, and preferably from 60 to 99% by mass, and the content of the cellulose ester resin in the cellulose ester resin layer (B) is from 1 to 45% by mass, and preferably from 1 to 40% by mass.

The layer having a higher acryl resin content suppresses the dimensional change under higher temperature and higher humidity, and when used in a polarizing plate, does not produces cloudy unevenness appearing blurred and further markedly reduces the curling or warping of a panel. Such a layer can maintain the above-described characteristics for a long term. The layer having an acryl resin content less than 55% by mass, when used in a polarizing plate, produces cloudy unevenness appearing blurred and light leakage, and lowers anti-curling property and flatness. In contrast, the layer having an acryl resin content more than 99% by mass lowers adhesion at the interface between the laminated layers and lowers flatness as a film. Accordingly, it is effective that the acryl resin content is within the range as described above.

It is preferred that the acryl resin layer (B) in the invention is provided on the viewer side of the polarizing plate or on the backlight side of the polarizing plate.

In the invention, ductile fracture, which is caused when a stress stronger than the strength of a material is applied to the material, is defined as fracture accompanying marked elongation or contraction of the material before reaching final rupture. The fracture surface characteristically forms thereon a number of dents, called dimples.

Therefore, “an acryl resin layer causing no ductile fracture” has a feature that even when large stress is applied to the layer so as to bend the layer double, no fracture is observed.

Taking into account the use under an environment of high temperature, the tension softening point of the acryl resin layer (B) is controlled so as to fall within a range of preferably from 110 to 145° C., and more preferably from 120 to 140° C.

The glass transition temperature (Tg) of the acryl resin layer (B) in the invention is preferably not less than 110° C., more preferably not less than 120° C., and still more preferably not less than 150° C.

In the invention, the glass transition temperature refers to a midpoint glass transition temperature (Tmg), which is measured by using a scanning differential calorimeter (Type DSC-7, produced by Perkin Elmer Co.) at a temperature-increasing rate of 20° C./min in accordance with JIS K7121 (1987).

In the acryl resin layer (B) in the invention, the number of defects having a diameter of 5 μm or more within the layer surface is preferably not more than 1 defect/10 cm-square, more preferably not more than 0.5 defect/10 cm square, and still more preferably not more than 0.1 defect/10 cm square.

Herein, when the defect is a circle, the diameter of the defect refers to the diameter of the circle, and when the defect is not a circle, the range of the defect microscopically observed and determined according to the following procedure and the maximum diameter (circumscribed circle diameter) is defined as the diameter of the defect.

When the defect is a bubble or foreign matter, the range of the defect is the size of the shadow when observing the defect by a differential interference microscope.

When the defect is a change in the surface form such as transfer of a flaw on a roll or an abrasion mark, such a defect is observed by refection light of a differential interference microscope to confirm its size.

When the size of a defect observed with reflection light is not clear, aluminum or platinum is vapor-deposited on the defect surface and observed.

In order to obtain a layer with high quality as is represented by the defect frequency as described above, it is effective to filter a resin solution with high precision immediately before being cast, to raise cleanness of the surroundings of a casting apparatus, or to set stepwise drying conditions after being cast to carry out drying efficiently while minimizing foaming.

When the number of defects is more than 1 defect/10 cm square, for example, when tension is applied to a film in processing at the post step, the film is ruptured from the defect as a base point, often resulting in markedly reduced productivity.

A defect with a diameter of not less than 5 μm can be visually observed by using a polarizing plate, which may form a brightening point when used as an optical unit.

Even when being not visually observed, uniform coating sometimes is not achieved, resulting in a defect (coating defect) when forming a hard coat layer on the film.

The acryl resin layer (B) in the invention has a fracture elongation in at least one direction of preferably 10% or more, and more preferably 20% or more, the fracture elongation being determined in accordance with JIS K7127 1999.

The upper limit of the fracture elongation is not specifically limited but is practically about 250%. In order to increase the fracture elongation, it is effective to minimize defects in the layer resulting from foreign matter or foams.

The thickness of the acryl resin layer (B) of the first protective film in the invention is preferably not less than 5 μm and more preferably not less than 30 μm, and is preferably not more than 100 μm from the economical point of view.

The thickness of the film can be appropriately chosen in accordance with its use.

The acryl resin layer (B) in the invention alone has a total light transmittance of preferably not less than 90% and more preferably not less than 93%. The real upper limit thereof is approximately 99%. To realize an excellent transparency represented by such a total light transmittance, it is effective that any additive or copolymerization component which absorbs visible light is not incorporated or foreign matter contained in a polymer is removed by precise filtration thereby minimizing light diffusion or absorption within the film.

The haze value of the acryl resin layer (B) in the invention, which is regarded as a measure of transparency, is preferably less than 2.0%, and more preferably not more than 0.5% in terms of luminance or contrast when built in a liquid crystal display.

To achieve such a haze value, it is effective that foreign matter in the resin is removed by highly precise filtration to minimize light diffusion within the film.

The total light transmittance and haze value of the acryl resin layer (B) are measured in accordance with JIS K 7361-1-1997 and JIS K 7136-2000.

The acryl resin layer (B) can contain a third resin other than acryl resin or cellulose ester, and the third resin is preferably resin (D) having an Abbe number of from 30 to 60.

### <Acryl Resin>

An acryl resin usable in the invention includes a methacryl resin. The methacryl resin is preferably one comprising 50 to 99% by mass of a methyl methacrylate unit and 1 to 50% by mass of another copolymerizable monomer unit.

Examples of another copolymerizable monomer include an alkyl methacrylate in which the alkyl has a carbon atom number of 2 to 18; an alkyl acrylate in which the alkyl group has a carbon atom number of 1 to 18 carbon atoms; an α,β-unsaturated acid such as acrylic acid or methacrylic acid; an unsaturated group-containing bicarboxylic acid such as maleic acid, fumaric acid or itaconic acid; an aromatic vinyl compound such as styrene, α-methylstyrene or a nucleus-substituted styrene; an α,β-unsaturated nitrile such as acrylonitrile or methacrylonitrile; maleic acid anhydride; maleimide; an N-substituted maleimide; and glutaric acid anhydride. These may be used singly or in combination.

Of these, methyl acrylate, ethyl acrylate, n-propyl acrylate, n-butyl acrylate, s-butyl acrylate or 2-ethylhexyl acrylate is preferred; and methyl acrylate or n-butyl acrylate is especially preferred.

The acryl resin used for the acryl resin layer (B) in the invention has a weight average molecular weight (Mw) of preferably 80000 to 1000000, and more preferably 100000 to 280000 in terms of mechanical strength as a film and control of fluidity or viscosity during film manufacture.

The weight average molecular weight of the acryl resin used in the invention can be measured according to gel permeation chromatography. The measurement conditions are as follows:

Solvent: Methylene chloride
Column: Three columns of Shodex K806 K805, K803G (made by Showa Denko Co., Ltd.) were connected.
Column temperature: 25° C.
Sample concentration: 0.1% by mass
Detector: RI Model 504 (made by GL Science Co.)
Pump: L6000 (made by Hitachi Seisakusho Co., Ltd.)
Flow rate: 1.0 ml/min
Calibration curve: A calibration curve was employed which was prepared from 13 samples of standard polystyrenes (standard polystyrene STK made by TOSO Co., Ltd.) having an Mw of from 500 to 2,800. It is preferred that the 13 samples had substantially the same molecular weight interval.

A production method of the acryl resin is not specifically limited, and known methods known such as a suspension polymerization, an emulsion polymerization, a block polymerization and a solution polymerization can be employed. As a polymerization initiator, a conventional peroxide or azo type initiator or a redox type initiator can be employed.

With respect to polymerization temperature, the suspension or emulsion polymerization is carried out at a temperature of from 30 to 100° C., and the block or solution polymerization is carried out at a temperature of from 80 to 160° C. In order to control the reduction viscosity of a copolymer produced, polymerization can be conducted using a chain transfer agent such as an alkylmercaptan.

The molecular weight range described above can secure compatibility of heat resistance and brittleness.

The acryl resin in the invention may be a commercially available one. Examples thereof include Delpet 60N, 80N (made by Asahi Chemical Industry Co., Ltd.), Dianal BR52, BR80, BR83, BR85, BR88 (made by Mitsubishi Rayon Co., Ltd.) and KT75 (made by Denki Kagaku Kogyo Co., Ltd.).

In the acryl resin layer (B), one or more kinds of acryl resins may be used. It is preferred that the weight average molecular weight of any of the acryl resins used is within the range from 80000 to 1000000.

It is preferred that the acryl resin layer (B) alone satisfies the following formulae (i) to (iv), and has a tension softening point of 105 to 145° C. and a photoelastic coefficient of −5.0×10⁻⁸ to 8.0×10⁻⁸ cm²/N.

|Rₒ(590)|≦10 nm (i)

|Rₜₕ(590)|≦20 nm (ii)

|Rₒ(480)−Rₒ(630)|≦5 nm (iii)

|Rₜₕ(480)−Rₜₕ(630)|≦10 nm (iv)

in which Rₒ=(nx−ny)×d and Rₜₕ=[(nx+ny)/2−nz]×d, wherein nx represents a refractive index in-plane in the direction of the slow phase axis of the film, ny represents a refractive index in-plane in the direction perpendicular to the slow phase axis, nz represents a refractive index in the direction of thickness, and d represents a thickness of the film; and numerical values 590, 480 and 630 in parentheses represent the wavelength (nm) of light used for measurement of birefringence, respectively. That is, it is preferred that acryl resin used in the acryl resin layer (B) removes birefringency as far as possible and does not have wavelength dispersion of birefringence.

### <Cellulose Ester Resin (Also Referred to as Cellulose Ester)>

Cellulose has three hydroxyl groups in total in one glucose unit, having a hydroxyl group at each of 2-, 3- and 6-positions of the glucose unit, and the total substitution degree means a value indicating how many acyl groups are bonded to one glucose unit on average. Accordingly, the maximum substitution degree is 3.0. A hydroxyl group ordinarily exists at a position of the cellulose which is not substituted with an acyl group. A cellulose, in which all or a part of the hydroxyl groups are substituted with an acyl group, is called cellulose ester. The substitution degree of the acyl group can be determined according to a method specified in ASTM-D817.

The cellulose ester in the acryl resin layer (B) is preferably a cellulose ester in which when X represents the sum of the average substitution degree of an acetyl group at each of the 2-, 3- and 6 positions and Y represents the sum of the average substitution degree of an acyl group with a carbon atom number of from 3 to 5 at each of the 2-, 3- and 6 positions, the following inequalities (1), (2) and (3) are simultaneously satisfied. (Hereinafter, average substitution degree also referred to simply as substitution degree.)

2.40≦X+Y≦3.00 Inequality (1)

0≦X≦2.40 Inequality (2)

0.10≦Y≦3.00 Inequality (3)

In inequalities above, X represents the average substitution degree of an acetyl group in the 2-, 3- and 6-positions, and Y represents the sum of the average substitution degree of an acyl group with a carbon atom number of from 3 to 5 in the 2-, 3- and 6-positions.

The cellulose ester is preferably one satisfying the inequalities 1.00≦X≦2.20 and 0.50≦Y≦2.00, and more preferably one satisfying the inequalities 1.20≦X≦2.00 and 0.70≦Y≦1.70.

Y is preferably a butyryl group and more preferably a propionyl group in that the advantageous effects of the invention are obtained and stretching treatment is easily carried out.

Cellulose which is a raw material for the cellulose ester may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100, 80:10:10, 85:0:15, and 40:30:30.

The cellulose ester can be synthesized according to a conventional method. The cellulose ester can be obtained, The cellulose ester can be obtained, for example, by substituting the hydroxyl group of the material cellulose by the acetic anhydride, anhydrous propionic acid and/or anhydrous butyric acid according to the normal method in such a way that the acetyl group, propionyl group and/or butyl group are kept within the aforementioned range. Employing the method as described above, the cellulose ester in the invention satisfying the formulae (1) through (3) above can be synthesized. There is no restriction to the method of synthesizing such a cellulose ester. For example, it can be synthesized by using the method disclosed in Japanese Patent O.P.I. Publication Nos. 10-45804 and 6-501040.

The weight average molecular weight of the cellulose ester, although not specifically limited, is preferably from 100000 to 400000, more preferably from 150000 to 300000, and still more preferably from 180000 to 300000.

Further, the ratio, the weight average molecular weight (Mw)/the number average molecular weight (Mn) of the cellulose ester used in the invention is preferably from 1.3 to 5.5, more preferably from 1.5 to 5.0, still more preferably from 1.7 to 4.0, and further still more preferably from 2.0 to 3.5. The Mw/Mn ratio exceeding 5.5 increases viscosity and tends to lower melt filtration property, which is undesired. It is preferred in view of industrial productivity that the Mw/Mn ratio is preferably 1.3 or more.

Mw and Mw/Mn can be obtained according to gel permeation chromatography (GPC) as follows.

The measurement conditions are as follows:

Solvent: Methylene chloride
Column: Three columns of Shodex K806 K805, K803G (made by Showa Denko Co., Ltd.) were connected.
Column temperature: 25° C.
Sample concentration: 0.1% by mass
Detector: RI Model 504 (made by GL Science Co.)
Pump: L6000 (made by Hitachi Seisakusho Co., Ltd.)
Flow rate: 1.0 ml/min
Calibration curve: A calibration curve was employed which was prepared from 13 samples of standard polystyrenes (standard polystyrene STK made by TOSO Co., Ltd.) having an Mw of from 500 to 2,800. It is preferred that the 13 samples had substantially the same molecular weight interval.

The content of an alkali earth metal in the cellulose ester in the invention is preferably from 1 to 50 ppm.

The content of an alkali earth metal in the cellulose ester of from 1 to 50 ppm minimizes increase in lip stains and prevents breakage at the slitting process during or after thermal stretching, which is preferred in that the advantageous effects of the invention are exhibited more efficiently. Further, the content of an alkali earth metal in the cellulose ester is more preferably from 1 to 30 ppm. The alkali earth metal content herein refers a total amount of calcium and magnesium, which can be measured by employing X ray photoelectron spectrometric analysis (XPS).

The amount of the residual sulfuric acid contained in the cellulose ester is 0.1 to 45 ppm in terms of the sulfur element. They are considered to be included as salts. The amount of the residual sulfuric acid contained therein of not less than 45 ppm tends to increase depositions on the die lip during heat-melting and to break a formed film during thermal stretching or slitting after thermal stretching. Therefore, Further, the residual sulfuric acid content of the cellulose ester is preferably in the range of 1 from to 30 ppm. The residual sulfuric acid content can be measured according to a method prescribed in ASTM-D817-96.

The content of the free acid in the cellulose ester is preferably 1 to 500 ppm. The above content range of the free acid in the cellulose ester minimizes increase in lip stains and prevents breakage. The free acid content is more preferably from 1 to 100 ppm, which further prevents breakage. The free acid content is still more preferably from 1 to 7 0 ppm. The content of free acid can be measured according to a method prescribed in ASTM-D817-96.

When the synthesized cellulose ester is washed more sufficiently than in the solution casting method, the content in the cellulose ester of the residual alkali earth metal, sulfuric acid or acid can be kept within the aforementioned range which is preferred.

Further, washing of the cellulose ester can be carried out using water, a poor solvent such as methanol or ethanol, or using a mixture of a poor solvent and a good solvent if it forms a poor solvent as a result. This washing can remove inorganic substances other than residual acid, and low-molecular organic impurities.

Furthermore, washing of the cellulose ester is carried out preferably in the presence of a deterioration preventing agent. This will improve the heat resistance and film formation stability of the cellulose ester.

The deterioration preventing agent can be used without any limitations as long as it is one which inactivates radicals produced in the cellulose ester or prevents deterioration of the cellulose ester resulting from addition of oxygen to the radicals produced in the cellulose ester. The deterioration preventing agent is preferably a hindered phenol compound, a hindered amine compound or a phosphor compound.

In order to improve the heat resistance, mechanical property and optical property of cellulose ester, a cellulose ester solution, in which the cellulose ester is dissolved in a good solvent, is re-precipitated in a poor solvent and filtered or cellulose ester is suspended in a poor solvent while stirring and filtered, thereby removing the low molecular weight components and other impurities in the cellulose ester. This process is preferably carried out in the presence of the deterioration preventing agent in the same manner as in washing as above. The deterioration preventing agent may remain in the cellulose ester after the washing. The residual content of the deterioration preventing agent in the cellulose ester is suitably from 0.02 to 2000 ppm, preferably from 0.05 to 1000 ppm and more preferably from 0.1 to 1000 ppm. The cellulose ester obtained by the re-precipitation may be added with another polymer or a low molecular weight compound.

It is preferred that the cellulose ester is one providing a film having minimal foreign matter bright spots. “Foreign matter bright spots” refer to spots in which, when one side of a laminate, in which two polarizing plates are arranged at right angles (crossed Nicols) and a cellulose ester film is arranged between them, is exposed to light and the laminate is viewed from the other side, leakage of the light is observed. At the time, it is desired that a polarizing plate employed for evaluation is composed of a protective film having no foreign matter bright spots, and one in which a glass plate is employed to protect a polarizer is preferably employed. It is assumed that the use of cellulose which has not been acetylated or cellulose with a low degree of acylation is one of the causes of the foreign matter bright spots. It is possible to remove the foreign matter bright spots by employing cellulose esters (for example, cellulose esters with a small variation of a degree of substitution) having minimal foreign matter bright spots, by filtering molten cellulose esters, or by filtering a solution of cellulose ester obtained at a final cellulose ester synthesis stage or a precipitation stage in the synthetic process.

As film thickness decreases, the number of foreign matter bright spots decreases, and as the cellulose ester content in the film decreases, the foreign matter bright spots tend to decrease. The number of foreign matter bright spots with a spot diameter of not less than 0.01 mm is preferably 200/cm² or less, more preferably 100/cm² or less, still more preferably 50/cm² or less, further still more preferably 30/cm² or less, further still further more preferably 10/cm² or less, and most preferably 0. Further, the number of foreign matter bright spots with a spot diameter of from 0.005 to 0.01 mm is preferably 200/cm² or less, more preferably 100/cm² or less, still more preferably 50/cm² or less, further still more preferably 30/cm² or less, further still further more preferably 10/cm² or less, and most preferably 0.

When the foreign matter bright spots are removed via melt filtration, melt filtration of a cellulose ester composition containing plasticizers and deterioration preventing agents is preferred as compared with that of a composition composed of only cellulose esters, since removal efficiency of the foreign matter bright spots is higher. As a matter of course, the foreign matter bright spots can be reduced by filtration of a solution in which cellulose ester is dissolved in a solvent during the synthesis process of the cellulose ester. It is possible to filter a composition incorporating UV absorbents or other additives. In the melt filtration, a molten composition containing cellulose ester to be filtered has a viscosity of preferably 10000 Pa·s or less, more preferably 5000 Pa·s, still more preferably 1000 Pa·s or less, and most preferably 500 Pa·s or less. As filter materials, preferably employed are conventional ones such as glass fibers, cellulose fibers, filter paper, or fluororesins such as ethylene tetrafluoride resin. Ceramics and metals are especially preferably employed. The absolute filtration accuracy of a filter employed is preferably 50 μm or less, more preferably 30 μm or less, still more preferably 10 μm or less, and most preferably 5 μm or less. These may be employed in combination. A surface or depth type filter material may be employed, while the depth type is more preferably employed due to less clogging.

One or more kinds of the cellulose ester can be used.

As the cellulose ester, cellulose ester used in the cellulose ester layer (A) described later can be used.

<Resins (D) Having Abbe Number of from 30 to 60 Other than Cellulose Ester and Acryl Resin>

The acryl resin layer (B) can contain various resins (D) as long as physical properties of the layer are not jeopardized. The Abbe number of the resins (D) is preferably from 30 to 60, which enables to desirably adjust optical properties of the layer.

Examples of such resins include methyl (meth)acrylate-styrene resin (with a styrene content exceeding 50% by mass); copolymers of an unsaturated group-containing dicarboxylic acid or its derivative with an aromatic vinyl compound such as styrene, α-methylstyrene or a nucleus-substituted styrene, for example, styrene-maleic acid resin, styrene-fumalic acid resin, styrene-itaconic acid resin or styrene-N-maleimide resin; indene copolymers such as indene-styrene resin or indene-methyl (meth)acrylate resin (an indene-acrylate copolymer with an indene content exceeding 50% by mass); an olefin-meleimide copolymer; polycarbonate; polycycloolefin; and octacetylsucrose.

Particularly, methyl (meth)acrylate-styrene resin (with an Abbe number of from 35 to 52), indene-methyl (meth)acrylate copolymer (with an Abbe number of from 34 to 51) and indene-cumarone copolymer (with an Abbe number of from 35 to 40) are preferably employed, which is likely to exhibit the advantageous effects of the invention.

As a commercially available resin, methyl methacrylate-styrene copolymer KT 75 with an Abbe number of 46 (produced by Denki Kagaku Kogyo Co., Ltd.) can be employed.

The Abbe number was measured according to a conventional method. Employing an Abbe refractometer, indexes nc, nd and nf were measured at the C line (656.3 nm), D line (590.3 nm) and the F line (486.1 nm) of Fraunhofer, respectively, and the Abbe number was determined by the following formula:

Abbe Number(νd)=(nd−1)/(nf−nc)

It is preferred that the resins (D) miscible with the acryl resin or cellulose ester resin in the invention are subjected to miscibility test before mixing.

The miscibility test is carried out as follows.

Each of the resin (A), resin (B) and resin (D) is dissolved in 100 ml of methylene chloride solution, to prepare a 5% resin (A) methylene chloride solution, a 5% resin (B) methylene chloride solution, and a 5% resin (C) methylene chloride solution. After the resulting solutions are mixed, the mixture is visually observed and its turbidity is measured in order to evaluate the miscibility.

This test makes it possible to select the resin (D) conveniently.

### <Other Additives>

The acryl resin layer (B) in the invention may contain a plasticizer to improve its fluidity or flexibility.

Examples of the plasticizer include a phthalic acid ester, a fatty acid ester, a trimellitic acid ester, a phosphate ester, a polyester and an epoxy.

Of these, a polyester ester or phthalic acid ester plasticizer is preferred. A polyester plasticizer is superior in non-transferability or extraction resistance but slightly inferior in plasticizing effect or miscibility, compared to a phthalic acid ester plasticizer.

Therefore, these plasticizers are chosen or used in combination in accordance with needs and are applicable to a broad range of use.

The polyester plasticizer is a reaction product of mono- to tetracarboxylic acids and mono- to hexaalcohols, and there is mainly used a reaction product of a dicarboxylic acid and a glycol. Typical examples of a dicarboxylic acid include a glutaric acid, itaconic acid, adipic acid, phthalic acid, azelaic acid and sebacic acid.

The use of adipic acid or phthalic acid can obtain a plasticizer superior in a plasticizing characteristic. Examples of the glycol include ethylene, propylene, 1,3-butylene, 1,4-butylene, 1,6-hexamethylene, neopentylene, diethylene and dipropylene glycols.

These dicarboxylic acids and glycols may be used singly or in combination.

Such an ester type plasticizer may be any of an ester, oligoester and polyester. The molecular weight of the plasticizer may be in the range of from 100 to 10000, and is preferably from 600 to 3000 in an enhanced plasticizing effect.

The viscosity of a plasticizer has a relationship with molecular structure or molecular weight. The adipic acid plasticizer has a viscosity within a range of preferably 200 to 5000 Pa·s (25° C.) in view of compatibility and plasticization efficiency. Such an adipic acid plasticizer may be used in combination with some polyester plasticizers.

It is preferred that the plasticizer is added in an amount of 0.5 to 30 parts by mass per 100 parts by mass of the acryl resin-containing composition. The amount exceeding 30 parts by mass makes the surface sticky, which is not preferable for practical use.

The acryl resin-containing composition preferably contains an ultraviolet absorbent, such as a benzotriazole, 2-hydroxybenzophenone or salicylic acid phenyl ester one. Specific examples of the ultraviolet absorbent include triazoles such as 2-(5-methyl-2-hydroxyphenyl)benzotriazole, 2-[2-hydroxy-3,5-bis(α,α-dimethylbebzyl)phenyl]-2H-benzotriazole and 2-(3,5-di-t-butyl-2-hydroxyphenyl)benzotriazole; and benzophenones such as 2-hydroxy-4-methoxybenzophenone, 2-hydroxy-4-octoxybenzophenone and 2,2′-dihydroxy-4-methoxybenzophenone.

Further, various kinds of antioxidants may be added to the acryl resin used in the acryl resin layer (B) to improve a thermal decomposition property or thermal coloring property at the time of fabrication. Addition of an antistatic agent enables to provide antistatic performance to the acryl resin-containing film.

An inflammable acryl resin composition blending a phosphorus flame retarder can be used as an acryl resin composition.

Examples of a phosphorus flame retarder include one or a mixture of two or more selected from a red phosphorus, a triazole phosphoric acid ester, a diaryl phosphoric acid ester, a monoaryl phosphoric acid ester, an arylphosphonic acid compound, an arylphosphine oxide compound, a condensed arylphosphoric acid ester, a halogen-containing, condensed phosphoric acid ester, A halogen-containing, condensed phosphonoc acid ester, and a halogen-containing phosphorus acid ester.

Specific examples include triphenyl phosphate, 9,10-dihydro-9-oxa-10-phosphaphenathrene-10-oxide, phenylphosphonic acid, tris(β-chloroethyl)phosphate, tris(dichloropropyl)phosphate and tris(tribromoneopentyl)phosphate.

### <Cellulose Ester Resin Layer (A)>

The cellulose ester resin layer (A), when the total content of a cellulose ester resin and an acryl resin in the cellulose ester resin layer (A) is 100% by mass, has a cellulose ester resin content of from 55 to 99% by mass and a acryl resin content of from 1 to 45% by mass. It is preferred that the cellulose ester resin layer (A) has a cellulose ester resin content of from 60 to 99% by mass and a acryl resin content of from 1 to 40% by mass.

When the cellulose ester resin content is less than 55% by mass, saponification properties lowers on preparation of a polarizing plate with a polarizer sandwiched between the protective films, resulting in lowering of productivity. Further, the lowering of the saponification property lowers adhesion between the protective films of a polarizing plate and causes high humidity dependency of the polarizing plate, which is likely to cause light leakage. When the cellulose ester resin content is more than 99% by mass, the planarity of the protective film is lowered, resulting in deterioration of adhesion at the interface between the laminated layers. Therefore, the cellulose ester content is required to be adjusted so as to fall within the range as described above.

### <Cellulose Ester>

As the cellulose ester, the cellulose ester usable in the acryl resin layer (B) described above can be used.

The cellulose ester described later can be also used.

The cellulose ester is an ester of cellulose and a carboxylic acid having a carbon atom number of from 2 to around 22, and may be an ester of cellulose and an aromatic carboxylic acid ester. Particularly, the cellulose ester is preferably an ester of cellulose and a lower fatty acid.

The lower fatty acid in the lower fatty acid ester of cellulose is a fatty acid having a carbon atom number of not more than 6. The acyl group bonding to the hydroxyl group of cellulose may be straight chained, branched or cyclic. Further, the acyl group may have another substituent.

When the degree of substitution of an acyl group in cellulose ester is the same, the acyl group is preferably selected from acyl groups having a carbon atom number of from of 2 to 6.

It is preferred that the cellulose ester in the invention preferably satisfies simultaneously the following formulae (a) and (b).

2.4≦X+Y≦3.0 Formula (a)

0.1≦Y≦1.5 Formula (b)

wherein X represents a degree of substitution of an acetyl group; Y represents a degree of substitution of a propionyl group or a butyryl group; and (X+Y) represents a total degree of substitution of an acyl group.

Among these, cellulose acetate propionate is especially preferred. A degree of substitution of an acyl group can be measured according to a method specified in ASTM-D817-96.

The molecular weight of the cellulose ester is preferably from 60,000 to 300,000 and more preferably from 70,000 to 200,000 in terms of a number average molecular weight (Mn).

The weight average molecular weight (Mw) to number average molecular weight (Mn) ratio of the cellulose ester in the invention is preferably not more than 4.0, and more preferably from 1.4 to 2.3.

The average molecular weight or molecular weight distribution of the cellulose ester can be measured according to gel permeation chromatography (GPC). The number average molecular weight (Mn) and weight average molecular weight (Mw) are determined from the measurements, and the ratio can be calculated.

The measurement can be carried out under the same conditions as described above.

The thickness of the cellulose ester layer (A) in the protective film is preferably from 5 to 200 μm, more preferably from 10 to 150 μm, and still more preferably from 10 to 80 μm.

### (Acryl Polymer>

The cellulose ester resin layer (A) can contain a low molecular weight acryl polymer in addition to the acryl resin used in the acryl resin layer (B) described above.

The acryl polymer is preferred which provides a negative birefringence in the stretching direction as function, when it is contained in the cellulose ester resin layer. The amyl polymer, although its structure is not specifically limited, is preferably a polymer having a weight average molecular weight of from 500 to 40000 prepared by polymerization of an ethylenically unsaturated monomer.

### (Birefringence Test of Acryl Polymer)

An acryl polymer is dissolved in a solvent, and cast to form a film, and dried to obtain a film with a transmittance of 80%. The resultant film was evaluated for birefringence.

Measurement of birefringence is carried out through an Abbe refractometer-4T (produced by ATAGO Co., Ltd,) employing a multi-wavelength light source. A refractive index in the stretching direction is designated as ny, and a refractive index in-plane perpendicular to it as ny. A (meth)acryl polymer in a film satisfying formula (ny−nx)<0 is judged to have a negative birefringence, ny and nx measured with a 550 nm light.

The acryl polymer having a weight average molecular weight of from 500 to 40,000 may be an acryl polymer with an aromatic ring in the side chain or an acryl polymer with a cyclohexyl group in the side chain.

The composition of the acryl polymer having a weight average molecular weight of from 500 to 40,000 being adjusted, compatibility of the acryl polymer with the cellulose ester resin can be improved.

The acryl polymer with an aromatic ring or a cyclohexyl group in the side chain, having a weight average molecular weight of preferably from 500 to 10,000, provides a cellulose ester film with excellent transparency and extremely low moisture permeation, which exhibits excellent performance as a protective film for a polarizing plate.

The polymer has a weight average molecular weight of from 500 to 40,000, and therefore, it is considered to be a polymer between an oligomer and a low molecular weight polymer. Synthesis of such a polymer is carried out according to a method in which does not increase the molecular weight and obtain the molecular weight as uniformly as possible

The acryl polymer used in the invention is preferably a polymer X with a weight average molecular weight of from 2000 to 40000 obtained by copolymerization of an ethylenically unsaturated monomer Xa having neither aromatic ring nor hydroxyl group in the molecule, an ethylenically unsaturated monomer Xb having a hydroxyl group but no aromatic ring in the molecule, and a copolymerizable ethylenically unsaturated monomer other than Xa and Xb or a polymer Y with a weight average molecular weight of from 500 to 5000 obtained by copolymerization of an ethylenically unsaturated monomer Ya having no aromatic ring and an ethylenically unsaturated monomer Yb copolymerizable with Ya.

### [Polymer X, Polymer Y]

To adjust the retardation of the cellulose ester resin layer (A), it is preferred that the layer contains a high molecular weight polymer X with a weight average molecular weight of from 2000 to 30000 obtained by copolymerization of an ethylenically unsaturated monomer Xa having none of an aromatic ring, a hydroxyl group and an amido group in the molecule, an ethylenically unsaturated monomer Xb having a hydroxyl group or an amido group but no aromatic ring in the molecule, and a copolymerizable ethylenically unsaturated monomer other than Xa and Xb and a low molecular weight polymer Y with a weight average molecular weight of from 500 to 5000 obtained by copolymerization of an ethylenically unsaturated monomer Ya having no aromatic ring and an ethylenically unsaturated monomer Yb copolymerizable with Ya.

The polymer X is a high molecular weight polymer with a weight average molecular weight of from 2000 to 40000 obtained by copolymerization of an ethylenically unsaturated monomer Xa having none of an aromatic ring, a hydroxyl group and an amido group in the molecule, an ethylenically unsaturated monomer Xb having a hydroxyl group or an amido group but no aromatic ring in the molecule, and a copolymerizable ethylenically unsaturated monomer other than Xa and Xb.

Xa is preferably an acryl or methacryl monomer which does not have an aromatic ring, a hydroxyl group or an amido group in the molecule, and Xb is an acryl or methacryl monomer which does not have an aromatic ring, but has a hydroxyl group or an amido group in the molecule.

The polymer X used in the invention is represented by the following formula (X).

-[Xa]m-[Xb]n-[Xc]p- Formula (X)

In formula (X) above, Xa represents an ethylenically unsaturated monomer which does not have an aromatic ring, a hydroxyl group or an amido group in the molecule; Xb represents an ethylenically unsaturated monomer which does not have an aromatic ring but has a hydroxyl group or an amido group in the molecule; Xc represents a copolymerizable ethylenically unsaturated monomer other than Xa or Xb; and m, n and p each represent molar composition ratio, provided that m≠0, and m+n+p=100.

The polymer X is preferably a polymer represented by the following formula (X-1),

—[CH₂—C(—R1)(—CO₂R2)]m-[CH₂—C(—R3)(—CO₂R4-OH)-]n-[Xc]p- Formula (X-1)

In formula (X-1), R1 and R3 independently represent a hydrogen atom or a methyl group; R2 represents an alkyl group having a carbon atom number of from 1 to 12 or a cycloalkyl group; R4 represents —CH₂—, —C₂H₄— or —C₃H₆—; Xc is a monomer unit polymerizable with [CH₂—C(—R1)(—CO₂R2)] or [CH₂—C(—R3)(—CO₂R4-OH)-]; and m, n and p are molar composition ratios, provided that m≠0, and m+n+p=100.

Monomers from which the monomer units constituting the polymer X in the present invention are derived will be listed below but the invention is not limited thereto.

In X, the hydrophilic group refers to a group having an ethylene oxide chain as well as a hydroxyl group.

Examples of an ethylenically unsaturated monomer Xa which does not have an aromatic ring, a hydroxyl group nor an amido group in the molecule includes methyl acrylate, ethyl acrylate, (i- or n-) propyl acrylate, (n-, i-, s- or t-) butyl acrylate, (n-, i- or s-) pentyl acrylate, (n- or i-) hexyl acrylate, (n- or i-) heptyl acrylate, (n- or i-) octyl acrylate, (n- or i-) nonyl acrylate, (n- or i-) myristyl acrylate, 2-ethylhexyl acrylate, ε-caprolactone acrylate, and those wherein the above acrylic acid esters are changed to methacrylic acid esters. Of these, preferred are methyl acrylate, ethyl acrylate, methyl methacrylate, ethyl methacrylate, and (n- or i-) propyl methacrylate.

An ethylenically unsaturated monomer Xb having no aromatic ring but having a hydroxyl group or an amido group in the molecule is preferably an acrylic acid ester or a methacrylic acid ester as a monomer unit having a hydroxyl group, including, for example, 2-hydroxyethyl acrylate, 2-hydroxypropyl acrylate, 3-hydroxypropyl acrylate, 4-hydroxybutyl acrylate, and 2-hydroxybutyl acrylate, or those wherein the above acrylic acid is replaced with methacrylic acid. Of these, 2-hydroxyethyl acrylate, 2-hydroxyethyl methacrylate, 2-hydroxypropyl acrylate, and 3-hydroxypropyl acrylate are preferred.

Examples of the monomer unit having an amido group in Xb include N-vinylpyrrolidone, N-acryloylmorpholine, N-methacryloylmorpholine, N-vinylpiperidone, N-vinylcaprolactam, acrylamide, N,N-dimethylacrylamide, N-isopropylacrylamide, N,N-dimethylaminopropylacrylamide, N,N-diethylacrylamide, N-hydroxyethylacrylamide, and N-vinylacetoamide.

Xc is not specifically limited as long as it is an ethylenically unsaturated monomer other than Xa or Xb and also is co-polymerizable, but is preferably one having no aromatic ring.

The molar composition ratio m:n of Xa to Xb is preferably in the range of 99:1 to 65:35, and more preferably 95:5 to 75:25. The molar composition ratio p of Xc is 0 to 10. Xc may be plural monomer units.

A molar composition ratio of Xb exceeding the above range tends to produce haze at film formation, and therefore, it is preferred that optimum molar composition ratio of Xb is determined, followed by determination of the molar composition ratio of Xa and Xb.

The molecular weight of the polymer X with high molecular weight is preferably from 5000 to 40000, and more preferably 5000 to 20000, in terms of weight average molecular weight.

The weight average molecular weight of 5000 or more is preferred, since it provides benefits such that dimensional variation of an optical compensation under high temperature and high humidity conditions are minimized and minimal curling is realized as a polarizing plate protective film.

When the polymer X has a weight average molecular weight of 40000 or less, the compatibility with cellulose ester is improved, and bleeding-out under high temperature and high humidity or haze occurrence after film formation is suppressed.

In the invention, the weight average molecular weight of the polymer X can be adjusted according to a conventional molecular weight regulating method. As such a molecular weight regulating method, there is mentioned a method of adding a chain transfer agent such as carbon tetrachloride, laurylmercaptan or octyl thioglycolate to a polymerization composition.

The polymerization temperature is ordinarily from room temperature to 130° C. and preferably from 50 to 100° C. The molecular weight can be controlled by adjustment of the polymerization temperature or the polymerization reaction time.

The weigh average molecular weight can be measured by the following method.

### (Measurement of Average Molecular Weight)

The weight average molecular weight Mw or the number average molecular weight Mn is determined according to a gel permeation chromatography (GPC), and the measurement conditions are as described above.

A polymer Y with low molecular weight used in the invention is one having a weight average molecular weight of from 500 to 5000 obtained by polymerization of an ethylenically unsaturated monomer Ya which does not have an aromatic ring. When the weight average molecular weight of the polymer is 500 or more, it is preferred since the residual monomer in the polymer decreases.

When the weight average molecular weight of the polymer is 5000 or less, it is preferred since the retardation value Rth lowering property is maintained. Ya is preferably an acryl or methacryl monomer which does not have an aromatic ring.

The polymer Y used in the invention is represented by the following formula (Y).

-[Ya]k-[Yb]q- Formula (Y)

In formula (Y) above, Ya represents an ethylenically unsaturated monomer which does not have an aromatic ring; Yb represents an ethylenically unsaturated monomer capable of copolymerizing with Ya; and m and q each represent molar composition ratio, provided that k≠0, and k+q=100.

The polymer Y is preferably a polymer represented by the following formula (Y-1).

—[CH₂—C(—R5)(—CO₂R6)]k-[Yb]q- Formula (Y-1)

In formula (Y-1), R5 represents a hydrogen atom or a methyl group; R6 represents an alkyl group having a carbon atom number of from 1 to 12 or a cycloalkyl group; Yb is a monomer unit polymerizable with [CH₂—C(—R5)(—CO₂R6)]; and k and q are molar composition ratios, provided that k≠0, and k+q=100.

Yb is not specifically limited as long as it is an ethylenically unsaturated monomer polymerizable with Ya [CH₂—C(—R5)(—CO₂R6)]. Yb may be plural, k+q=100, and q is preferably from 1 to 30.

Examples of an ethylenically unsaturated monomer Ya constituting the polymer Y obtained by polymerizing an ethylenically unsaturated monomer which does not have an aromatic ring includes acrylic acid esters such as methyl acrylate, ethyl acrylate, (i- or n-) propyl acrylate, (n-, i-, s-, or t-) butyl acrylate, (n-, i-, or s-) pentyl acrylate, (n- or i-) hexyl acrylate, (n- or i-) heptyl acrylate, (n- or i-) octyl acrylate, (n- or i-) nonyl acrylate, (n- or i-) myristyl acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, and 2-hydroxybutyl acrylate; those wherein the above acrylic acid esters are changed to methacrylic acid esters; and unsaturated acids such as acrylic acid, methacrylic acid, malic anhydride, crotonic acid and itaconic acid.

Yb is not specifically limited as long as it is an ethylenically unsaturated monomer polymerizable with Ya. The ethylenically unsaturated monomer Yb is preferably a vinyl ester such as vinyl acetate, vinyl propionate, vinyl butyrate, vinyl valerate, vinyl pivalate, vinyl caproate, vinyl caprate, vinyl laurate, vinyl myristate, vinyl palmitate, vinyl stearate, vinyl cyclohaxane carboxylate, vinyl octilate, vinyl methacrylate, vinyl crotonate, vinyl sorbicate or vinyl cinnamate. Yb may be plural.

In the synthesis of the polymers X and Y, a conventional polymerization method is difficult to control the molecular weight. It is preferred that a method is carried out which uniforms the molecular weight as far as possible and does not increase the molecular weight.

As such a method, there is a method of using a peroxide polymerization initiator such as cumene peroxide or t-butyl hydroperoxide, a method of using a polymerization initiator in an amount larger than in a conventional polymerization, a method of using a chain transfer agent such as a mercapto compound or a carbon tetrachloride in addition to a polymerization initiator, a method of using a polymerization terminating agent such as benzoquinone or dinitrobenzene in addition to a polymerization initiator, or a method of carrying out bulk polymerization by use of a compound having one thiol group and a secondary hydroxyl group, or by use of a polymerization catalyst prepared in combination of the compound with an organic metal compound, as disclosed in Japanese Patent O.P.I. Publication Nos. 2000-128911 and 2000-344823. In the present invention, any of these is preferably used.

Particularly in polymerization of the polymer Y, it is preferred that a polymerization method is carried out which employs a compound having a thiol group and a secondary hydroxyl group in the molecule as a chain transfer agent. In this case, the molecular end group of the polymer Y has a hydroxyl group or a thiol group resulting from a polymerization initiator or a chain transfer agent. Compatibility of the polymer Y and cellulose ester can be adjusted by the end group.

The hydroxyl group value of the polymers X and Y is preferably from 30 to 150 mgKOH/g.

### (Determination Method of Hydroxyl Group Value)

This determination is based on JIS K 0070 (1992). The hydroxyl group value is defined as the number of milligrams of potassium hydroxide required to neutralize acetic acid joining a hydroxyl group when 1 g of a sample is acetylated.

Specifically, X g (approximately 1 g) of a sample is precisely weighed in a flask, and an acetylating reagent (a reagent in which pyridine is added to 20 ml of acetic anhydride to get a mixture of 400 ml) is accurately added thereto. An air cooling tube is attached to the mouth of the flask, followed by heating in a glycerin bath of 95 to 100° C. After one and a half hours of heating, cooling is carried out, and 1 ml of purified water is added through the air cooling tube to decompose the acetic anhydride into acetic acid.

Subsequently, titration is conducted with a 0.5 mol/l potassium hydroxide ethanol solution using a potential difference titration apparatus. The inflection point of the thus-obtained titration curve is defined as an end point.

Further, as a blank test, titration is carried out with no sample to determine the inflection point of the titration curve. The hydroxyl group value is calculated by the following formula.

Hydroxyl group value={(B−C)×f×28.05/X}+D

wherein B represents the amount (ml) of the 0.5 mol/l potassium hydroxide ethanol solution used in the blank test; C represents the amount (ml) of the 0.5 mol/l potassium hydroxide ethanol solution used in the titration; f represents the factor of the 0.5 mol/l potassium hydroxide ethanol solution; D represents an acid value; and 28.05 represents a half of the amount of 1 mol, 56.11, of potassium hydroxide.

The polymers X and Y described above each exhibit excellent compatibility with a cellulose ester, excellent productivity with no evaporation or volatilization, exhibiting enhanced retention properties, as well as minimal moisture permeability and excellent dimensional stability as for a protective film for a polarizing plate.

The content of the polymer X or Y used in the invention is preferably from 5 to 20% by mass. When the total content of the polymer X or the polymer Y is not less than 5% by mass based on the total mass of cellulose ester, it adequately functions to adjust a retardation value. Further, when the total content of the polymer X or the polymer Y is not more than 20% by mass, adhesion to a polarizer PVA is enhanced.

It is possible that the polymer X and the polymer Y are directly added as a melted composition to cellulose ester.

### <Other Additives>

It is preferred that the cellulose ester resin layer (A) in the invention contains a plasticizer providing processability to the film, an anti-oxidant preventing deterioration of the film, an ultraviolet absorbent providing UV light absorbing ability, microparticles (a matting agent) providing slipping property to the film, or a retardation adjusting agent controlling the retardation of the film.

### <Plasticizer>

As the plasticizer, there are mentioned an alcohol compound, a phosphoric acid ester plasticizer, an ethylene glycol ester plasticizer, a glycerin ester plasticizer, a diglycerin ester plasticizer (fatty acid ester), a polyhydric alcohol ester plasticizer, a dicarboxylic acid ester plasticizer, a polycarboxylic acid ester plasticizer, and a polymer plasticizer.

The addition amount of a plasticizer is preferably from 1 to 50% by mass, more preferably from 3 to 30% by mass, and still more preferably from 5 to 15% by mass, based on 100 parts by mass of cellulose ester.

### (Alcohol Compound)

As the alcohol compound used in the invention, a monohydric to polyhydric alcohol compound can be used.

Examples of the monohydric alcohol include butyl alcohol, (iso- or n-) amyl alcohol, hexyl alcohol, heptyl alcohol, 1-octanol, 2-ethylhexyl alcohol, n-dedecyl alcohol, lauryl alcohol, and oleyl alcohol. Examples of the dihydric alcohol include 1,5-pentane diol, ethylene glycol, propylene glycol, 2-methyl-2,4-pentane diol, and 1,6-hexane diol. Examples of the trihydric alcohol include trimethylol propane, trimethylol ethane, glycerin and phytan triol.

Examples of the tetrahydric alcohol include pentaerythritol, and diglycerin. Examples of the polyhydric alcohol include polyglycerin.

Of these, a monohydric alcohol having a carbon atom number of not less than 7 is preferred. The monohydric alcohol has a boiling point of preferably not lower than 160° C.

A water-soluble plasticizer lowers resistance to bleeding-out. Of the alcohol compounds above, heptyl alcohol, 1-octanol, 2-ethylhexyl alcohol, n-dedecyl alcohol, lauryl alcohol, and oleyl alcohol are preferred in obtaining the advantageous results of the invention.

In addition to the above, plasticizers preferably used in the invention will be explained below, however, the invention is not specifically limited thereto.

### (Phosphoric Acid Aster Plasticizer)

Examples of the phosphoric acid ester plasticizer include alkyl phosphate such as triacetyl phosphate or tributyl phosphate; cycloalkyl phosphate such as tricyclopentyl phosphate or cyclohexyl phosphate; and aryl phosphate such as triphenyl phosphate, tricresyl phosphate, cresyl phenyl phosphate, octyl diphenyl phosphate, biphenyl biphenyl phosphate, trioctyl phosphate, tributyl phosphate, trinaphthyl phosphate, trixylyl phosphate or trisortho-biphenyl phosphate.

These substituents may be the same or different, and may further have a substituent. An alkyl group, a cycloalkyl group and an aryl group may be mixed and the substituents combine with each other through a covalent bond.

### (Ethylene Glycol Ester Plasticizer)

Typical examples of the ethylene glycol ester plasticizer include ethylene glycol alkyl ester plasticizers such as ethylene glycol diacetate and ethylene glycol dibutyrate; ethylene glycol cycloalkyl ester plasticizers such as ethylene glycol dicyclopropyl carboxylate, and ethylene glycol dicyclohexyl carboxylate; and ethylene glycol aryl ester plasticizers such as ethylene glycol dibenzoate and ethylene glycol di-4-methyl benzoate.

### (Glycerin Ester Plasticizer)

Typical examples of the glycerin ester plasticizer include glycerin alley esters such as triacetin, tributyrin, glycerin diacetate carboxylate and glycerin oleate propionate; glycerin cycloalkyl esters such as glycerin tricyclopropyl carboxylate, and glycerin tricyclohexyl carboxylate; glycerin aryl esters such as glycerin tribenzoate and glycerin-4-methylbenzoate; diglycerin alkyl esters such as diglycerin tetraacetylate, diglycerin tetrapropionate, diglycerin acetate tricaprylate and diglycerin tetralaurate; diglycerin cycloalkyl esters such as diglycerin tetracyclobutyl carboxylate and diglycerin tetracyclopentyl carboxylate; and diglycerin aryl esters such as diglycerin tetrabenzoate and diglycerin-3-methyl benzoate.

### (Polyhydric Alcohol Ester Plasticizer)

Examples of the polyhydric alcohol ester plasticizer include those disclosed in paragraphs 30 to 33 of Japanese Patent O.P.I. Publication No. 2003-12823.

### (Dicarboxylic Acid Ester Plasticizer)

Typical examples of the dicarboxylic acid ester plasticizer include alkyl dicarboxylic acid alkyl ester plasticizers such as didodecyl malonate (C1), dioctyl adipate (C4) and dibutyl sebacate (C8); alkyl dicarboxylic acid cycloalkyl ester plasticizers such as dicyclopentyl succinate and dicyclohexyl adipate; alkyl dicarboxylic acid aryl ester plasticizers such as diphenyl succinate and di-4-methylphenyl glutarate, cycloalkyl dicarboxylic acid alkyl ester plasticizers such as dihexyl-1,4-cyclohexane dicarboxylate and didecyl bicyclo[2.2.1]heptane-2,3-dicarboxylate; cycloalkyl dicarboxylic acid cycloalkyl ester plasticizers such as dicyclohexyl-1,2-cyclobutane dicarboxylate and dicyclopropyl-1,2-cyclohexyl dicarboxylate; cycloalkyl dicarboxylic acid aryl ester plasticizers such as diphenyl-1,1-cyclopropyl dicarboxylate and di-2-naphtyl-1,4-cyclohexane dicarboxylate; aryl dicarboxylic acid alkyl ester plasticizers such as diethyl phthalate, dimethyl phthalate, dioctyl phthalate, dibutyl phthalate and di-2-ethylhexyl phthalate; aryl dicarboxylic acid cycloalkyl ester plasticizers such as dicyclopropyl phthalate and dicyclohexyl phthalate; and aryl dicarboxylic acid aryl ester plasticizers such as diphenyl phthalate and di-4-methylphenyl phthalate.

### (Polycarboxylic Acid Ester Plasticizer)

Typical examples of the polycarboxylic acid ester plasticizer include alkyl polycarboxylic acid alkyl ester plasticizes such as tridodecyl tricarbalate and tributyl-meso-butane-1,2,3,4,-tetracarboxylate; alkyl polycarboxylic acid cycloalkyl ester plasticizers such as tricyclohexyl tricarbalate, and tricyclopropyl 2-hydroxy-1,2,3-propane tricarboxylate; alkyl polycarboxylic acid aryl ester plasticizers such as triphenyl 2-hydroxyl-1,2,3-propane tricarboxylate and tetra-3-methylphenyl tetrahydrofuran-2,3,4,5-tetracarboxylate; cycloalkyl polycarboxylic acid alkyl ester plasticizers such as tetrahexyl 1,2,3,4-cyclobutane tetracarboxylate and tetrabutyl 1,2,3,4-cyclopentane tetracarboxylate; cycloalkyl polycarboxylic acid cycloalkyl ester plasticizers such as tetracyclopropyl 1,2,3,4-cyclobutane tetracarboxylate and tricyclohexyl-1,3,5-cyclohexyl tricarboxylate; cycloalkyl polycarboxylic acid aryl ester plasticizers such as triphenyl 1,3,5-cyclohexyl tricarboxylate and hexa4-methylphenyl-1,2,3,4,5,6-cyclohexyl hexacarboxylate; aryl polycarboxylic acid alkyl ester plasticizers such as tridodecyl benzene-1,2,4-tricarboxylate and tetraoctyl benzene-1,2,4,5 tetracarboxylate; aryl polycarboxylic acid cycloalkyl ester plasticizers such as tricyclopentyl benzene-1,3,5-tricarboxylate and tetracyclohexyl benzene-1,2,3,5-tetracarboxylate; and aryl polycarboxylic acid aryl ester plasticizers such as triphenyl benzene-1,3,5-tetracarboxylate and hexa-4-methylphenyl benzene-1,2,3,4,5,6-hexacarboxylate.

### (Polymer Plasticizer)

In the invention, a polymer plasticizer is preferably used also.

Particularly, polyesters disclosed in Japanese Patent O.P.I. Publication Nos. 2007-231157, paragraphs 0103 to 0116 and the polyester plasticizers described above can be preferably used.

### (Saccharide Ester Plasticizer)

It is preferred that the cellulose ester layer (A) contains a saccharide ester plasticizer prepared by esterifying the hydroxyl group of a saccharide compound in which 1 to 12 of at least one of a furanose structure and a pyranose structure are bonded.

Examples of the saccharide compound include glucose, galactose, mannose, fructose, xylose, arabinose, lactose, sucrose, cellobiose, cellotriose, maltotriose and raffinose. Specifically preferred is a compound having both the furanose structure and the pyranose structure.

As a commercially available one, there is MONOPET SB produced by Dai-Ichi Seiyaku Co., Ltd.

Of the plasticizers described above, ones producing no volatile component during heat melting are preferred. Examples thereof include a non-volatile phosphoric acid ester disclosed in Japanese Patent O.P.I. Publication No. 6-501040, in which for example, arylene bis(diarylphosphate) esters or the Exemplified compound trimethylolpropane tribenzoate are preferred. However, the invention is not specifically limited thereto.

When a volatile component is produced due to thermal decomposition, the thermal decomposition temperature Td (1.0) of the plasticizers described above is defined as a temperature at which 1.0% by mass of the mass is reduced. In the definition, the thermal decomposition temperature is required to be higher than the melting temperature of film-formation materials. The thermal decomposition temperature Td (1.0) can be determined according to a commercially available heat differential thermogravimetric analyzer (TG-DTA).

### <Antioxidant>

In the invention, an antioxidant known in the art can be used.

Specifically, a lactone compound, a sulfur-containing compound, a phenol-containing compound, a compound having double bond, a hindered amine compound, and a phosphorus-containing compound are preferably used.

For example, preferable is a compound containing a product name of “IrgafosXP40” or “IrgafosXP60” produced by Ciba Specialty Chemicals, Inc.

As the abovementioned phenol-containing compound, preferred is a compound having a structure of 2,6-dialkylphenol, for example, a commercially available one, “Irganox1076” or “Irganox1010” from Ciba Specialty Chemicals, Inc., or ADK STAB AO-50 from ADEKA Corp.

As the abovementioned phosphorus-containing compound, preferred is “Sumilizer GP” from Sumitomo Chemical Co., Ltd., “ADK STAB PEP-24G”, “ADK STAB PEP-36” or “ADK STAB 3010” from ADEKA Corp., “IRGAFOS P-EPQ” from Ciba Specialty Chemicals, Inc., or “GSY-P101” from Sakai Chemical Industry Co., Ltd.

As the abovementioned hindered amine compound, preferred is “Tinuvin144” or “Tinuvin770” from Ciba Specialty Chemicals, Inc., and “ADK STAB LA-52” from ADEKA Corp.

As for the abovementioned sulfur-containing compound, preferred “Sumilizer TPL-R” or “Sumilizer TP-D” from Sumitomo Chemical Co., Ltd.

As for the abovementioned compound containing a double bond, preferred are “Sumilizer GM” or “Sumilizer GS” from Sumitomo Chemical Co., Ltd.

Further, a compound having an epoxy group as disclosed in the U.S. Pat. No. 4,137,201 as an acid scavenger can also be contained.

Generally, the content of these antioxidants or other additives are from 0.05 to 20% by mass, and preferably from 0.1 to 1% by mass, based on the mass of the resin which is the main component of the film, although the content is properly determined depending on the recycling process.

These antioxidants can acquire a synergistic effect rather when two or more kinds thereof are used in combination, than when they are used singly. For example, a combination of a lactone compound, a phenol-containing compound, a compound having double bond, and a phosphorus-containing compound is preferred.

### <Colorant>

A colorant is preferably used in the present invention. The colorant means a dye or a pigment, and the colorant is ones having an effect of making the image on the liquid crystal display to bluish tone, controlling the yellow index or lowering the haze, in the present invention.

An anthraquinone dye, an azo dye and a phthalocyanine pigment are effectively usable, although various dyes and pigments can be used as the colorant.

### <UV Absorber>

The UV absorber used in the present invention is not specifically limited, however, there are mentioned, for example, an oxybenzophenone compound, a benzotriazole compound, a salicylate compound, a benzophenone compound, a cyanoacrylate compound, a triazine compound, a nickel complex salt, and inorganic powder. A polymer UV absorber may also be used. The benzotriazole compound is preferably a commercially available one, for example, trade name “Tinuvin 928” available from Ciba Japan Co., Ltd.

### <Matting Agent>

A matting agent is preferably used to provide lubricating property to the film in the present invention.

Either of an inorganic compound or an organic compound is usable as a matting agent in the present invention as far as the transparency of the obtained film is not deteriorated or the matting agent is heat resistant at melting. Examples of the matting agent include talc, mica, zeolite, diatomaceous earth, calcinated diatomaceous earth, kaolin, sericite, bentonite, smectites, cray, silica, quartz powder, glass beads, glass powder, glass flake, milled fiber, warastnite, boron nitride, boron carbide, boron titanate, magnesium carbonate, heavy calcium carbonate, light calcium carbonate, calcium silicate, aluminum silicate, magnesium silicate, magnesium aluminosilicate, alumina, zinc oxide, titanium dioxide, iron oxide, magnesium oxide, zirconium oxide, aluminum hydroxide, calcium hydroxide, magnesium hydroxide, calcium sulfate, barium sulfate, silicon carbide, aluminum carbide, titanium carbide, aluminum nitride, silicon nitride, titanium nitride and white carbon. These matting agents may be used singly or as an admixture of two or more kinds thereof.

It is possible to highly balance transparency and a lubricating property by utilizing particles having different particle diameters and forms (for example, a needle form and a spherical form) in combination.

Among these, silicon dioxide, which is excellent in transparency (haze) due to the refractive index near to that of cellulose ester, is preferably utilized.

As specific examples of silicon dioxide, preferably utilized can be products available on the market under the name of such as Aerosil 200V, R972V, R972, R974, R812, 200, 300, R202, OX50 and TT600, Aerosil RY50, Aerosil NY50, Aerosil RY200, Aerosil RY200S, Aerosil RX50, Aerosil NA50, Aerosil RX200, Aerosil RX300, Aerosil R504, Aerosil DT4, Aerosil LE1, Aerosil LE2, (produced by Nippon Aerosil Co., Ltd.), Seahostar KEP-10, KEP-30 and KEP-50 (produced by Nippon Shokubai Co., Ltd.), Syrohobic 100 (produced by Fuji Silycia Chemical Ltd.), Nipseal E220A (produced by Nippon Silica Industry) and Admafine SO (produced by Admatechs).

As for a form of particles, any of an irregular form, a needle form, a flat form and a spherical form can be utilized without specific limitation; however, a spherical form is specifically preferable because transparency of the prepared film becomes excellent.

The size of particles is preferably not more than a wavelength of visible light and more preferably not more than ½ of a wavelength of visible light because light will be scattered when the size is near to a wavelength of visible light to make transparency poor. The particle size is specifically preferably in a range of 80 to 180 nm since a sliding property may not be improved when the size is excessively small.

Herein, the particle size means the size of aggregate when the particles are constituted of aggregate of primary particles. Further, particle size means a diameter of an equivalent circle of the projected area when particles are not spherical.

### (Viscosity Reducing Agent)

In the present invention, there may be added a hydrogen bonding solvent to reduce melt viscosity. The hydrogen bonding solvent refers to an organic solvent capable of forming a hydrogen atom-mediated “bond” caused between an electrically negative atom (e.g., oxygen, nitrogen, fluorine, chlorine) and a hydrogen atom covalent-bonded to the electrically negative atom, in other word, it means an organic solvent capable of arranging molecules approaching to each other with a large bonding moment and by containing a bond including hydrogen such as O—H ((oxygen hydrogen bond), N—H (nitrogen hydrogen bond) and F—H (fluorine hydrogen bond), as described in J. N. Israelachibiri, “Intermolecular Force and Surface Force” (translated by Tamotsu Kondou and Hiroyuki Ooshima, published by McGraw-Hill. 1991).

The hydrogen bonding solvent is capable of forming a hydrogen bond between celluloses stronger than that between molecules of cellulose resin, the melting temperature of a cellulose resin composition can be lowered by the addition of the hydrogen bonding solvent than the glass transition temperature of a cellulose resin alone in the melt casting method conducted in the present invention. Further, the melt viscosity of a cellulose resin composition containing the hydrogen bonding solvent can be lowered than that of a cellulose resin in the same melting temperature.

### <Manufacturing Method of First Protective Film in the Invention>

A manufacturing method of the first protective film in the invention is preferably a melt cast film manufacturing method which co-extruding a melted cellulose ester resin composition and a melted acryl resin composition to form a laminate of a cellulose ester resin layer (A) and an acryl resin layer (B).

The first protective film in the invention is obtained by providing an acryl resin layer (B) containing an acryl resin in an amount of from 55 to 95% by mass on one side of the cellulose ester resin layer (A) containing a cellulose ester resin in an amount of from 55 to 95% by mass to form a laminate composed of two or more layers including the layer (A) and (B), and extruding the laminate in the form of a film from a flat dye, followed by cooling.

The number of layers constituting the film in the invention is not limited as long as it is two or more. However, it is preferred that the film is composed of two layers in view of simplicity of manufacture facilities. In the invention, “lamination” implies that at least two melted resin layers having fluidity are adhered to each other and formed into a film in the sheet form as one body. The thickness of the layer (A) containing a cellulose ester resin in an amount of from 55 to 95% by mass is preferably from 5 to 200 μm, and more preferably from 10 to 80 μm in the final protective film for a polarizing plate. The thickness of the layer (B) containing an acryl resin in an amount of from 55 to 95% by mass is preferably not less than 5 μm, in exhibiting the advantageous effects of the invention, and more preferably from 5 to 100 μm from the economical point of view.

A molding method due to melt extrusion employing heat melt can be classified, in further details, into a melt extrusion molding method, a press molding method, an inflation molding method, an ejection molding method, a blow molding method and a stretching molding method. Of these methods, the melt extrusion method is preferred in obtaining a protective film for a polarizing plate with excellent mechanical strength and surface precision, and is especially preferably employed in the invention. Taking physical properties of the film into account, temperature of melted resin is preferably from 120 to 300° C., and more preferably from 200 to 270° C. In this case, the temperature of the cylinder is ordinarily from 150 to 400° C., preferably from 200 to 350° C. and more preferably from 230 to 330° C., and is appropriately set. When temperature for melting the resin is too low, fluidity of the melted resin lowers and distortion of film occur, which makes it difficult to control a thickness of the film. When temperature for melting the resin is too high, voids, silver streaks or yellowing occur in the film, resulting in molding defects.

In an actual flow, a raw material cellulose ester formed into powders or pellets is subjected to hot air drying or vacuum drying, and then is heat melted together with the film constituent materials to develop fluidity. Thereafter, the resulting melted mixture is extruded into a sheet through a T-die, brought into close contact with a cooling drum or an endless belt, for example, using an electrostatic application method, and cooled and solidified, thereby obtaining an unstretched sheet. The temperature of the cooling drum is preferably kept at from 90 to 150° C.

When a web formed by co-extrusion is conveyed while cooling on a first cooling roller and a second cooling roller which follows the first cooling roller disposed, it is preferred that the film is conveyed so that the cellulose ester resin layer (A) contacts the first cooling roller, and the acryl resin layer (B) contacts the second cooling roller.

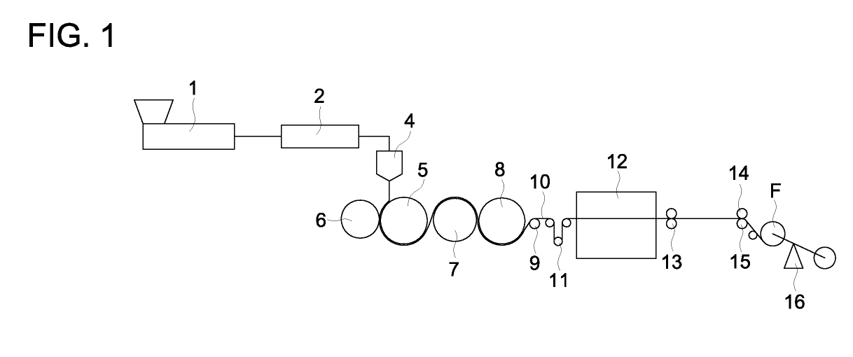

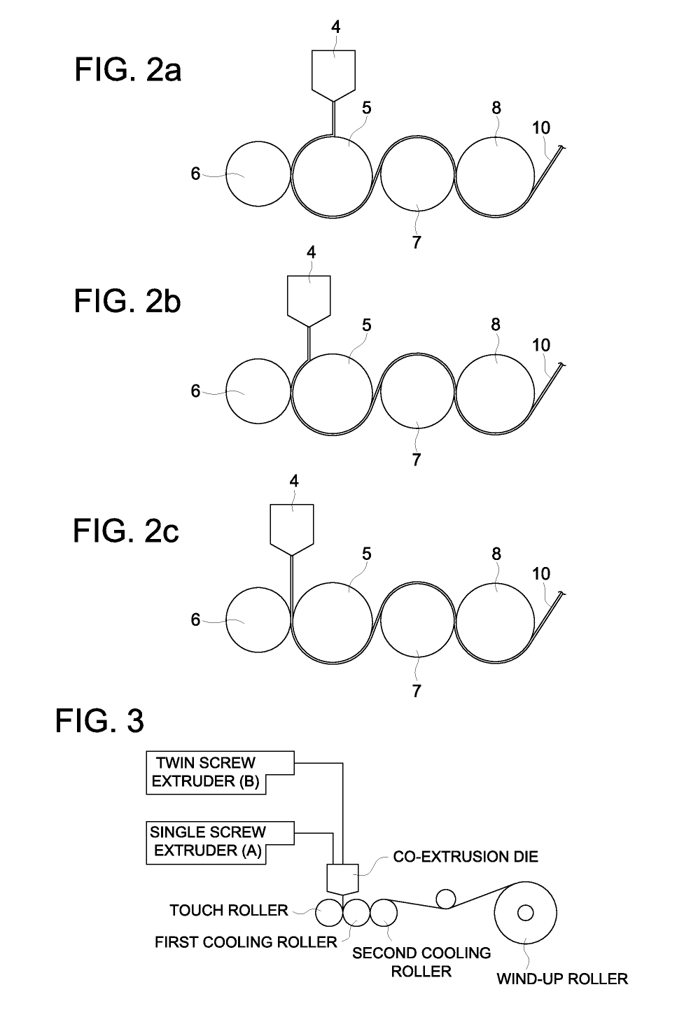

FIG. 1 is a schematic flow sheet showing the whole constitution of an apparatus for carrying out a manufacturing method of the first protective film in the invention, and FIG. 2 is a drawing in which the section from a dice to cooling rollers is enlarged.

In the manufacturing of the first protective film in the invention as shown in FIGS. 1 and 2, film raw materials such as a cellulose ester resin and an acryl resin are mixed, melt extruded onto the first cooling roller 5 from a dice 4 employing an extruder 1 so that the cellulose ester resin layer (A) is brought into contact with the surface of the first cooling roller 5 and the acrylic resin layer (B) is brought into contact with the surface of the second cooling roller 7, conveyed to the third cooling roller 8 (if necessary), whereby the layers are brought into contact with the total three cooling rollers in sequence to be cooled and solidified. Thus, the cellulose ester film 10 is obtained. Then, the cellulose ester film 10 is peeled by the peeling roller 9, stretched while gripping both sides of the film employing stretching device 12, and wound by the wind-up device 16. A touch roller 6 to secure flatness of the film is provided so that molten film is pressed onto the surface of the first cooling roller 5. The touch roller 6 has elasticity in its surface, and a nip is formed between the touch roller 6 and the first cooling roller 5. The touch roller 6 will be detailed later.

Regarding extrusion from the dice to the cooling rollers in FIG. 2, FIGS. 2a, 2b and 2c may be exemplified as their arrangement, but the invention is not specifically limited thereto.

FIG. 3 is a schematic view of a preferred co-extrusion die melt film formation apparatus in the invention.

An acryl resin formed into powders or pellets is melt-kneaded employing a single screw extruder (A), and a cellulose ester resin is melt-kneaded employing a twin screw extruder (B). It is preferred that a twin screw extruder is employed to knead homogeneously additives such as a plasticizer and an anti-oxidant which are incorporated in the cellulose ester resin. The twin screw extruder can blend materials effectively, since it can apply shearing force stronger than a single screw extruder by the two screws. As the twin screw extruder, there are two types. One is of the same direction rotation type and the other is of counter direction rotation type, and the former is preferably used in the invention because stronger shearing force is applied. Further, segments for feeding due to screw and kneading can be designed to be in optimal combination so as to melt-knead materials in the invention. For example, a kneading disk is installed to disperse a material hard to disperse such as an inorganic microparticle matting agent to an intended dispersion degree, and the diameter of the screw is selected to obtain an intended extrusion amount. When raw materials are supplied to a twin screw extruder of the same direction rotation type, the raw materials may be supplied separately or a mixture of the raw materials may be supplied. A known continuous feeder such as a screw feeder, an electromagnetic vibration feeder and forced pressure screw feeder may be used to supply raw materials to the extruder. It is preferred that cellulose ester resin or acryl resin are dried prior to supply to the extruder. The drying temperature is preferably not higher than the Tg of the resin. It is not preferable that the glass transition temperature or melting point of additives such as a plasticizer is not higher than the drying temperature of the cellulose ester resin and the acryl resin, since when they are simultaneously dried in the same dryer, the additives may be fused onto the wall of the dryer. It is preferable the additive is dried and supplied separately from cellulose ester resin and acrylic resin in such instance. When cellulose ester resin, acrylic resin and additives are supplied as an admixture thereof, drying temperature is set at a temperature not higher than the lowest Tg or melting point among Tgs or melting points of the materials. It is preferred that the materials are supplied to the extruder immediately after drying to avoid moisture absorption. For this purpose, a drier is arranged at the upper portion of the extruder so as to supply the dried materials promptly to the extruder employing the continuous feeder described above. Further, in order to carry out drying efficiently and avoid moisture absorption of the dried materials, it is preferred that drying is carried out under vacuum, reduced pressure or inactive gas atmosphere. It is also preferred that the space between a dryer and a feeder, and between the feeder and an inlet of an extruder is maintained under reducing pressure or inactive gas atmosphere. When cellulose and additives are fed in the form of powders, whether fed separately or as the mixture, it is preferred that their particle size and particle size distribution are the same or substantially the same in view of homogeneous blending. It is also preferred that the mixed materials are to pulverized in a pulverizer.

Defective melt molded film or edge portions of the molded film not suitable as a product (hereinafter referred to as recovered materials), after pulverized, can be reused as raw materials for molding. The recovered materials may be pelletized or granulated. The recovered materials may be pelletized or granulated singly or in combination with a virgin material. The recovered materials may be supplied to the extruder separately from the virgin material, for example, a mixture of the cellulose ester resin, the acrylic resin, and the recovered materials may be supplied to the extruder.

Subsequently, the respective melt resin streams being laminated in a merging device called a feed block or widened resin streams in a manifold being merged and laminated by a mouthpiece land section, the resulting laminated materials are melt extruded from a co-extrusion die (a flat die in the invention) to form a two layer laminated sheet composed of a cellulose ester-containing layer (A) and an acryl resin-containing layer (B). The melt resin laminated sheet is brought into contact closely with a moving cooling medium such as a wind-up roller shown in the drawing to be cooled and solidified, thereby obtaining a cast sheet.

The pellets prepared are melted at a melting temperature of from about 200 to about 300° C. via a single screw or twin screw type extruder. After foreign matter being removed via filtration employing a leaf disk type filter, the melting material is co-extruded from a T die in the form of a film, solidified on a cooling roller, and cast while pressing the film employing an elastic touch roller.

While fed into an extruder from a feeding hopper, it is preferable to minimize oxidation decomposition under vacuum or reduced pressure or under an ambience of inert gases.

The die with flaws or foreign matter adhered occasionally produces streak-like defects. Such defects are called die lines. In order to decrease surface defects such as the die lines, a structure is preferred in which resin retaining portions are minimized in the pipe from the extruder to the die. It is also preferable to employ a die having minimal flaws on its interior surfaces or lip. Volatile components from resins are occasionally deposited on the periphery of the die, resulting in die lines.

It is preferred that the inner surface of the extruder and the die, in contact with melted resins, is modified to a surface in which the melted resins are difficult to adhere by reducing the surface roughness or employing materials of low surface energy. Specifically, there are mentioned those which are ground to have a surface roughness of not more than 0.2 S after chromium plating or thermal ceramic spraying.

The first cooling roller 1 and the second cooling roller 2 (a third cooling roller in some cases) are made of a highly rigid metal roller and structured so that heat controllable heat medium or cooling medium flows in the interior thereof. The size is not limited as long as it is sufficiently large to cool the melt-extruded film. The diameter of the cooling roller is ordinarily from about 100 mm to about 1 m.

As surface materials of the cooling roller, there are mentioned carbon steel, stainless steel, aluminum, and titanium. Further, in order to increase the surface hardness or to improve peeling properties of resins, It is preferred that the surface treatments such as hard chromium plating, nickel plating, amorphous chromium plating, or thermal ceramic spraying are carried out.

The surface roughness of the cooling roller is preferably not more than 0.1 μm and more preferably not more than 0.05 μm in terms of Ra. The roller with smoother surface enables to make the surface of the resulting film smoother. It is preferred that the surface-treated surface is further ground to have the surface roughness as described above.

As a touch roller 6 provided to face the first cooling roller, there can be employed a silicone rubber roller whose the surface is covered with a thin film metal sleeve, which is described in Japanese Patent O.P.I. Publication Nos. 03-124425, 08-24772, 07-100960, and 10-272676, WO 2005-028950, and Japanese Patent O.P.I. Publication Nos. 11-235747, 2002-36332, 2005-172940 and 2005-280217.

When a film is peeled from the cooling roller, it is preferred that film deformation is minimized by controlling the tension.

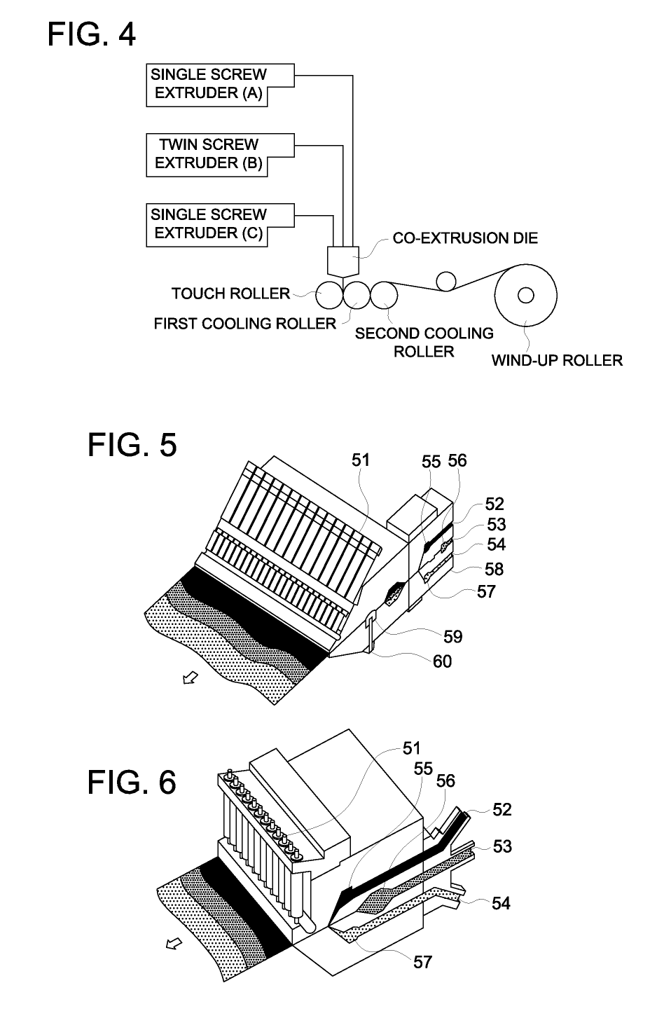

FIG. 4 is a schematic view of another co-extrusion die melt film formation apparatus preferably used in the invention.

In this case, two extruders, a single screw extruder (A) for kneading a melt composition for a cellulose ester resin layer (A) or a melt composition for an acryl resin layer (B) and a twin screw extruder (B) are used, and separate supply is carried out upstream the co-extruder. Thus, a sheet composed of three layers can be manufactured.

A co-extrusion slit die used in the melt extrusion is preferably a flat die such as a T type die, an L type die or a fish tail type die. The clearance between the die lips is preferably from 50 μm to 2 mm. The co-extrusion die may be any of a die having a feed block shown in FIG. 5, a multi-manifold die shown in FIG. 6, or a multi-slot die, and a multi-manifold die is especially preferred in view of thickness precision and flatness. A combination of the feed block with the multi-manifold die can form a multi-layer film such as a 5-layered film or a 7-layered film. In this case, a mixing ratio of cellulose ester resin and acrylic resin can be arbitrarily changed to form a melt cast film having a multi-layer constitution.

In the multi-manifold die shown in FIG. 6, which is a flat die preferably used in the invention, a cellulose ester resin or an acryl resin melted and kneaded in a single screw extruder or a twin screw extruder is introduced into extrusion sections A and B via a gear pump (not illustrated) for controlling the flow rate, the extrusion amount being stabilized in liquid reservoirs, manifolds A and B, and is melt extruded with a film thickness controlled by lip adjust bolts 51 to form a film. It is preferred that a filter is provided between the extruder and a die.

With respect to material of a flat die, a SUS material a ceramic material such as TiN each having excellent releasing ability is preferably used for a material of a surface contacting a melted resin instead of a conventional chromium plating or nitride steel, since the melted resin is likely to adhere to metal material constituting a die and to generate fixed streaks named die streaks, which may cause problem of incapability of optical application.

A multi-layered laminate web is brought into contact with a cooling roll to be cooled and solidified. In this case, the sheet slips on a drum, which causes molecular orientation and so called variation of retardation, and therefore, the web may be cast employing an adhesion improving method selected from an air knife, an air chamber, a press roll method, a liquid paraffin coating method and a static electricity application method.

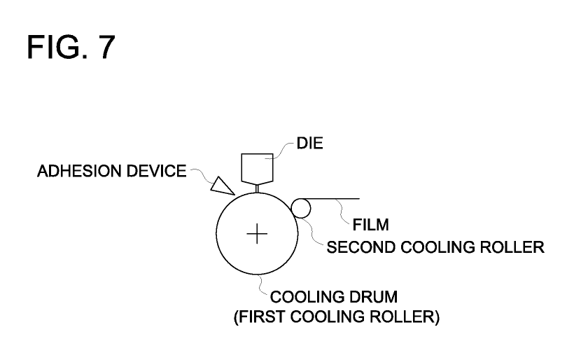

FIG. 7 is a drawing of another embodiment of pulling a melted film. A film composition supplied from a die is cooled and solidified with a desired thickness by a cooling drum, illustrated as a first cooling roller and an adhesion device (such as an air knife or the like), and is formed in a film via a peeling roller.

The width of a protective film manufactured by melt film formation is preferably not less than 1.4 m and more preferably in the range of 1.4 to 3 in from a view point of productivity.

### <Stretching Process>

It is preferred that the film obtained as described above is passed through a process to contact the cooling rollers, and is stretched 1.01 to 3.0 times in at least one direction. The stretching relaxes sharpness of streaks produced, whereby the resulting film can be greatly remedied.

It is preferred that the film is stretched both in the longitudinal direction (film conveyance direction) and in the transverse direction (film width direction) by a magnification of from 1.01 to 2.0).

The stretching method is preferably carried out employing a conventional roller stretching machine or tenter.

The stretching ratio is ordinarily from 1.01 to 3.0, preferably from 1.1 to 2.0, and more preferably from 1.2 to 1.5, and the stretching temperature is ordinarily from Tg to (Tg+50° C.), and preferably from Tg to (Tg+40° C.), Tg being that of resins constituting the film.

It is preferred that the film, controlled to have a temperature distribution uniform in the width direction, is stretched. The variation in the width direction of temperature is in the range of preferably ±2°, more preferably ±1°, and still more preferably ±0.5°.

In the protective film prepared by the method described above, the film can be contracted in the conveyance direction or in the width direction for the purpose of adjusting the retardation or minimizing the dimensional variation.

In order to contract the film in the conveyance direction, there are, for example, a method in which stretching in the transverse direction is temporarily suspended to relax the film in the conveyance direction and a method in which the intervals of the adjacent clips of the width stretching machine are gradually shortened.

The retardation in-plane (Ro) and the retardation in the thickness direction (Rth) of the first protective film in the invention can be properly adjusted. It is preferred that the relation Ro≦10 nm, and the relation −10 nm≦Rth≦10 nm are satisfied, and it is more preferred that the relation Ro≦5 nm, and the relation −5 nm≦Rth≦5 nm are satisfied.

When Nx represents a refractive index in the delayed phase axis of the film, Ny represents a refractive index in the advanced phase axis of the film, and d (nm) represents a thickness direction of the film, Ro and Rth are represented by the following formula:

Ro=(Nx−Ny)×d

Rth={(Nx+Ny)/2−Nz}×d

The retardations Ro and Rth can be measured employing an automatic birefringence meter. They can be determined at 23° C. and at 55% RH, employing, for example, KOBRA-21ADH (produced by Oji Keisokukiki Co., ltd.).

Variation of the retardations is preferably smaller, and is in the range of ordinarily ±10 nm, preferably ±5 nm, and more preferably ±2 nm.

### <Cleaning Device>

It is preferred that a melt casting manufacturing apparatus is equipped with a cleaning device to clean the belt and the rollers automatically. The cleaning device is not specifically limited, and as the cleaning device, there are, for example, a system for knipping a brushing roller, a moisture absorption roller, an adhesion roller, a sweeping roller and the like; an air blowing system for blowing a clean air; and an incineration system employing a laser; and a combination thereof.

In the system of kipping the cleaning rollers, when the linear rate of the roller is different from that of the belt, great cleaning effects can be obtained.

The first protective film in the invention is preferably a long length film, specifically a film with a length of from 100 to 5000 m, and is ordinarily in the form of a roll.

The thickness of the first protective film in the invention is not specifically limited, however, as a protective film for a polarizing plate, the total thickness of the cellulose ester resin layer (A) and the acrylic resin layer (B) is preferably from 20 to 200 μm, more preferably from 25 to 100 μm, and still more preferably from 30 to 80 μm.

### <Curable Resin Layer (Hard Coat Layer)>

It is preferred that the first protective film in the invention further has a curable resin layer. The curable resin layer provides improved flexibility, particularly improved inflection resistance, as well as improved surface hardness.

The curable resin layer may be a single layer and may be composed of two or more layers depending on the intended use. The curable resin layer is composed of preferably one to four layers in view of productivity.

The curable resin layer is provided preferably on the acryl resin layer (B) of the protective film, but may be provided on both sides of the protective film.

The refractive index of the resin constituting the curable resin layer is preferably not less than 1.47, and more preferably from 1.47 to 1.70.

In order to obtain the index falling within the range described above, the kinds or addition amount ratio of the transparent resin can be properly selected. A resin with a refractive index less than 1.47 does not provide high hardness, while a resin with a refractive index more than 1.70 tends to produce pronounced uneveness of the film.

The refractive index of the transparent film can be directly measured at 23° C. employing, for example, an Abbe's refractometer or can be determined according to spectroscopic reflectometry or spectroscopic ellipsometry.

The curable resin is preferably a binder polymer having a saturated hydrocarbon chain or a polyether chain as the main chain, and more preferably a binder polymer having a saturated hydrocarbon chain as the main chain.

As the curable resin, there is a resin cured by heat application or actinic ray irradiation. The curable resin is preferably a resin to be cured by crosslinking reaction due to irradiation of actinic rays such as UV light or electronic beam.

Examples of the curable resin include LTV ray curable acrylate resins such as a UV ray curable acrylurethane resin, a UV ray curable polyesteracrylate resin, a UV ray curable epoxyacrylate resin, a UV ray curable polyolacrylate resin and a UV ray curable epoxy resin.

The UV ray curable acrylurethane resin can be easily obtained by reacting a polyesterpolyol with an isocyanate monomer or its prepolymer and then reacting the resulting product with an acrylate having a hydroxy group such as 2-hydroxyethylacrylate, 2-hydroxyethylmethacrylate (hereinafter, the acrylate comprises methacrylate) or 2-hydroxypropyl-acrylate.

For example, those disclosed in Japanese Patent O.P.I. Publication No. 59-151110) can be used. For example, a mixture of 100 parts of Unidick 17-806 (produced by Dainippon Ink Co., Ltd.) and 1 part of Colonate L (produced by Nippon Polyurethane Industry Co., Ltd.) is preferably used.

As the UV ray curable polyesteracrylate resins, there are mentioned those prepared easily by reacting a polyesterpolyol with 2-hydroxyethylacrylate or 2-hydroxypropylacrylate, disclosed for example, in Japanese Patent O.P.I. Publication No 59-151112.

Examples of the UV ray curable epoxyacrylate resin include those prepared by reacting an epoxyacrylate oligomer in the presence of a reactive diluting agent and a photoinitiator, disclosed for example, in Japanese Patent O.P.I. Publication No. 1-105738.

Examples of the UV ray curable polyol acrylate resin include trimethylolpropane triacrylate, ditrimethylolpropane tetraacrylate, pentaerythritol triacrylate, pentaerythritol tetraacrylate, dipentaerythritol hexaacrylate or alkyl-modified dipentaerythritol pentaacrylate.

The photoinitiators for the UV ray curable resins include benzoine or its derivative, or acetophenones, benzophenones, hydroxy benzophenones, Michler's ketone, α-amyloxime esters, thioxanthones or their derivatives. an oxime ketone derivative, a benzophenone derivative or a thioxanthone derivative. These photoinitiators may be used together with a photo-sensitizer.

Sensitizers such as n-butylamine, triethylamine and tri-n-butylphosphine can be used together with a photoinitiator on photopolymerization of epoxyacrylates.

The content of the photoinitiators or sensitizers used in the curable resin composition is 0.1 to 25 parts by mass, and preferably 1 to 15 parts by mass, based on the 100 parts by mass of the curable resin composition.

As the acrylate resins there are mentioned methyl acrylate, ethyl acrylate, butyl acrylate, benzyl acrylate, cyclohexyl acrylate, ethylene glycol diacrylate, propylene glycol diacrylate, divinylbenzene, 1,4-cyclohexane diacrylate, 1,4-cyclohexyldimethyl diacrylate, trimethylol propane triacrylate, and pentaerythritol tetraacrylate.

As those available on the market, there are mentioned Adekaoptomer KR, BY Series such as KR-400, KR-410, KR-550, KR-566, KR-567 and BY-320B (produced by Asahi Denka Co., Ltd.); Koeihard A-101-KK, A-101WS, C-302, C-401-N, C-501, M-101, M-102, T-102, D-102, NS-101, FT-102Q8, MAG-1-P20, AG-106 and M-101-C (produced by Koei Kagaku Co., Ltd.); Seikabeam PHC2210(S), PHC X-9(K-3), PHC2213, DP-10, DP-20, DP-30, P1000, P1100, P1200, P1300, P1400, P1500, P1600, SCR900 (produced by Dainichiseika Kogyo Co., Ltd.); KRM7033, KRM7039, KRM7130, KRM7131, UVECRYL29201 and UVECRYL29202 (produced by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (produced by Dainippon Ink & Chemicals, Inc.); Olex No. 340 Clear (produced by Chyugoku Toryo Co., Ltd.); Sunrad H-601, RC-750, RC-700, RC-600, RC-500, RC-611 and RC-612 (produced by Sanyo Kaseikogyo Co., Ltd.); SP-1509 and SP-1507 (produced by Syowa Kobunshi Co., Ltd.); RCC-15C (produced by Grace Japan Co., Ltd.); Aronix M-6100, M-8030 and M-8060 (produced by Toagosei Co., Ltd.); and NK Hard B-420, NK Ester A-DOG, NK ESTER A-IBD-2E (produced by Shinakamura Kagaku Co., Ltd.). These can be appropriately employed.

Examples of other acrylate resins include trimethylol propane triacrylate, ditrimethylol propane tetracrylate, pentaerythritol triacrylate, pentaerythritol tetracrylate, dipentaerythritol hexaacrylate and alkyl modified dipentaerythritol pentaacrylate.

### <Method of Forming Cured Resin Layer>

It is preferred that a coating composition for forming a cured resin layer is coated on an acryl resin-containing film through a conventional coating method such as a gravure coater, a dip coater, a reverse coater, a die coater or ink jet printing, dried while heating and subjected to UV curing treatment to form a cured resin layer.

The wet coating amount of the coating composition is properly from 0.1 to 40 μm, and preferably from 0.5 to 30 μm.

The average dry coating amount of the cured layer is properly from 0.1 to 30 μm, and preferably from 1 to 20 μm. This thickness range can prevent lowering of hardness, anti-curling property, flexibility or processability.

Light sources for the UV curing treatment are not specifically limited, and any light sources can be used as long as they can emit UV ray. Examples thereof include a low-pressure mercury lamp, a medium-pressure mercury lamp, a high-pressure mercury lamp, an ultra high-pressure mercury lamp, a carbon arc lamp, a metal halide lamp and a xenon lamp.

The irradiation conditions vary depending on the kinds of a lamp used. The irradiation quantity of the actinic ray is ordinarily from 5 to 500 mJ/cm², and preferably from 5 to 150 mJ/cm².

Irradiation of the actinic ray is preferably carried out while applying tension in the conveyance direction of the film and more preferably while applying tension both in the transverse and in the conveyance direction. The preferred tension applied is from 30 to 300 N/m.

The method to apply tension is not specifically limited. Tension may be applied to a film in the conveyance direction on back rollers or in the transverse direction or in biaxial directions in a tenter, whereby a film with excellent flatness can be obtained.

The organic solvent is preferably propylene glycol monoalkyl ether (the alkyl having a carbon atom number of from 1 to 4) or propylene glycol monoalkyl ether acetate (the alkyl having a carbon atom number of from 1 to 4). The organic solvent content of the coating composition is preferably from 5 to 80% by weight.

It is preferred that a conductive layer, an intermediate layer, an antireflection layer such as a low refractive index layer or a high refractive index layer, or an anti-stain layer is further provided between the cured resin layer and the first protective layer or on the cured resin layer.

### <<Second Protective Film>>

The second protective film in the invention is preferably a melt casting film employing a melt composition containing at least cellulose ester resin and a retardation adjusting agent.

A solution casting method occasionally produces non-uniform distribution of the components contained in the film resulting from sedimentation of the retardation adjusting agent and the like in the solution or in the web, and therefore, a melt casting method is preferred which excels in uniform extrusion of the melt composition.

As the cellulose ester resin or additives such as a plasticizer, a polymer, a UV absorbent and a matting agent to be used, those explained above in the cellulose ester resin layer (A) can be appropriately used in the second protective film.

The film formation of the second protective film employing a melt casting method is not specifically limited, however, it can be carried out according to the method used in the film formation of the first protective film.

Next, a retardation adjusting agent will be explained in detail.

The retardation adjusting agent used in the second protective film is preferably a disc-shaped compound or a rod-shaped compound described later.

### <Retardation Adjusting Agent>

### (Disc-Shaped Compound and Rod-Shaped Compound)

A disc-shaped compound and a rod-shaped compound are preferably compounds represented by formulae (1) through (5)

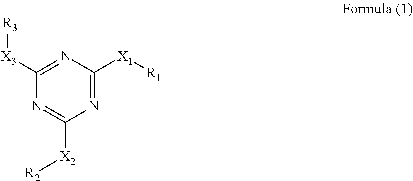

In Formula (1), R₁, R₂ and R₃ independently represent an aromatic ring group or a heterocyclic ring group; X₁ represents a single bond, —NR₄—, —O— or —S—; X₂ is a single bond, —NR₅—, —O— or —S—; X₃ is a single bond, —NR₆—, —O— or —S—; and R₄, R₅ and R₆ independently represent a hydrogen atom, a substituted or unsubstituted alkyl group, a substituted or unsubstituted alkenyl group, a substituted or unsubstituted aryl group or a substituted or unsubstituted heterocyclic ring group.

AR₁-L₄-AR₂ Formula (2)

In formula (2), AR₁ and AR₂ independently represent an aromatic group; and L₁ represents a divalent linkage group selected from the group consisting of an alkylene group, an alkenylene group, an alkynylene group, —O—, —CO— and a combination thereof

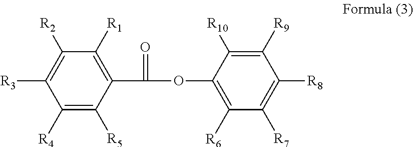

In formula (3), R₁ through R₇, R₉ and R₁₀ independently represent a hydrogen atom or a substituent, provided that at least one of R₁ through R₅ is an electron donating group; and R₈ represents a hydrogen atom, an alkyl group having a carbon atom number of from 1 to 4, an alkenyl group having a carbon atom number of from 2 to 6, an alkynyl group having a carbon atom number of from 1 to 6, an aryl group having a carbon atom number of from 6 to 12, an alkoxy group having a carbon atom number of from 1 to 12, an aryloxy group having a carbon atom number of from 6 to 12, an alkoxycarbonyl group having a carbon atom number of from 2 to 12, an acylamino group having a carbon atom number of from 2 to 12, a cyano group or a halogen atom.

AR₁-L₁-(AR₂-L₂)n-AR₃ Formula (4)

In formula (4), AR₁ and AR₃ independently represent an aryl group, an arylcarbonyl group or an aromatic heterocyclic ring group; AR₂ represents an arylene group or an aromatic heterocyclic ring group; L₁ and L₂ independently represent a single bond or a divalent linkage group; and n is an integer of 3 or more, provided that AR₂ and L₂ may be the same or different.

AR₁-L₁-X-L₂-AR₂ Formula (5)

In formula (5), AR₁ and AR₂ independently represent an aryl group or an aromatic heterocyclic ring group; L₁ and L₂ independently represent —C(═O)O— or —C(═O)NR— in which R represents a hydrogen atom or an alkyl group; and X represents a divalent linkage group represented by the following formula (5-A) or (5-B),

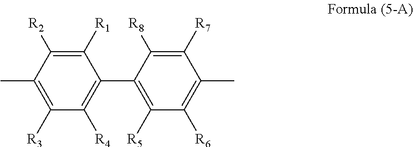

In formula (5), R₁, R₂, R₃, R₄, R₅, R₆, R₇ and R₈ independently represent a hydrogen atom or a substituent.

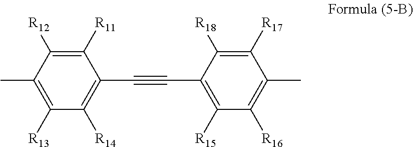

In formula (B), R₁₁, R₁₂, R₁₂, R₁₄, R₁₅, R₁₆, R₁₇ and R₁₈ independently represent a hydrogen atom or a substituent.

Firstly, compounds represented by formula (1) above will be explained below.

In formula (1) above, R₁, R₂ and R₃ independently represent an aromatic ring group or a heterocyclic ring group. The aromatic ring group represented by R₁, R₂ and R₃ is preferably a phenyl group or a naphthyl group, and more preferably a phenyl group. The aromatic ring group represented by R₁, R₂ and R₃ may have a substituent. Examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamido group, a carbamoyl group, an alkyl-substituted carbamoyl group, an alkenyl-substituted carbamoyl group, an aryl-substituted carbamoyl group, an amido group, an alkylthio group, an alkenylthio group, an arylthio group and an acyl group. The above alkyl group is the same as the foregoing alkyl group.

It is preferred that the heterocyclic ring group represented by R₁, R₂ and R₃ of formula (1) has aromaticity. The heterocyclic ring having aromaticity is usually an unsaturated heterocyclic ring, and preferably a heterocyclic ring having the largest number of double bonds. The heterocyclic ring is preferably a 5-, 6- or 7-member ring, more preferably a 5- or 6-member ring, and most preferably a 6-member ring. The hetero atom in the heterocyclic ring is preferably a nitrogen atom, a sulfur atom or an oxygen atom, and more preferably a nitrogen atom. As the heterocyclic ring having aromaticity, a pyridine ring (2-pyridyl or 4-pyridyl group as a heterocyclic ring group) is especially preferable. The heterocyclic ring group may have a substituent. Examples of the substituent are the same as those denoted in the foregoing aryl group.

When X₁, X₂ and X₃ are each a single bond, the heterocyclic ring is preferably one having a free valence at the nitrogen atom. The heterocyclic ring group having the free valence at the nitrogen atom is preferably 5-, 6- or 7-member ring, more preferably a 5- or 6-member ring, and most preferably a 5-member ring. The heterocyclic ring group may have plural nitrogen atoms. The heterocyclic ring group may have a hetero-atom other than the nitrogen atom (such as O or S). Examples of the heterocyclic ring group having the free valence at the nitrogen atom will be listed below.

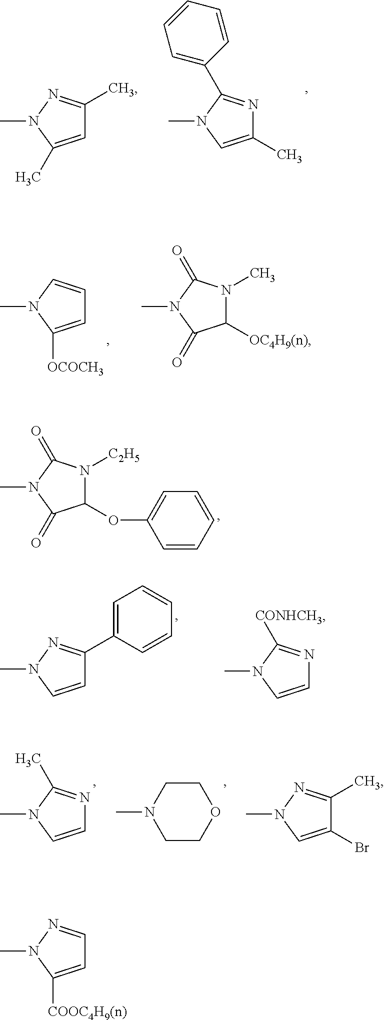

In Formula (1), X₁ represents a single bond, —NR₄—, —O— or —S—; X₂ represents a single bond, —NR₅—, —O— or —S—; X₃ represents a single bond, —NR₆—, —O— or —S—; and R₄, R₅ and R₆ independently represent a hydrogen atom, a substituted or unsubstituted alkyl group, a substituted or unsubstituted alkenyl group, a substituted or unsubstituted aryl group or a substituted or unsubstituted heterocyclic ring group.

In formula (1), the alkyl group represented by R₄, R₅ or R₆ may be a cyclic or chained alkyl group but preferably a chained alkyl group. Further, a straight-chained alkyl group is preferable to a branched alkyl group. The carbon atom number of the alkyl group is preferably from 1 to 30, more preferably from 1 to 20, still more preferably from 1 to 10, further still more preferably from 1 to 8, and most preferably from 1 to 6.

The alkyl group may have a substituent. Examples of the substituent include a halogen atom, an alkoxy group (such as a methoxy group or an ethoxy group), and an acyloxy group (such as an acryloyloxy group and a methacryloyloxy group).

In formula (1), the alkenyl group represented by R₄, R₅ or R₆ may be a cyclic or chained alkenyl group but preferably a chained alkenyl group. Further, a straight-chained alkenyl group is preferable to a branched alkenyl group. The carbon atom number of the alkenyl group is preferably from 2 to 30, more preferably from 2 to 20, still more preferably from 2 to 10, further still more preferably from 2 to 8, and most preferably from 2 to 6. The alkyl group may have a substituent. Examples of the substituent are the same as denoted above in the alkyl group.

In formula (1), the aromatic ring group and heterocyclic ring group represented by R₄, R₅ or R₆ are the same as those represented by R₁, R₂ or R₃ and the preferred groups of R₄, R₅ or R₆ are the same as those of R₁, R₂ or R₃. The aromatic ring group and heterocyclic ring group may further have a substituent, for example, substituent are the same as those of the aromatic ring group and heterocyclic ring group in R₁, R₂ or R₃.

Of these, the especially preferred compounds are ones in which X₁ is —NR₄—, X₂ is —NR₅—, and X₃ is —NR₆—.

Next, typical examples of the compounds represented by formula (1) will be listed.

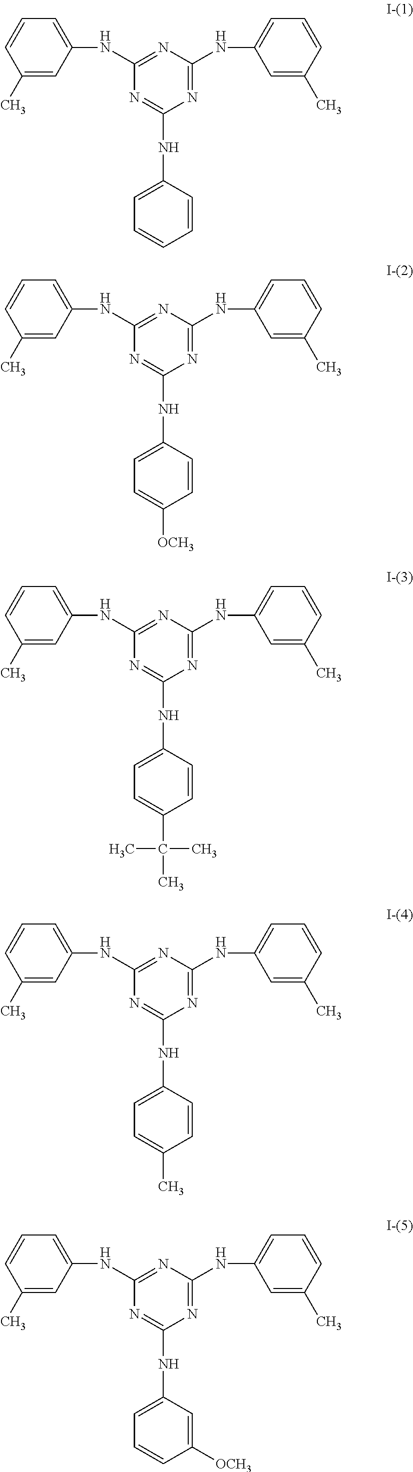

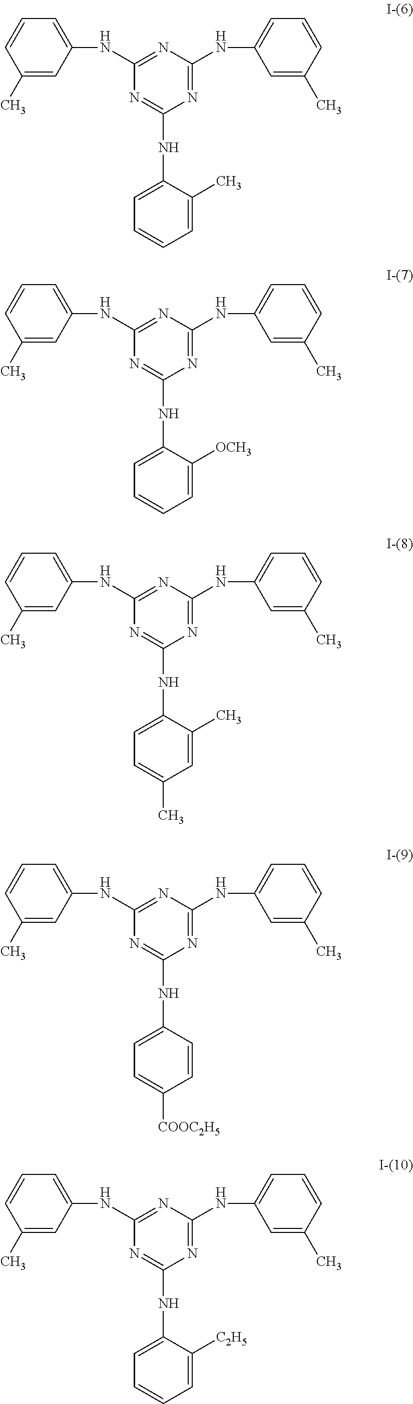

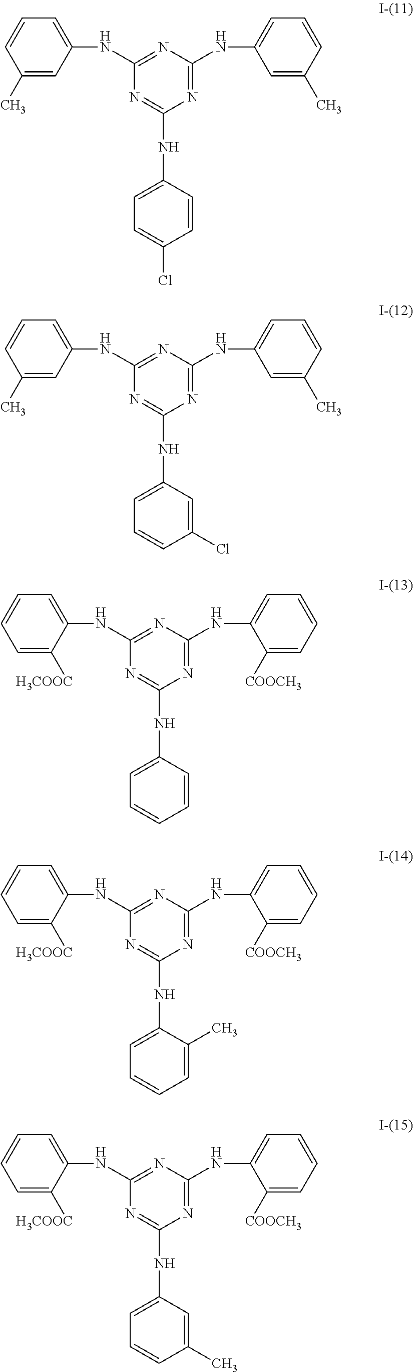

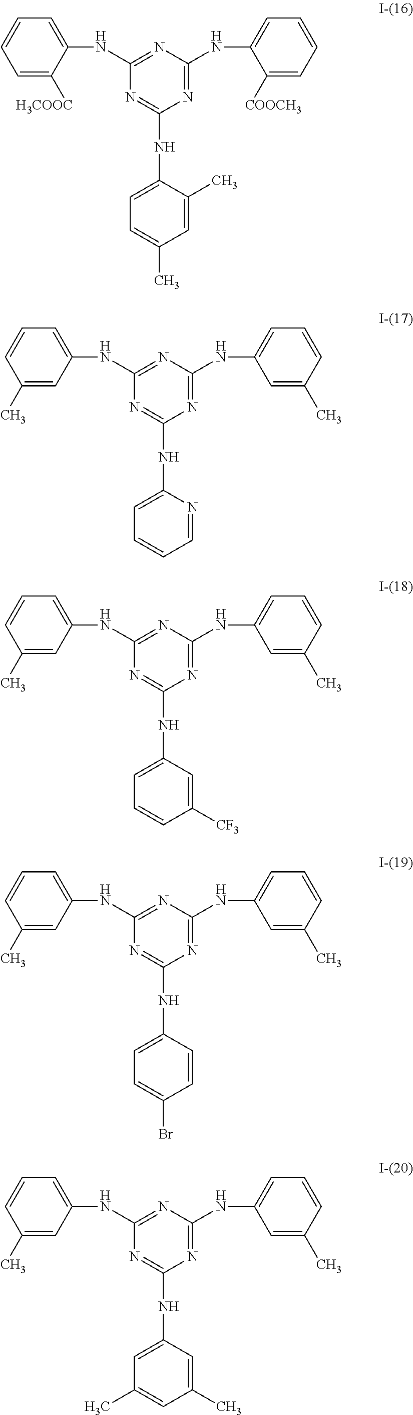

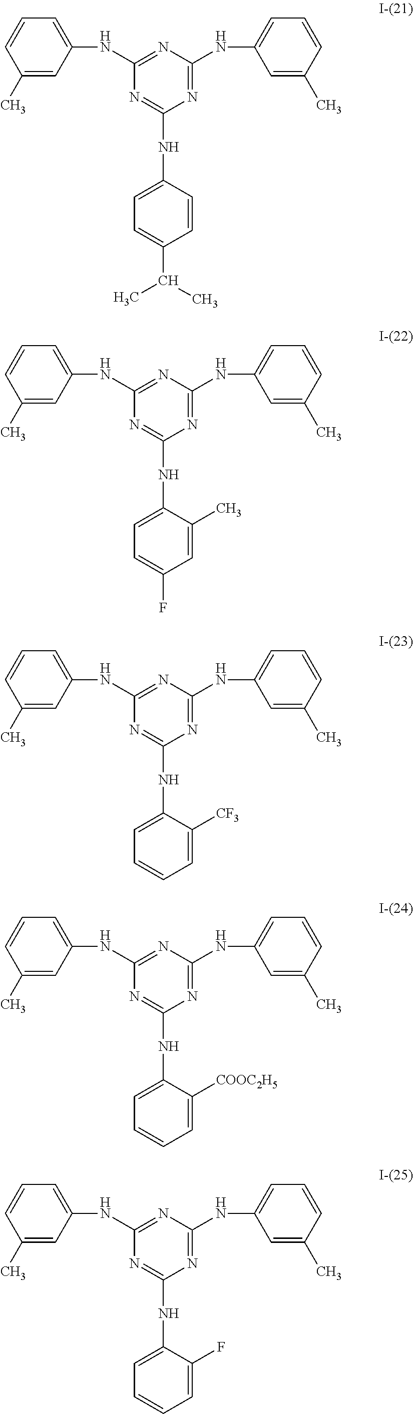

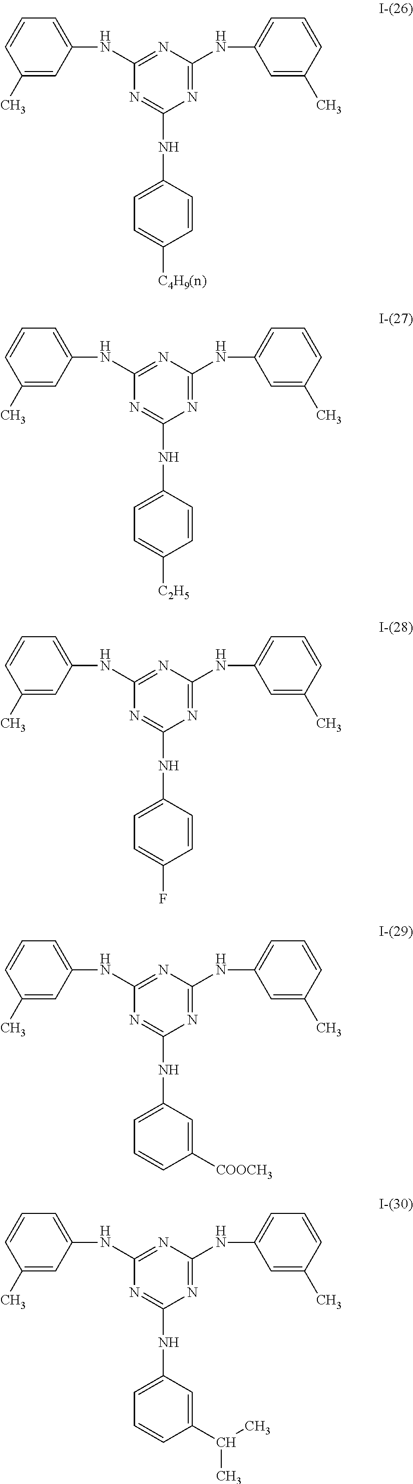

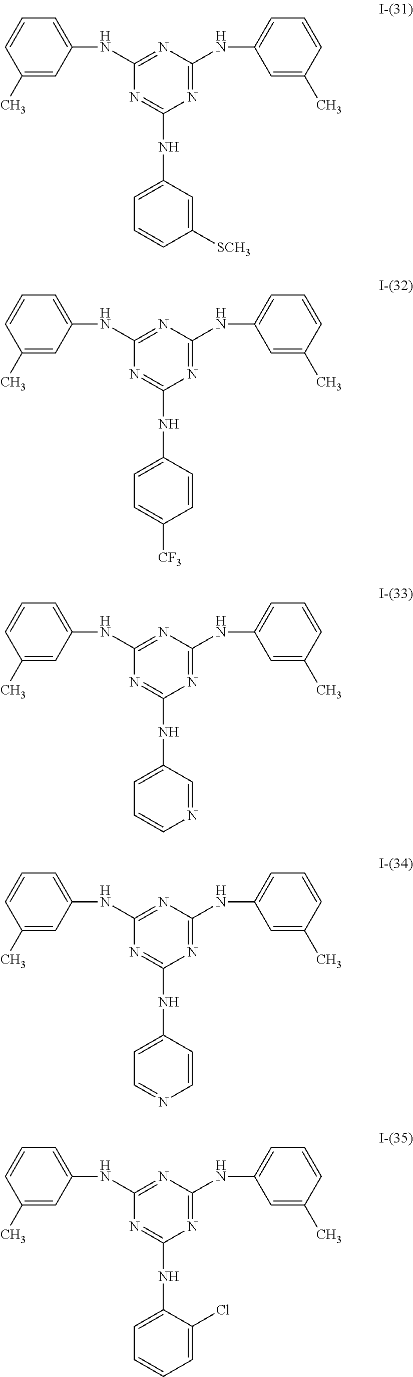

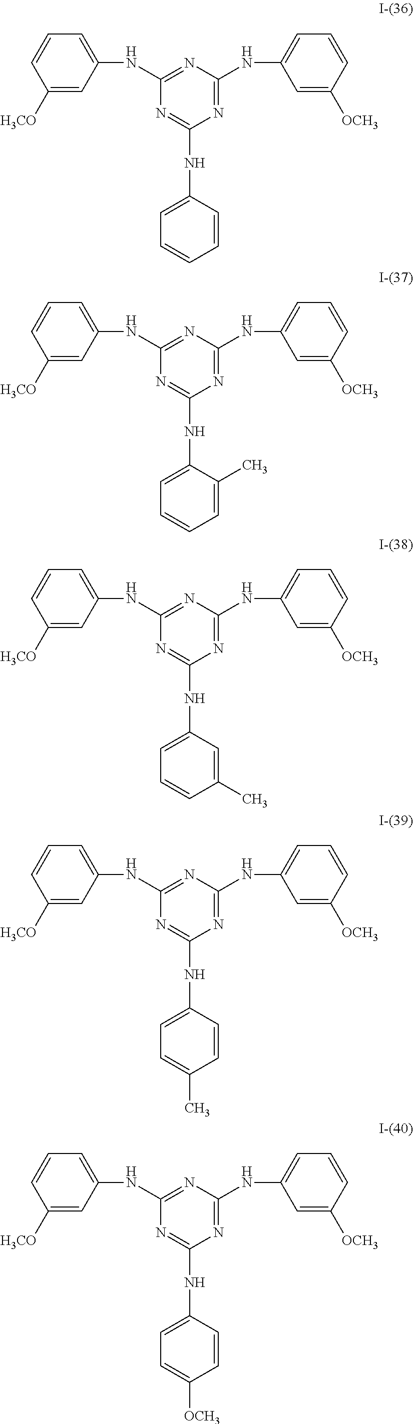

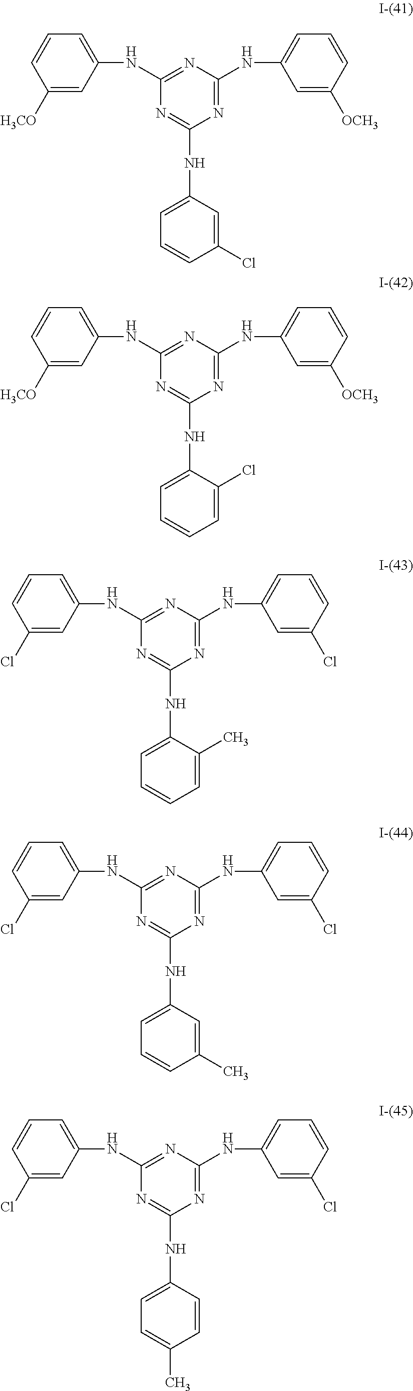

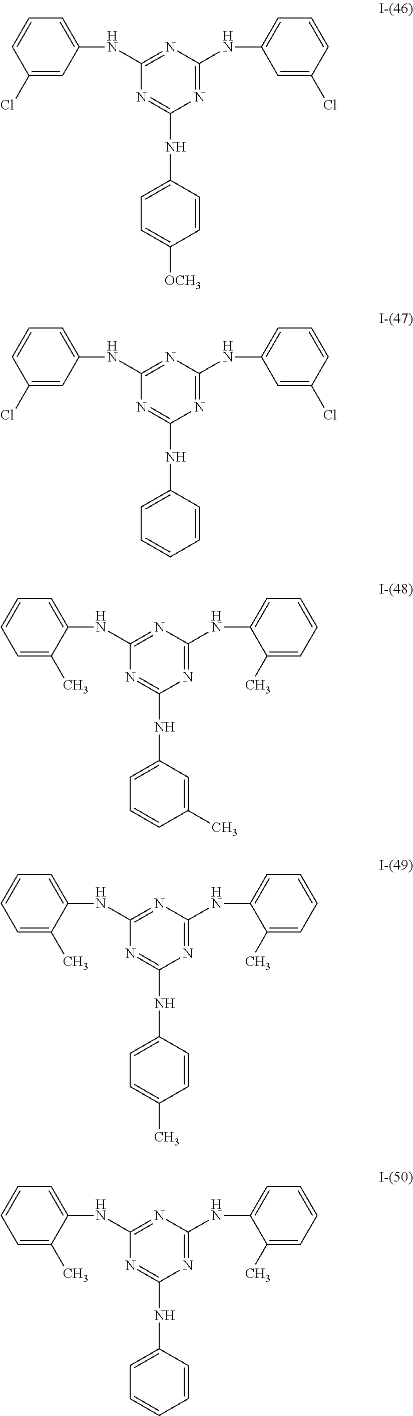

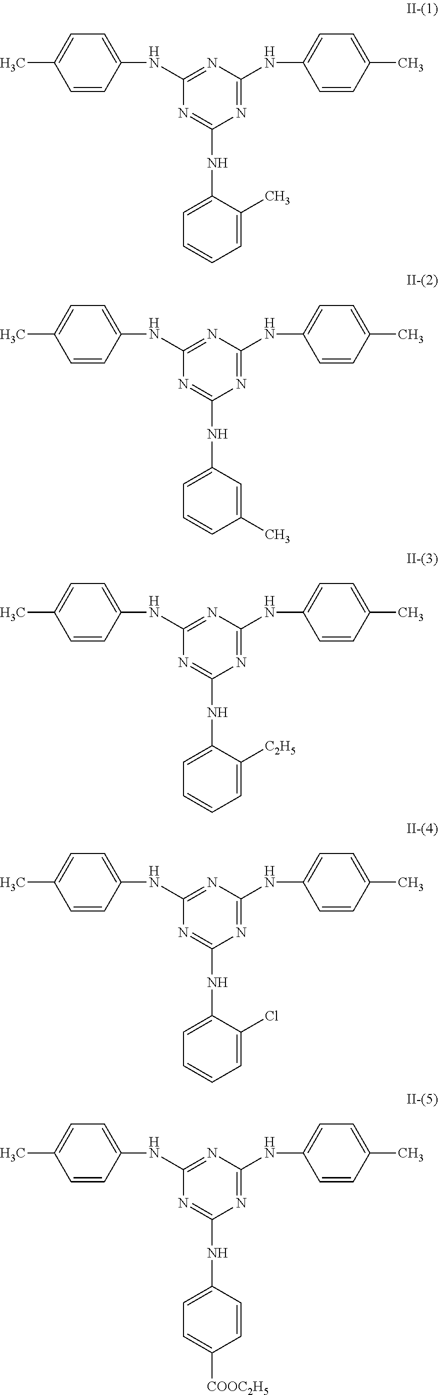

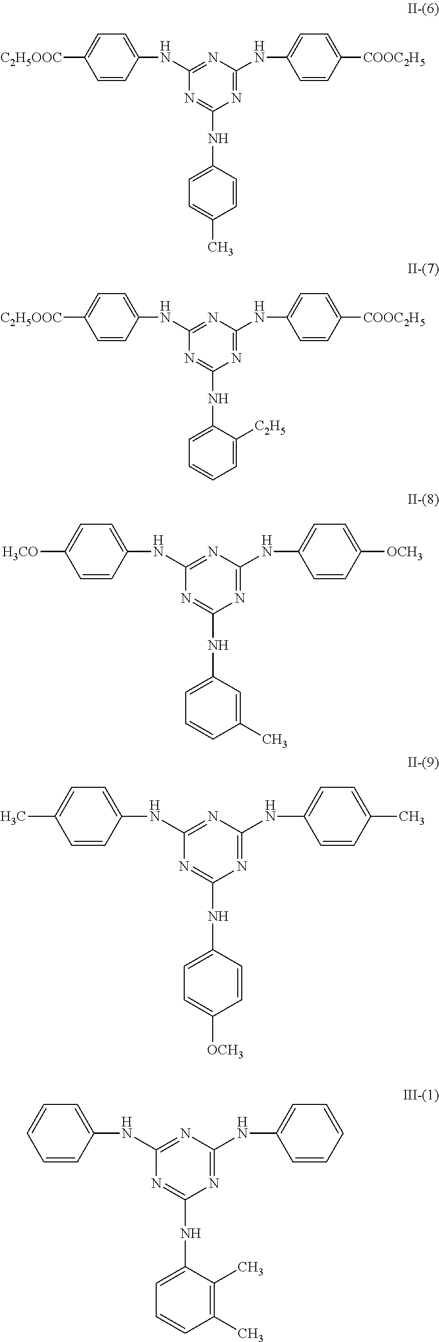

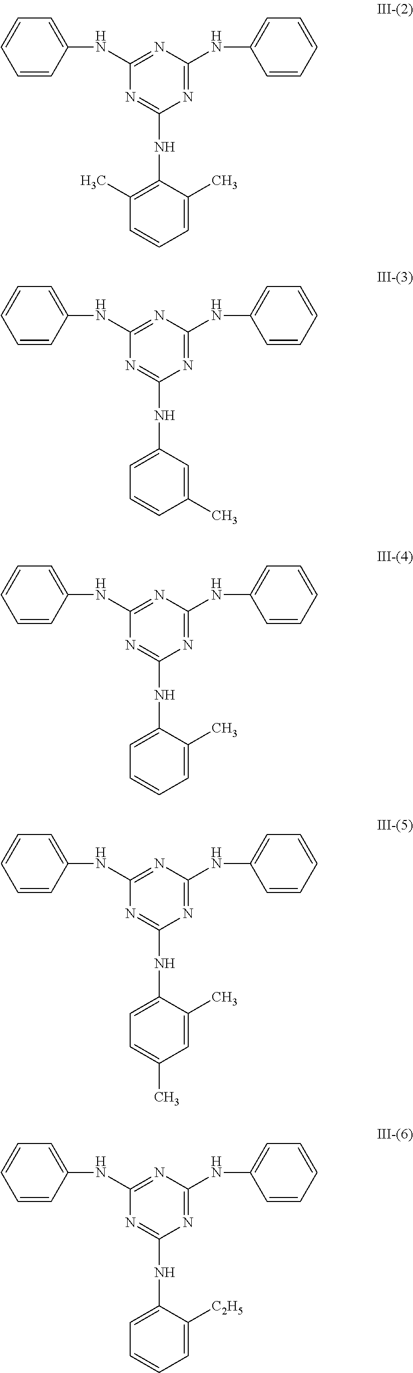

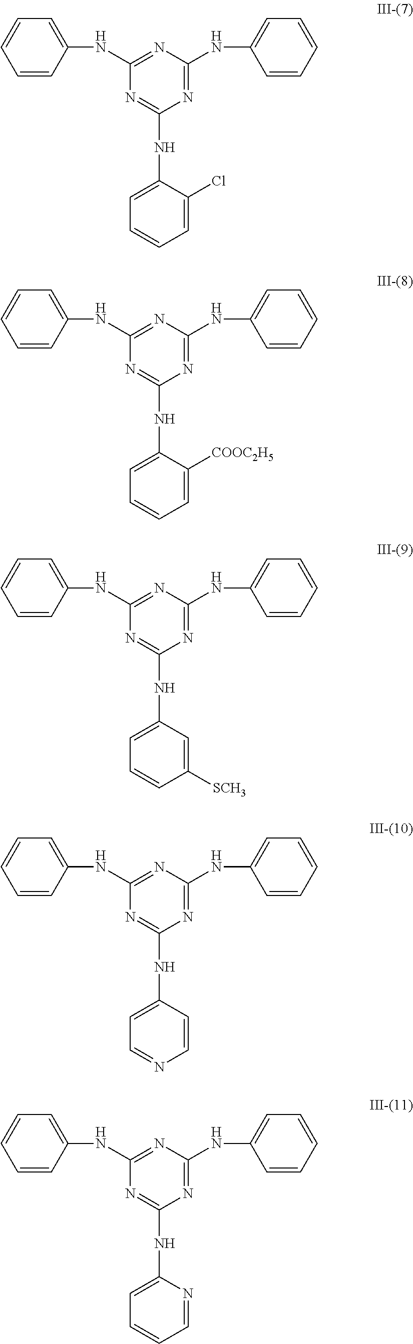

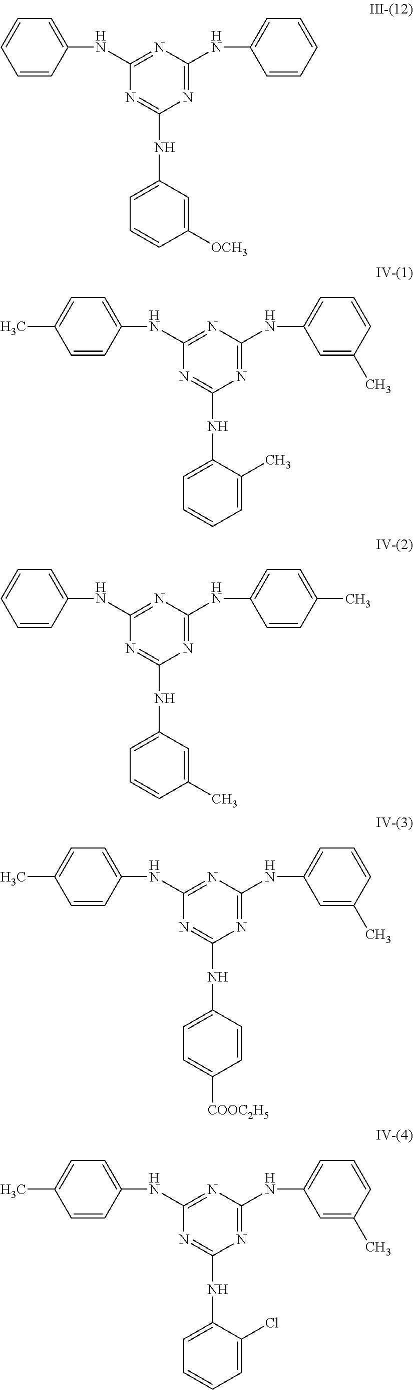

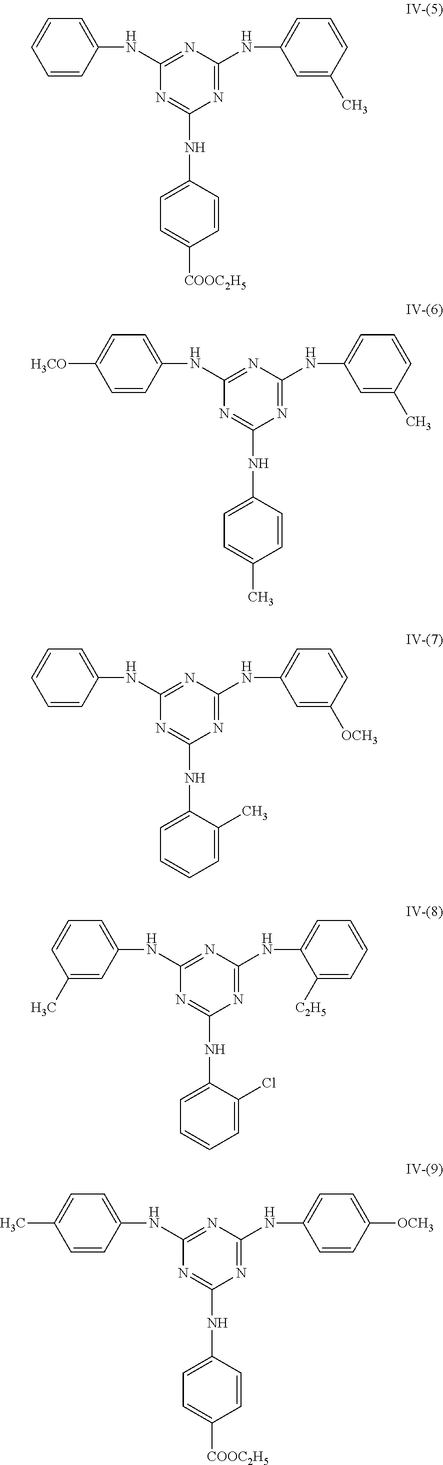

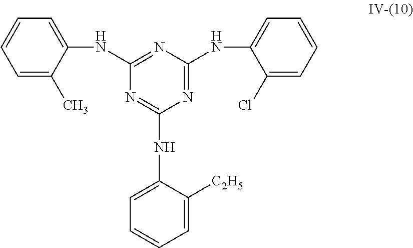

Other examples include compounds disclosed in Japanese Patent O.P.I. Publication No. 2006-71876, paragraphs [0079] through [0103].

Next, a synthetic method of a low molecular weight compound represented by formula (1) will be described. Compounds other than the compound as shown in the following synthetic example can be synthesized in the same manner as described below.

### Synthetic Example 1

### Synthesis of Exemplified Compound I-(2)

A mixture of 9.1 kg (25 mol) of 2,4-di-m-toluidino-6-chloro-1,3,5-triazine and 3.1 kg (25 mol) of p-anisidine was dissolved in 20 liter of dimethylformamide. The resulting solution was added with 5.2 kg (37.5 mol) of potassium carbonate and reacted at 120° C. for 2 hours. The reaction solution was cooled and extracted with 100 liters of ethyl acetate. The extract was dried over anhydrous sodium sulfate. The ethyl acetate was removed under reduced pressure, and the resulting residue was subjected to column chromatography employing an n-hexane/ethyl acetate (5/1 by volume ratio) mixture solution as an elute to obtain an objective compound (yield 9.1 kg, 88%). The chemical structure of the compound was identified according to NMR spectra, MS spectra and elemental analysis.

Next, a compound represented by formula (2) will be explained.

The compound represented by formula (2) above preferably has a linear molecular structure. The linear molecular structure means that the molecular structure of the rod-shaped compound is linear in the thermodynamically most stable structure state. The thermodynamically most stable structure can be determined by crystal structure analyzing or molecular orbital calculation. The molecular structure providing a minimum heat of formation can be determined by molecular orbital calculation, for example, a software for molecular orbital calculation WinMOPAC2000 manufactured by Fujitsu Co., Ltd. The linear molecular structure means that the angle of the molecular structure is not less than 140° in the thermodynamically most stable structure calculated as above.

In Formula (2), AR₁ and AR₂ independently represent an aromatic group. The aromatic group in the invention includes an aryl group (an aromatic hydrocarbon group), a substituted aryl group, an aromatic heterocyclic ring group and a substituted heterocyclic ring group. As the aromatic group, the aryl group and the substituted aryl group are preferable to the aromatic heterocyclic ring group and the substituted aromatic heterocyclic ring group. The heterocyclic ring of the aromatic heterocyclic ring group is usually unsaturated. The aromatic heterocyclic ring is preferably a 5-, 6- or 7-member ring, and more preferably a 5- or 6-member ring. The aromatic heterocyclic ring usually has the largest number of double bonds. The hetero atom of the heterocyclic ring is preferably a nitrogen atom, an oxygen atom or a sulfur atom and more preferably a nitrogen atom or an oxygen atom. Examples of the aromatic heterocyclic ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring and a 1,3,5-triazine ring.

As the aromatic ring of the aromatic group, a benzene ring, a furan ring, a thiophene ring, a pyrrole ring, an oxazole ring, a thiazole ring, a thiazole ring, an imidazole ring, a triazole ring, a pyridine ring, a pyrimidine ring and pyrazine ring are preferable, and a benzene ring is especially preferable.

Examples of the substituent of the substituted aryl group and the substituted aromatic heterocyclic ring group include a halogen atom (F, Cl, Br, I); a hydroxyl group; a carboxyl group; a cyano group; an amino group; an alkylamino group (such as a methylamino group, an ethylamino group, a butylamno group or a dimethylamino group); a nitro group; a sulfo group; a carbamoyl group; an alkylcarbamoyl group (such as an N-methylcarbaamoyl group, an N-ethylcarbaamoyl group or an N,N-dimethylcarbamoyl group); a sulfamoyl group; an alkylsulfamoyl group (such as an N-methylsulfamoyl group, an N-ethylsulfamoyl group or an N,N-dimethylsulfamoyl group); a ureido group; an alkylureido group (such as an N-methylureido group, an N,N-dimethylureido group or an N,N,N-trimethylureido group); an alkyl group (such as a methyl group, an ethyl group, a propyl group, a butyl group, a pentyl group, a heptyl group, an octyl group, an isopropyl group, an s-butyl group, a t-amyl group, a cyclohexyl group or a cyclopentyl group); an alkenyl group (such as a vinyl group, an allyl group or a hexenyl group); an alkynyl group (such as an ethynyl group and a butynyl group); an acyl group (such as a formyl group, an acetyl group, a butylyl group, a hexanoyl group or a lauryl group); an acyloxy group (such as an acetoxy group, a butylyloxy group, a hexanoyloxy group or lauryloxy group); an alkoxy group (such as a methoxy group, an ethoxy group, a propoxy group, a butoxy group, a pentyloxy group, a heptyloxy group or an octyloxy group); an aryloxy group (such as a phenoxy group) an alkoxycarbonyl group (such as a methoxycarbonyl group, an ethoxycarbonyl group, a propoxycarbonyl group, a butoxycarbonyl group, a pentyloxycarbonyl group or a heptyloxycarbonyl group); an aryloxycarbonyl group (such as a phenoxycarbonyl group); an alkoxycarbonylamino group (such as a butoxycarbonylamino group and a hexyloxycarbonylamino group); an alkylthio group (such as a methylthio group, an ethylthio group, a propylthio group, butylthio group, a pentylthio group, a heptylthio group or an octylthio group; an arylthio group (such as a phenylthio group); an alkylsulfonyl group (such as a methylsulfonyl group, an ethylsulfonyl group, a propylsulfonyl group, a butylsulfonyl group, a pentylsulfonyl group, a heptylsulfonyl group or an octylsulfonyl group); an amido group (such as an acetoamido group, a butylamido group, a hexylamido group or an laurylamido group, and a non-aromatic heterocyclic ring group (such as a morpholyl group and a pyradinyl group).

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferred.

The alkyl moiety of the alkylamino group, the alkoxycarbonyl group, the alkoxy group and the alkylthio group, and the alkyl group each may further have a substituent. Examples of the substituent of the alkyl moiety or the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic ring group. The halogen atom, the hydroxyl group, an amino group, an alkylamino group, an acyl group, an acyloxy group, an acylamino group, an alkoxycarbonyl group and an alkoxy group are preferred as the substituent of the alkyl moiety or the alkyl group.

In Formula (2), L1 is a divalent linkage group selected from the group consisting of an alkylene group, an alkenylene group, an alkynylene group, —O—, —CO— and a combination thereof. The alkylene group may be chained or cyclic. The cyclic alkylene group is preferably a cyclohexylene group, and more preferably a 1,4-cyclohexylene group. As the chained alkylene group, a straight-chain alkylene group is preferable to a branched alkylene group. The carbon atom number of the alkylene group is preferably from 1 to 20, more preferably from 1 to 15, still more preferably from 1 to 10, further still more preferably from 1 to 8, and most preferably from 1 to 6.

The alkenylene group and the alkynylene group each having a chained structure are preferable to those having a cyclic structure, and a straight-chained structure is preferable to a branched structure. The carbon atom number of the alkenylene group and the alkynylene group is preferably from 2 to 10, more preferably from 2 to 8, still more preferably from 2 to 6, further still more preferably 2 to 4, and most preferably 2 (i.e., vinylene or ethynylene).

Examples of the divalent linkage group will be listed below which is composed of a combination of groups shown below.

L-1: —O—CO-alkylene-CO—O—

L-2: —CO—O-alkylene-O—CO—

L-3: —O—CO-alkenylene-CO—O—

L-4: —CO—O-alkenylene-O—CO—

L-5: —O—CO-alkynylene-CO—O—

L-6: —CO—O-alkynylene-O—CO—

In the structure of Formula (2), the angle formed by AR₁ and AR₂ through L₁ is preferably from 140° to 180°.

Typical examples of the compound represented by formula (2) will be listed below.

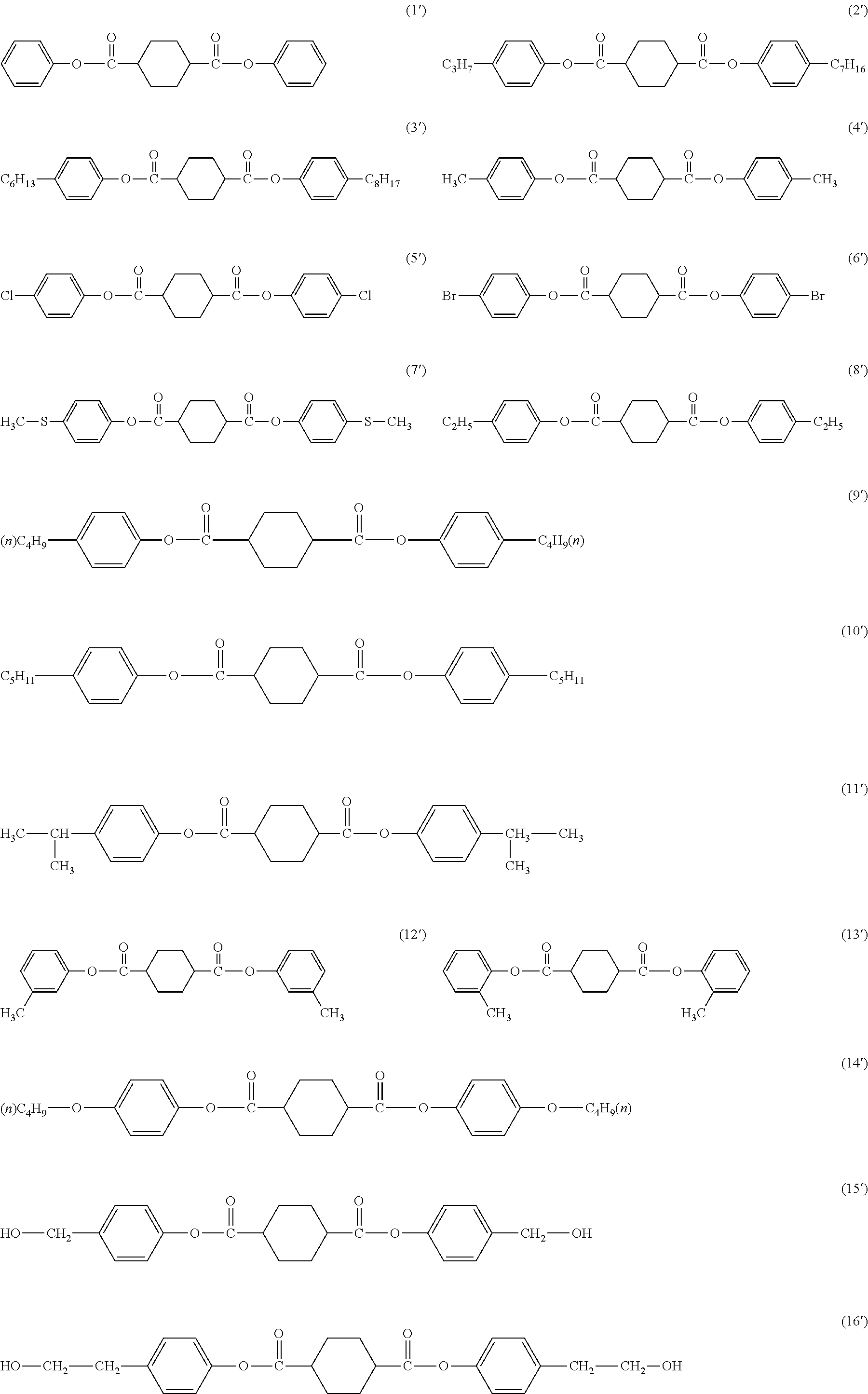

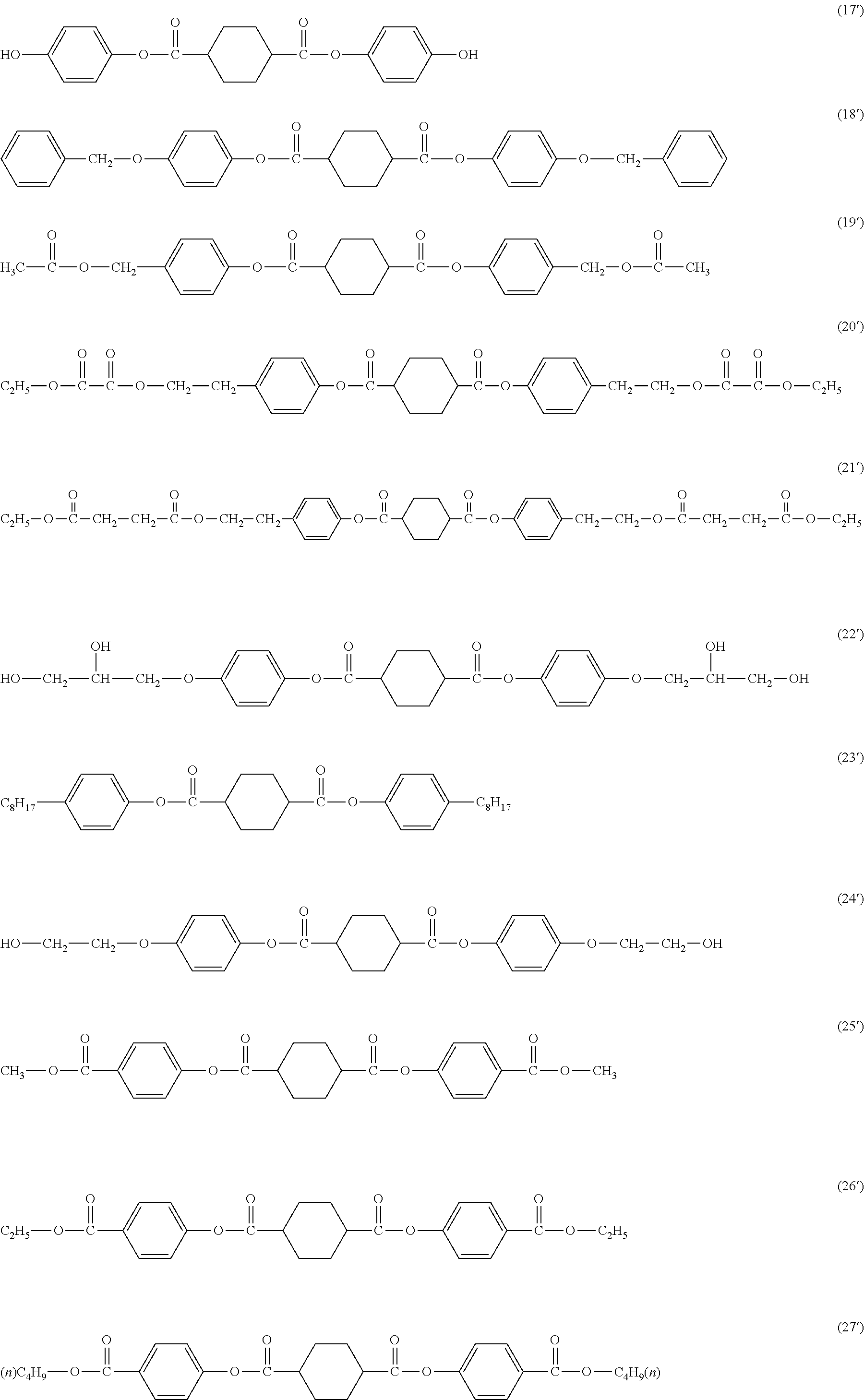

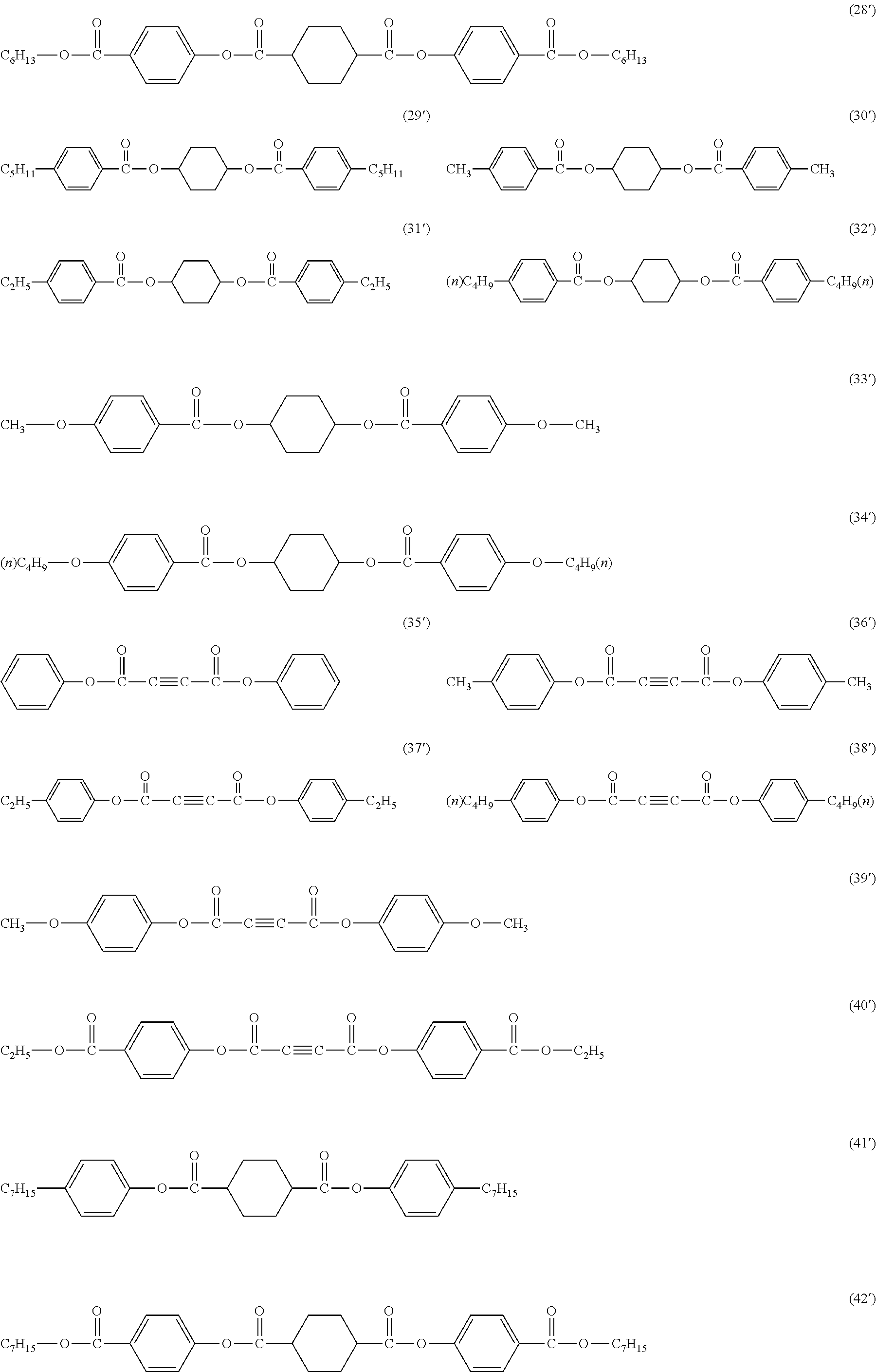

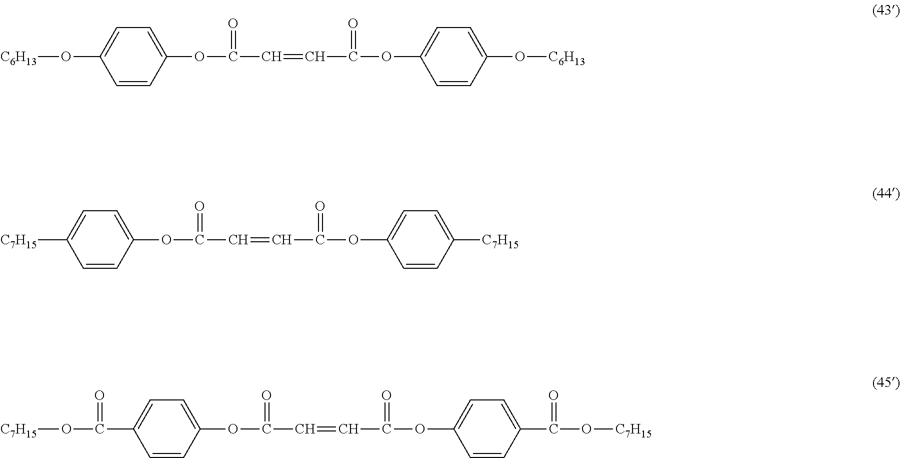

In formula (2), each of the above Exemplified compounds (1′) to (34′), (41′) and (42′) has two asymmetric carbon atoms at 1- and 4-positions of the cyclohexane ring. However, Exemplified compounds (1′), (4′) to (34′), (41′) and (42′) do not form optical isomers (no optical activity) since they have symmetrical meso form molecular structure, and can form only geometric isomers. In Exemplified compound (1′) of formula (2), trans-form (1-trans) and cis-form (1-cis) will be shown below.

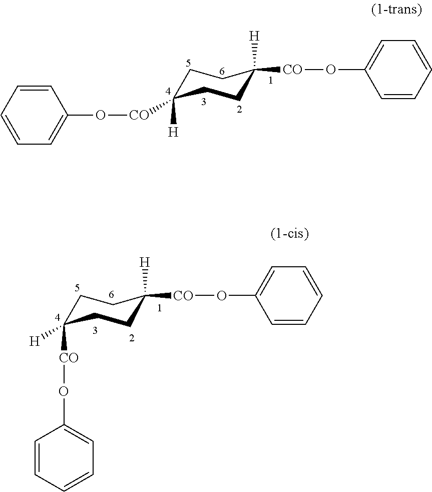

As is decd above, the compound represented by formula (2) preferably has a linear molecular structure. Therefore, the trans form is preferable to the cis-form. Exemplified compounds (2′) and (3′) have the optical isomers in addition to the geometric isomers (four isomers in total). Regarding the geometric isomers, the trans-form is preferable to the cis-form. There is no difference between the optical isomers and any of d-, l- and racemic-body can be applicable. In Exemplified compounds (43′) to (45′), cis-form and trans-form are formed at the vinylene bond at the center of the molecules. The trans-form is preferable to the cis-form for the same reason as above.

In the invention, two or more kinds of the compounds represented by formula (2) each having absorption maximum at a wavelength shorter than 250 nm may be employed in combination. The compounds represented by formula (2) can be synthesized according to a method disclosed in the literature. As the literature, there are mentioned “Mol. Cryst. Liq. Cryst.” vol. 53, p. 229, 1979, ibid. vol. 89, p. 93, 1982, ibid. vol. 145, p. 111, 1987, and ibid. vol. 170, p. 43, 1989, “J. Am. Chem. Soc.” Vol. 113, p. 1349, 1991, ibid. vol. 118, p. 5346, 1996, and ibid. vol. 92, p. 1582, 1970, “J. Org. Chem.” Vol. 40, p. 420, 1975, and “Tetrahedron” vol. 48, No. 16, p. 3437, 1992.

Next, a compound represented by formula (3) will be explained.

In formula (3) above, R₁ through R₇, and R₉ and R₁₀ independently represent a hydrogen atom or a substituent. As such a substituent, there is mentioned a substituent T₁ described later.

At least one of R₁ through R₅ represents an electron donating group. In formula (3), it is preferred that at least one of R₁, R₃ and R₅ represents an electron donating group, and it is more preferred that R₃ represents an electron donating group.

The “electron donating group” refers to one which having a Hammet σp of not more than 0. One having a Hammet σp of not more than 0, described in Chem. Rev., 91, 165 (1991), is preferred and one having a Hammet σp of from −0.85 to 0 is more preferred. Examples of the electron donating group include an alkyl group, an alkoxy group, an amino group, and a hydroxyl group.

The electron donating group is preferably an alkyl group or an alkoxy group, and more preferably an alkoxy group (having a carbon atom number of preferably from 1 to 12, more preferably from 1 to 8, still more preferably from 1 to 6, and most preferably from 1 to 4).

In formula (3), R₁ is preferably a hydrogen atom or an electron donating group, more preferably an alkyl group, an alkoxy group, an amino group or a hydroxyl group, sill more preferably an alkyl group having a carbon atom number of from 1 to 4 or an alkoxy group having a carbon atom number of from 1 to 12, further still more preferably an alkoxy group (having a carbon atom number of preferably from 1 to 12, more preferably from 1 to 8, still more preferably from 1 to 6, and most preferably from 1 to 4) and most preferably a methoxy group.

In formula (3), R₂ is preferably a hydrogen atom, an alkyl group, an alkoxy group, an amino group or a hydroxyl group, and more preferably a hydrogen atom or an alkyl group (an alkyl group having a carbon atom number of preferably from 1 to 4, more preferably a methyl group) or an alkoxy group (having a carbon atom number of preferably from 1 to 12, more preferably from 1 to 8, still more preferably from 1 to 6, and most preferably from 1 to 4), and most preferably a hydrogen atom, a methyl group or a methoxy group.

In formula (3), R₃ is preferably a hydrogen atom or an electron donating group, more preferably a hydrogen atom, an alkyl group, an alkoxy group, an amino group or a hydroxyl group, still more preferably an alkyl group or an alkoxy group, further still more preferably an alkoxy group (having a carbon atom number of preferably from 1 to 12, more preferably from 1 to 8, still more preferably from 1 to 6, and most preferably from 1 to 4), and most preferably a propoxy group, an ethoxy group or a methoxy group.

In formula (3), R₄ is preferably a hydrogen atom or an electron donating group; more preferably a hydrogen atom, an alkyl group, an alkoxy group, an amino group or a hydroxyl group; still more preferably a hydrogen atom, an alkyl group having a carbon atom number of from 1 to 4 or an alkoxy group having a carbon atom number of from 1 to 12 (preferably from 1 to 12, more preferably from 1 to 8, still more preferably from 1 to 6, and most preferably from 1 to 4); further still more preferably a hydrogen atom, an alkyl group having a carbon atom number of from 1 to 4 or an alkoxy group having a carbon atom number of from 1 to 4); and most preferably a hydrogen atom, a methyl group or a methoxy group.

In formula (3), the preferred groups of R₅ are the same as those denoted in R₂ above.

In formula (3), each of R₆, R₇, R₉ and R₁₀ is preferably a hydrogen atom, an alkyl group having a carbon atom number of from 1 to 12, an alkoxy group having a carbon atom number of from 1 to 12 or a halogen atom, more preferably a hydrogen atom or a halogen atom, and still more preferably a hydrogen atom.

In formula (3), R₈ represents a hydrogen atom, an alkyl group having a carbon atom number of from 1 to 4, an alkenyl group having a carbon atom number of from 2 to 6, an alkynyl group having a carbon atom number of from 2 to 6, an aryl group having a carbon atom number of from 6 to 12, an alkoxy group having a carbon atom number of from 1 to 12, an aryloxy group having a carbon atom number of from 6 to 12, an alkoxycarbonyl group having a carbon atom number of from 2 to 12, an acylamino group having a carbon atom number of from 2 to 12, a cyano group or a halogen atom, each of which may have a substituent if possible. As such a substituent, there is mentioned a substituent T₁ described later.

In formula (3), R₈ is preferably an alkyl group having a carbon atom number of from 1 to 4, an alkynyl group having a carbon atom number of from 2 to 6, an aryl group having a carbon atom number of from 6 to 12, an alkoxy group having a carbon atom number of from 1 to 12 or an aryloxy group having a carbon atom number of from 6 to 12, more preferably an aryl group having a carbon atom number of from 6 to 12, an alkoxy group (having a carbon atom number of preferably from 1 to 12, more preferably from 1 to 8, still more preferably from 1 to 6, and most preferably from 1 to 4), and most preferably a methoxy group, an ethoxy group, an n-propoxy group or an iso-butoxy group.

Next, the substituent T₁ will be explained.

Examples of the substituent T₁ include an alkyl group (an alkyl group having a carbon atom number of preferably from 1 to 20, more preferably from 1 to 12 and still more preferably from 1 to 8, for example, a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.); an alkenyl group (an alkenyl group having a carbon atom number of preferably from 2 to 20, more preferably from 2 to 12 and still more preferably from 2 to 8, for example, a vinyl group, an allyl group, a 2-butenyl group, 3-pentenyl group, etc.); an alkynyl group (an alkynyl group a carbon atom number of from 2 to 20, more preferably from 2 to 12 and still more preferably from 2 to 8, for example, a propargyl group, a 3-pentynyl group, etc.); an aryl group (an aryl group having a carbon atom number of preferably from 6 to 30, more preferably from 6 to 20 and still more preferably from 6 to 12, for example, a phenyl group, a p-methylphenyl group, a naphthyl group, etc.); a substituted or unsubstituted amino group (a substituted or unsubstituted amino group having a carbon atom number of preferably from 0 to 20, more preferably from 0 to 10 and still more preferably from 0 to 6, for example, an amino group, a methylamino group, a dimethylamino group, a diethylamino group, a dibenzylamino group, etc.); an alkoxy group (an alkoxy group having a carbon atom number of preferably from 1 to 20, more preferably from 1 to 12, and still more preferably from 1 to 8, for example, a methoxy group, an ethoxy group, a butoxy group, etc.); an aryloxy group (an aryloxy group having a carbon atom number of preferably from 1 to 20, more preferably from 1 to 12, and still more preferably from 1 to 8, for example, a phenyloxy group, a 2-naphthyloxy group, etc.); an acyl group (an acyl group having a carbon atom number of preferably from 1 to 20, more preferably from 1 to 16 and still more preferably from 1 to 12, for example, an acetyl group, a benzoyl group, a formyl group, a pivaloyl group, etc.); an alkoxycarbonyl group (an alkoxycarbonyl group having a carbon atom number of preferably from 2 to 20, more preferably from 2 to 16 and still more preferably from 2 to 12, for example, a methoxycarbonyl group, an ethoxycarbonyl group, etc.); an aryloxycarbonyl group (an aryloxycarbonyl group having a carbon atom number of preferably from 7 to 20, more preferably from 7 to 16 and still more preferably from 7 to 10, for example, a phenyloxycarbonyl group, etc.); an acyloxy group (an acyloxy group having a carbon atom number of preferably from 2 to 20, more preferably from 2 to 16 and still more preferably from 2 to 10, for example, an acetoxy group, a benzoyloxy group, etc.); an acylamino group (an acylamino group having a carbon atom number of preferably from 2 to 20, more preferably from 2 to 16 and still more preferably from 2 to 10, for example, an acetylamino group and a benzoylamino group); an alkoxycarbonylamino group (an alkoxycarbonylamino group having a carbon atom number of preferably from 2 to 20, more preferably from 2 to 16 and still more preferably from 2 to 12, for example, a methoxycarbonylamino group, etc.); an aryloxycarbonylamino group (an aryloxycarbonylamino group having a carbon atom number of preferably from 7 to 20, more preferably from 7 to 16 and still more preferably from 1 to 12, for example, a phenyloxycarbonylamino group, etc.); a sulfonylamino group (a sulfonylamino group having a carbon atom number of preferably from 1 to 20, more preferably from 1 to 16 and still more preferably from 1 to 12, for example, a methanesulfonylamino group, a benzensulfonylamino group, etc.); a sulfamoyl group (a sulfamoyl group having a carbon atom number of preferably from 0 to 20, more preferably from 0 to 16 and still more preferably from 0 to 12, for example, a sulfamoyl group, a methylsulfamoyl group, a dimethylsulfamoyl group, a phenylsulfamoyl group, etc.); a carbamoyl group (a carbamoyl group having a carbon atom number of preferably from 1 to 20, more preferably from 1 to 16 and still more preferably from 1 to 12, for example, a carbamoyl group, a methylcarbamoyl group, a diethylcarbamoyl group, a phenylcarbamoyl group, etc.); an alkylthio group (an alkylthio group having a carbon atom number of preferably from 1 to 20, more preferably from 1 to 16 and still more preferably from 1 to 12, for example, a methylthio group, an ethylthio group, etc.); an arylthio group (an arylthio group having a carbon atom number of preferably from 6 to 20, more preferably from 6 to 16 and still more preferably from 6 to 12, for example, a phenylthio group, etc.); an alkylsulfonyl or arylsulfonyl group (an alkylsulfonyl or arylsulfonyl group having a carbon atom number of preferably from 1 to 20, more preferably from 1 to 16 and still more preferably from 1 to 12, for example, a mesyl group, a tosyl group, etc.); an alkylsulfinyl or arylsulfinyl group (an alkylsulfinyl or arylsulfinyl group having a carbon atom number of preferably from 1 to 20, more preferably from 1 to 16 and still more preferably from 1 to 12, for example, a methanesulfinyl group, a benzenesulfinyl group, etc.); a ureido group (a ureido group having a carbon atom number of preferably from 1 to 20, more preferably from 1 to 16 and still more preferably from 1 to 12, for example, a ureido group, a methylureido group, a phenylureido group, etc.); a phosphoric acid amide group (a phosphoric acid amide group having a carbon atom number of preferably from 1 to 20, more preferably from 1 to 16 and still more preferably from 1 to 12, for example, a diethylphosphoric acid amide group, a phenylphosphoric acid amide group, etc.); a hydroxy group; a mercapto group; a halogen atom (for example, a fluorine atom and a chlorine atom, a bromine atom and an iodine atom); a cyano group; a sulfo group; a carboxyl group; a nitro group; a hydroxamic acid group; a sulfino group; a hydrazino group; an imino group; a heterocyclic group (a heterocyclic group having a carbon atom number of preferably from 1 to 30, and more preferably from 1 to 12, in which examples of the hetero atom include a nitrogen atom, an oxygen atom and a sulfur atom, for example, an imidazolyl group, a pyridyl group, a quinolyl group, a furyl group, a piperidyl group, a morpholino group, a benzoxazolyl group, a benzimidazolyl group, a benzthiazolyl group, etc.); and a silyl group (a silyl group having a carbon atom number of preferably from 3 to 40, more preferably from 3 to 30 and still more preferably from 3 to 24, for example, a trimethylsilyl group, a triphenylsilyl group, etc.). These substituents may further be substituted.

Two or more T₁s may be the same of different. If possible, the substituents may combine with each other to form a ring.

The compounds represented by formula (3) will be listed below, but the invention is not specifically limited thereto.

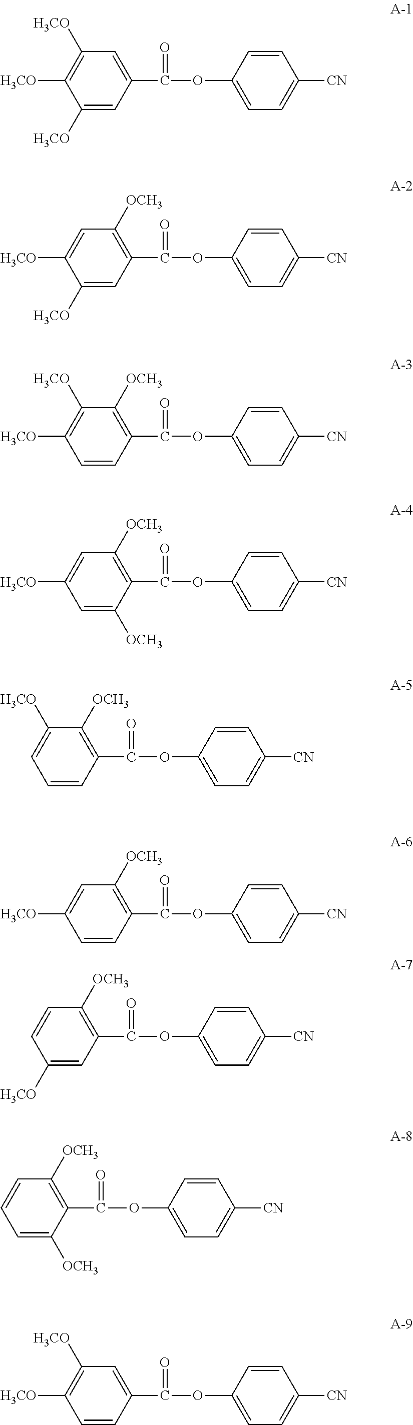

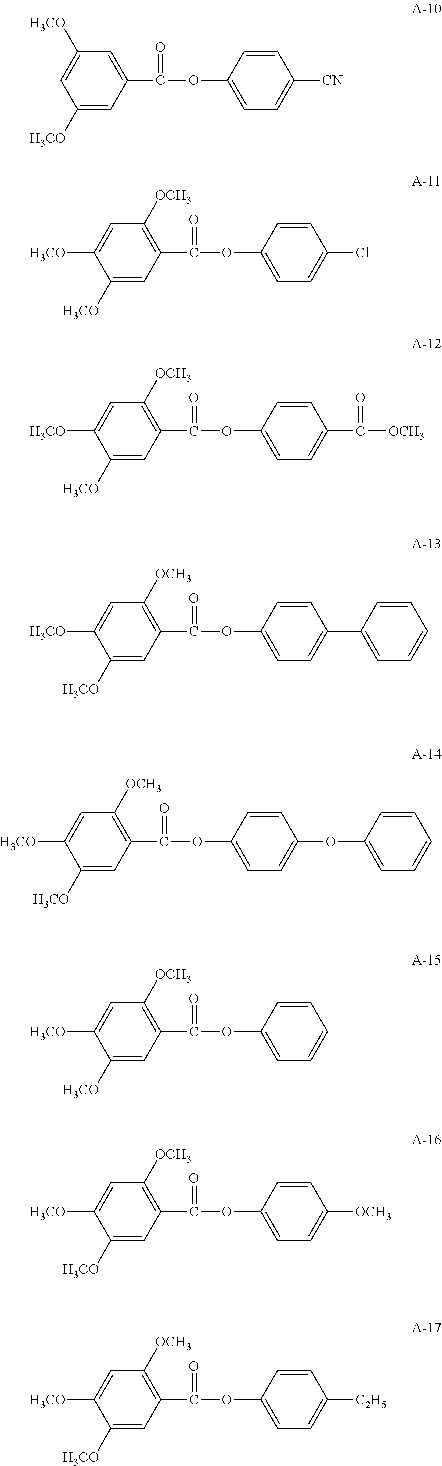

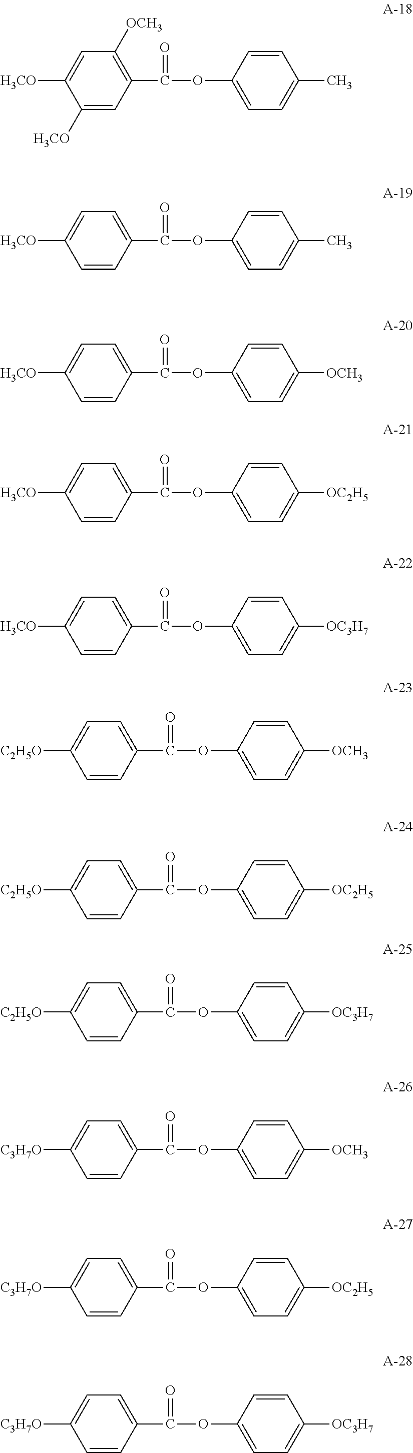

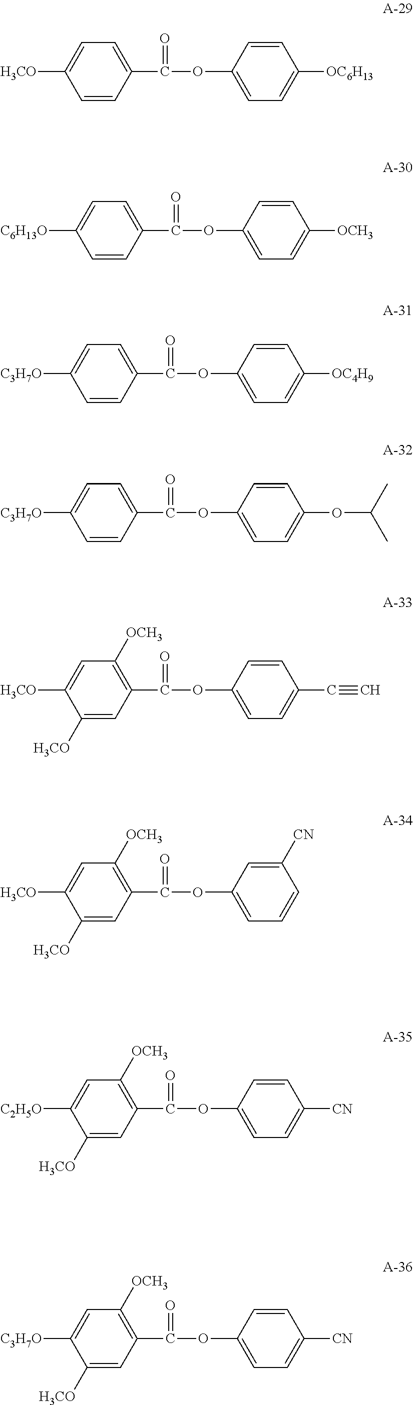

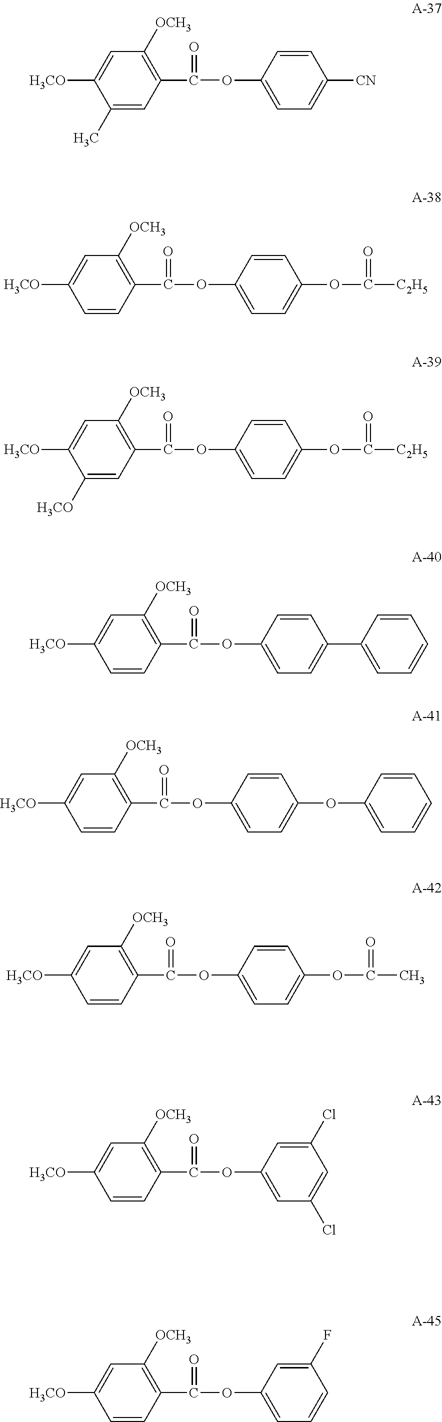

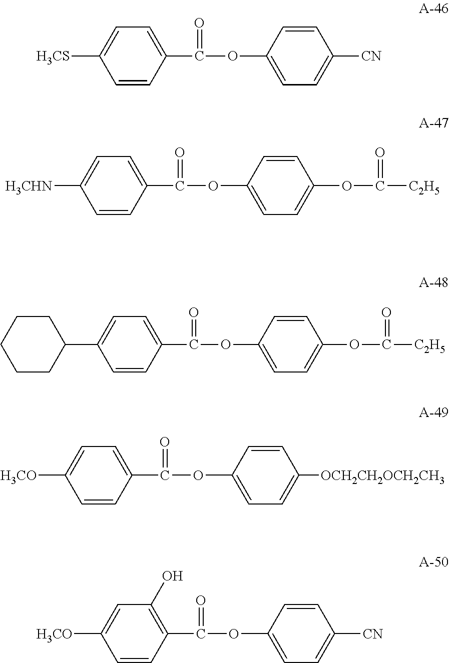

The compound represented by formula (3) can be synthesized by a conventional esterification reaction of a substituted benzoic acid and a phenol derivative. Any reaction may be applied as long as it is an ester bond formation reaction. There is a method in which an acid chloride derived from a substituted benzoic acid is condensed with phenol or a method in which a substituted benzoic acid is dehydration condensed with a phenol derivative in the presence of a condensing agent or a catalyst.

In the invention, a method is preferred from the viewpoint of a manufacturing process, in which an acid chloride derived from a substituted benzoic acid is condensed with phenol.

Next, a synthetic method of a low molecular weight compound represented by formula (3) will be described, but the invention is not specifically limited thereto.

### Synthetic Example 2

### Synthesis of Exemplified Compound A-12

A mixture of 45.0 g (212 millimol) of 2,4,5-trimethoxybenzoic acid, 180 ml of toluene and 1.8 ml of dimethylformamide was heated to 60° C., slowly added with 27.8 g (233 millimol) of thionyl chloride, and stirred at 60° C. for 2.5 hours. To the resulting mixture were slowly added a solution in which 35.4 g (233 millimol) of 4-hydroxybenzoic acid were dissolved in 27 ml of dimethylformamide and stirred at 80° C. for 3 hours. The resulting reaction solution was cooled to room temperature, and added with 270 ml of methanol to produce crystals. The crystals were filtered off to obtain 64.5 g of the objective compound as white crystals (yield 88%). Identification of the compound was carried out according to 1H-NMR (400 MHz) and mass spectroscopy.

1H-NMR (CDCl₃) δ 3.95 (m, 9H), 3.99 (s, 3H), 6.57 (s, 1H), 7.28 (d, 2H), 7.57 (s, 1H), 8.11 (d, 2H)

Mass spectra: m/z 347 (M+H)+

The resulting compound had a melting point of 121-123° C.

Next, a compound represented by formula (4) will be explained.

In formula (4), when AR₁ and AR₃ represent an aryl group or an aromatic heterocyclic ring group, AR₁ and AR₃ may be the same or different. The aryl group of AR₁ or of the arylcarbonyl group represented by AR₃ is preferably an aryl group having a carbon atom number of from 6 to 30. The aryl group may be a single ring or may be condensed with another ring to form a condensed ring. The aryl group may have a substituent if possible. As such a substituent, there is mentioned a substituent T₂ described later. The aryl group is more preferably an aryl group having a carbon atom number of from 6 to 20, and still more preferably an aryl group having a carbon atom number of from 6 to 12. As such an aryl group, there is mentioned a phenyl group, a p-methylphenyl group or naphthyl group.

In formula (4), AR₂ represents an arylene group or an aromatic heterocyclic ring group; and plural AR₂s in the repeating unit may be the same or different. The arylene group is preferably an arylene group having a carbon atom number of from 6 to 30, and may be a single ring or may be condensed with another ring to form a condensed ring. The arylene group may have a substituent if possible. As such a substituent, there is mentioned a substituent T₂ described later.

In formula (4), the arylene group represented by AR₂ is more preferably an arylene group having a carbon atom number of from 6 to 20, and still more preferably an arylene group having a carbon atom number of from 6 to 12. As such an arylene group, there is mentioned a phenylene group, a p-methylphenylene group or naphthylene group.

The aromatic heterocyclic ring group represented by AR₁, AR₂ or AR₃ is an aromatic heterocyclic ring group having at least one selected from an oxygen atom, a nitrogen atom and a sulfur atom, preferably a 5- or 6-member aromatic heterocyclic ring group having at least one selected from an oxygen atom, a nitrogen atom and a sulfur atom. The aromatic heterocyclic ring group may have a substituent if possible. As such a substituent, there is mentioned a substituent T₂ described later.

In formula (4), examples of the ring of the aromatic heterocyclic ring group represented by AR₁, AR₂ or AR₃ include rings of furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetraaza indene, pyrrolotriazole, and pyrazolotriazole. The aromatic heterocyclic ring is preferably a ring of benzimidazole, benzoxazole, benzothiazole or benzotriazole.

In formula (4), L₁ and L₂ independently represent a single bond or a divalent linkage group. L₁ and L₂ may be the same or different, and plural L₂s in the repeating unit may be the same or different.

The divalent linkage group is preferably a group represented by —NR₇ (in which R₇ represents a hydrogen atom, a substituted or unsubstituted alkyl group or a substituted or unsubstituted aryl group), —SO₂—, —CO—, a substituted or unsubstituted alkylene group, a substituted or unsubstituted alkenylene group, an alkynylene group, —O—, —S—, —SO— and a combination of two or more kinds thereof, more preferably —O—, —CO—, —SO₂NR₇—, —NR₇SO₂—, —CONR₇—, —NR₇CO—, —COO—, —OCO— or an alkylene group, and most preferably —CONR₇—, —NR₇CO—, —COO—, —OCO— or an alkylene group.

In formula (4), AR₂ combines with L₁ and L₂, and when AR₂ is phenylene, L₁-AR₂-L₂ and L₂-AR₂-L₂ in which L₁ and L₂ combine with the phenylene at the para position are most preferred.

In formula (4), n is an integer of 3 or more, preferably from 3 to 7, and still more preferably from 3 to 5.

Next, the substituent T₂ in formula (4) above will be explained.

Preferred examples of the substituent T₂ include a halogen atom (for example, a fluorine atom, a chlorine atom, a bromine atom or iodine atom); an alkyl group (preferably an alkyl group having a carbon atom number of from 1 to 30, for example, a methyl group, an ethyl group, an n-propyl group, an isopropyl group, a t-butyl group, an n-octyl group or a 2-ethylhexyl group); a cycloalkyl group (preferably a substituted or unsubstituted cycloalkyl group having a carbon atom number of from 3 to 30, for example, a cyclohexyl group, a cyclopentyl group or a 4-n-dodecylcyclohexyl group), a bicycloalkyl group (preferably a bicycloalkyl group having a carbon atom number of from 5 to 30, i.e., a monovalent group obtained by removing one hydrogen atom from a bicycloalkane having a carbon atom number of from 5 to 30, for example, bicyclo[1,2,2]heptane-2-yl or bicyclo[2,2,2]octane-3-yl); an alkenyl group (preferably a substituted or unsubstituted alkenyl group having a carbon atom number of from 2 to 30, for example, a vinyl group or an allyl group); a cycloalkenyl group (preferably a substituted or unsubstituted cycloalkenyl group having a carbon atom number of from 3 to 30, i.e., a monovalent group obtained by removing one hydrogen atom from a cycloalkene having a carbon atom number of from 3 to 30, for example, 2-cyclopentene-1-yl or 2-cyclohexene-1-yl); a bicycloalkenyl group (preferably a substituted or unsubstituted bicycloalkenyl group, a substituted or unsubstituted bicycloalkenyl group having a carbon atom number of from 5 to 30, i.e., a monovalent group obtained by removing one hydrogen atom from a bicycloalkene having one double bond, for example, bicyclo[2,2,1]hepto-2-en-1-yl or bicyclo[2,2,2]octo-2-en-4-yl); an alkynyl group (preferably a substituted or unsubstituted alkynyl group having a carbon atom number of from 2 to 30, for example, an ethynyl group or a propargyl group); an aryl group (preferably a substituted or unsubstituted aryl group having a carbon atom number of from 6 to 30, for example, a phenyl group, a p-tolyl group or a naphthyl group); a heterocyclic ring group (preferably a monovalent group which is obtained by removing one hydrogen atom from a 5- or 6-member substituted or unsubstituted aromatic or non-aromatic heterocyclic compound, and more preferably a 5- or 6-member aromatic heterocyclic ring group having a carbon atom number of from 3 to 30, for example, a 2-furyl group, a 2-thienyl group, a 2-pyridinyl group or a benzothiazolyl group); a cyano group; a hydroxyl group; a nitro group; a carboxyl group; an alkoxy group (preferably a substituted or unsubstituted alkoxy group having a carbon atom number of from 1 to 30, for example, a methoxy group, an ethoxy group, an isopropoxy group, a t-butoxy group, an n-octyloxy group or a 2-methoxyethoxy group); an aryloxy group (preferably a substituted or unsubstituted aryloxy group having a carbon atom number of from 6 to 30, for example, a phenoxy group, a 2-methylphenoxy group, a 4-tert-butylphenoxy group, a 3-nitrophenoxy group or a 2-tetradecanoylphenoxy group); a silyloxy group (preferably a silyloxy group having a carbon atom number of from 3 to 30, for example, a trimethylsilyloxy group or a tert-butyldimethylsilyloxy group); a heterocyclicoxy group (preferably a substituted or unsubstituted heterocyclicoxy group having a carbon atom number of from 2 to 30, for example, a 1-phenyltetrazole-5-oxy group or a 2-tetrahydropyranyloxy group); an acyloxy group (preferably a formyloxy group, a substituted or unsubstituted alkylcarbonyloxy group having a carbon atom number of from 2 to 30 or a substituted or unsubstituted arylcarbonyloxy group having a carbon atom number of from 6 to 30, for example, a formyloxy group, an acetyloxy group, a pivaloyloxy group, a stearoyloxy group, a benzoyloxy group or a p-methoxyphenylcarbonyloxy group); a carbamoyloxy group (preferably a substituted or unsubstituted carbamoyloxy group having a carbon atom number of from 1 to 30, for example, an N,N-dimethylcarbamoyloxy group, an N,N-diethylcarbamoyloxy group, a morpholinocarbonyloxy group, an N,N-di-n-octylaminocarbonyloxy group or a N-n-octylcarbamoyloxy group); an alkoxycarbonyloxy group (preferably a substituted or unsubstituted alkoxycarbonyloxy group having a carbon atom number of from 2 to 30, for example, a methoxycarbonyloxy group, an ethoxycarbonyloxy group, a tert-butoxycarbonyloxy group or an n-octylcarbonyloxy group); an aryloxycarbonyloxy group (preferably a substituted or unsubstituted aryloxycarbonyloxy group having a carbon atom number of from 7 to 30, for example, a phenoxycarbonyloxy group, a p-methoxyphenoxycarbonyloxy group or a p-n-hexadecyloxyphenoxycarbonyloxy group); an amino group (preferably an amino group, a substituted or unsubstituted alkylamino group having a carbon atom number of from 1 to 30 or a substituted or unsubstituted anilino group having a carbon atom number of from 6 to 30, for example, an amino group, a methylamino group, a dimethylamino group, an aniline group, an N-methylanilino group or a diphenylamino group); an acylamino group (preferably a formylamino group, a substituted or unsubstituted alkylcarbonylamino group having a carbon atom number of from 1 to 30 or a substituted or unsubstituted arylcarbonylamino group having a carbon atom number of from 6 to 30, for example, a formylamino group, an acetylamino group, a pivaloylamino group, a lauroylamino group or a benzoylamino group); an aminocarbonylamino group (preferably a substituted or unsubstituted aminocarbonylamino group having a carbon atom number of from 1 to 30, for example, a carbamoylamino group, an N,N-dimethylaminocarbonylamino group, an N,N-diethylaminocarbonylamino group or a morpholinocarbonylamino group); an alkoxycarbonylamino group (preferably a substituted or unsubstituted alkoxycarbonylamino group having a carbon atom number of from 2 to 30, for example, a methoxycarbonylamino group, an ethoxycarbonylamino group, a tert-butoxycarbonylamino group, an n-octadecyloxycarbonylamino group or an N-methyl-methoxycarbonylamino group); an aryloxycarbonylamino group (preferably a substituted or unsubstituted aryloxycarbonylamino group having a carbon atom number of from 7 to 30, for example, a phenoxycarbonylamino group, a p-chlorophenoxycarbonylamino group or an m-n-octyloxyphenoxycarbonylamino group); a sulfamoylamino group (preferably a substituted or unsubstituted sulfamoylamino group having a carbon atom number of from 0 to 30, for example, a sulfamoylamino group, an N,N-dimethylaminosulfonylamino group or an N-n-octylaminosulfonylamino group); an alkylsulfonylamino or arylsulfonylamino group (preferably a substituted or unsubstituted alkylsulfonylamino group having a carbon atom number of from 1 to 30 or a substituted or unsubstituted arylsulfonylamino group having a carbon atom number of from 6 to 30, for example, a methylsulfonylamino group, a butylsulfonylamino group, a phenylsulfonylamino group, a 2,3,5-trichlorophenylsulfonylamino group or a p-methylphenylsulfonylamino group); a mercapto group; an alkylthio group (preferably a substituted or unsubstituted alkylthio group having a carbon atom number of from 1 to 30, a methylthio group, an ethylthio group or an n-hexadecylthio group); an arylthio group (preferably a substituted or unsubstituted arylthio group having a carbon atom number of from 6 to 30, for example, a phenylthio group, a p-methylthio group or an m-methoxyphenylthio group); a heterocyclicthio group (preferably a substituted or unsubstituted heterocyclicthio group having a carbon atom number of from 2 to 30, for example, a 2-benzothiazolyl group or a 1-phenyltetrazol-5-ylthio group); a sulfamoyl group (preferably a substituted or unsubstituted sulfamoyl group having a carbon atom number of from 0 to 30, for example, an N-ethylsulfamoyl group, an N-(3-dodecyloxypropyl)sulfamoyl group, an N,N-dimethylsulfamoyl group, an N-acetylsulfamoyl group, an N-benzoylsulfamoyl group or an N—(N′-phenylcarbamoyl)sulfamoyl group); a sulfo group; a sulfo group; an alkylsulfinyl or arylsulfinyl group (preferably a substituted or unsubstituted alkylsulfonyl group having a carbon atom number of from 1 to 30 or a substituted or unsubstituted arylsulfinyl group having a carbon atom number of from 6 to 30, for example, a methylsulfinyl group, an ethylsulfinyl group, a phenylsulfinyl group or a p-methylphenylsulfinyl group); an alkylsulfonyl or arylsulfonyl group (preferably a substituted or unsubstituted alkylsulfonyl group having a carbon atom number of from 1 to 30 or a substituted or unsubstituted arylsulfonyl group having a carbon atom number of from 6 to 30, for example, a methylsulfonyl group, an ethylsulfonyl group, a phenylsulfonyl group or a p-methylphenylsulfonyl group); an acyl group (preferably a formyl group, a substituted or unsubstituted alkylcarbonyl group having a carbon atom number of from 2 to 30 or a substituted or unsubstituted arylcarbonyl group having a carbon atom number of from 7 to 30, for example, an acetyl group, a pivaloyl group or a benzoyl group); an aryloxycarbonyl group (preferably a substituted or unsubstituted aryloxycarbonyl group having a carbon atom number of from 7 to 30, for example, a phenoxycarbonyl group, an o-chlorophenoxycarbonyl group, an m-nitrophenoxycarbonyl group or a p-tert-butylphenoxycarbonyl group); an alkoxycarbonyl group (preferably a substituted or unsubstituted alkoxycarbonyl group having a carbon atom number of from 2 to 30, for example, a methoxycarbonyl group, an ethoxycarbonyl group, a tert-butoxycarbonyl group or an n-octadecyloxycarbonyl group); a carbamoyl group (preferably a substituted or unsubstituted carbamoyl group having a carbon atom number of from 1 to 30, for example, a carbamoyl group, an N-methylcarbamoyl group, an N,N-dimethylcarbamoyl group, an N,N-di-n-octylcarbamoyl group or an N-(methylsulfonyl)carbamoyl group); an arylazo or heterocyclicazo group (preferably a substituted or unsubstituted arylazo group having a carbon atom number of from 6 to 30 or a substituted or unsubstituted heterocyclicazo group having a carbon atom number of from 3 to 30, for example, a phenylazo group, a p-chlorophenylazo group, a naphthylazo group or a 5-ethylthio-1,3,4-thiadiazole-2-ylazo group); an imido group (preferably an N-succinimido group or an N-phthalimido group); a phosphino group (preferably a substituted or unsubstituted phosphino group having a carbon atom number of from 2 to 30, for example, a dimethylphosphino group, a diphenylphosphino group or a methylphenoxyphosphino group); a phosphinyl group (preferably a substituted or unsubstituted phosphinyl group having a carbon atom number of from 2 to 30, for example, a phosphinyl group, a dioctyloxyphosphinyl group or a diethoxyphosphinyl group), a phosphinyloxy group (preferably a substituted or unsubstituted phosphinyloxy group having a carbon atom number of from 2 to 30, for example, a diphenoxyphosphinyloxy group or a dioctyloxyphosphinyloxy group); a phosphinylamino group (preferably a substituted or unsubstituted phosphinylamino group having a carbon atom number of from 2 to 30, for example, a dimethoxyphosphinylamino group, or a dimethylaminophosphinylamino group); and a silyl group (preferably a substituted or unsubstituted silyl group having a carbon atom number of from 3 to 30, for example, a trimethylsilyl group, a tert-butyldimethylsilyl group, or a phenyldimethylsilyl group).

When the substituent T₂ in formula (4) above has a hydrogen atom, the hydrogen atom may be further replaced with the substituent T₂. As the substituent T₂. with which the hydrogen is replaced, there is mentioned an alkylcarbonylaminosulfonyl group, an arylcarbonylaminosulfonyl group, an alkylsulfonylaminocarbonyl group or an arylsulfonylaminocarbonyl group. Typical examples thereof include a methylsulfonylaminocarbonyl group, a p-methylphenylsulfonylaminocarbonyl group, an acetylaminosulfonyl group or a benzoylaminosulfonyl group.

Two or more substituents may be the same of different. If possible, the substituents may combine with each other to form a ring.

The compounds represented by formula (4) will be listed below, but the invention is not specifically limited thereto.

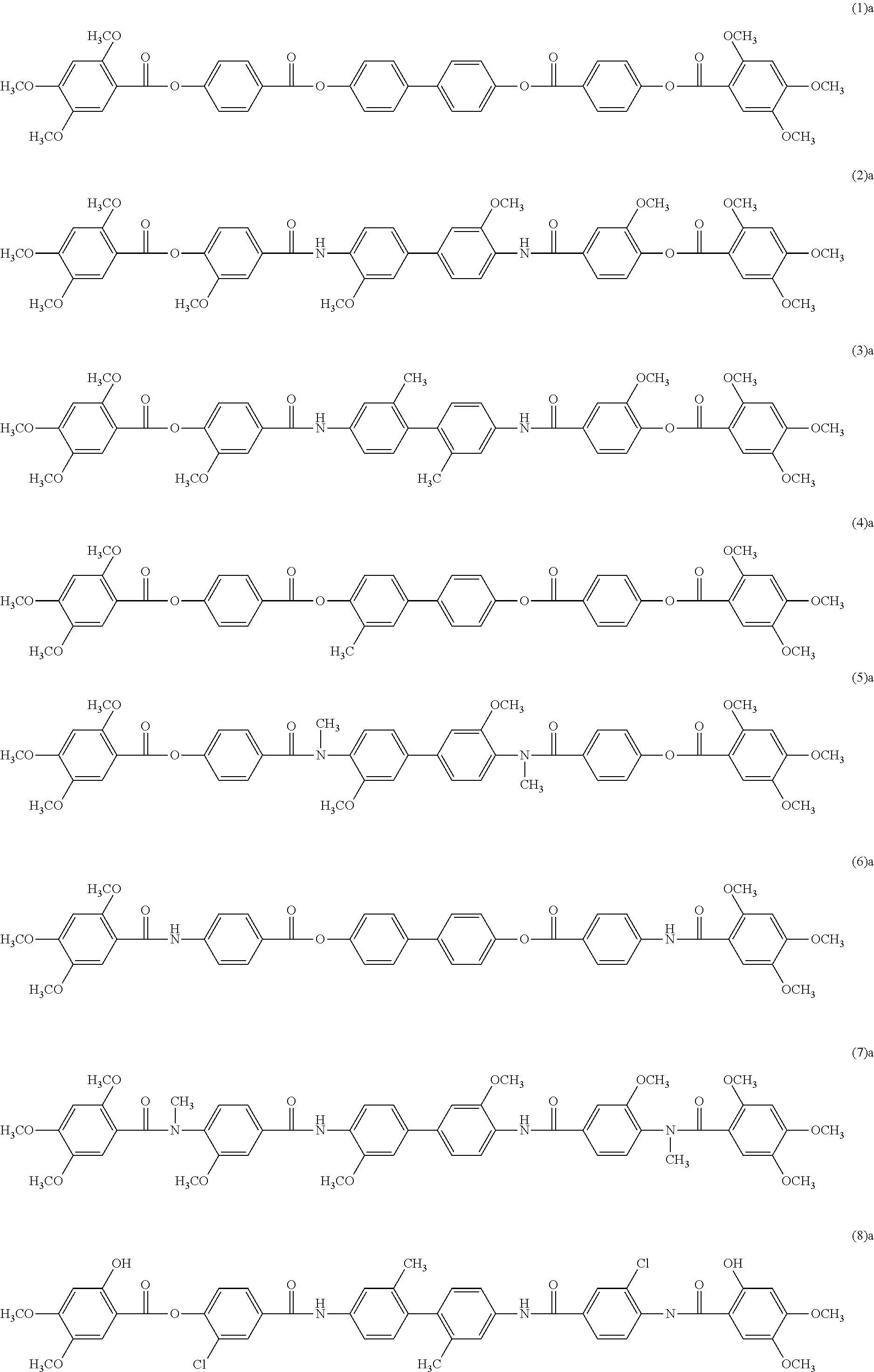

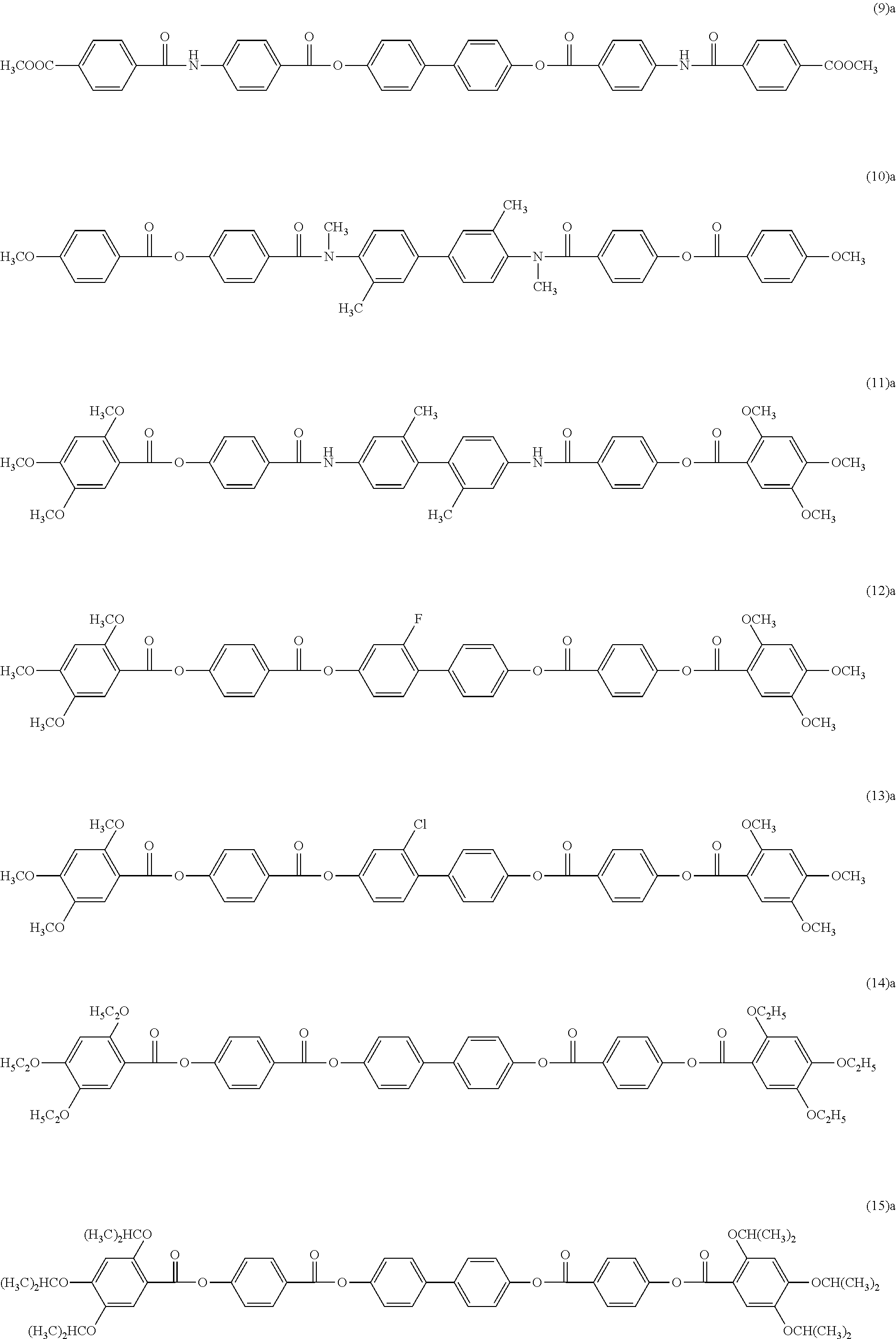

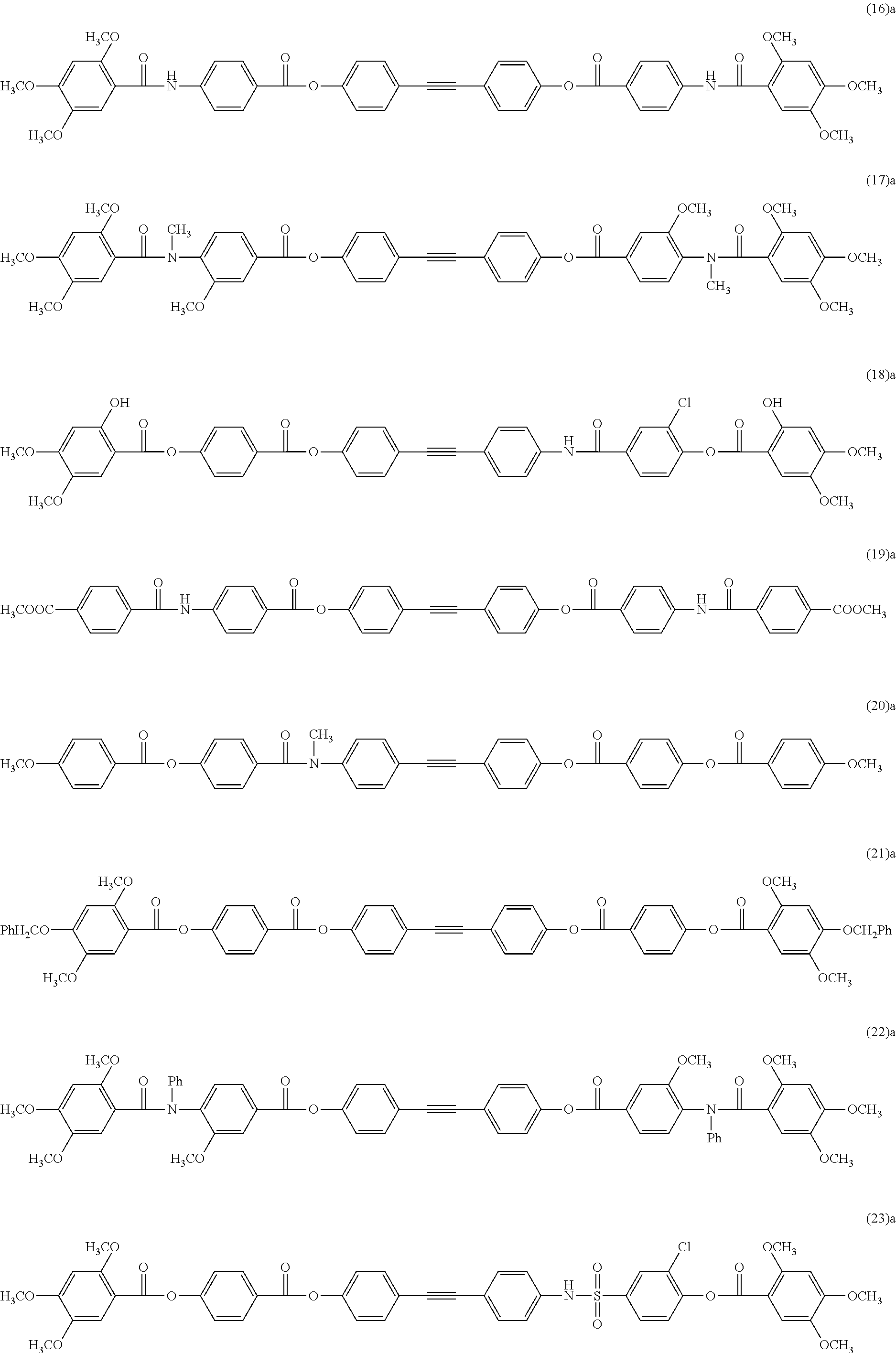

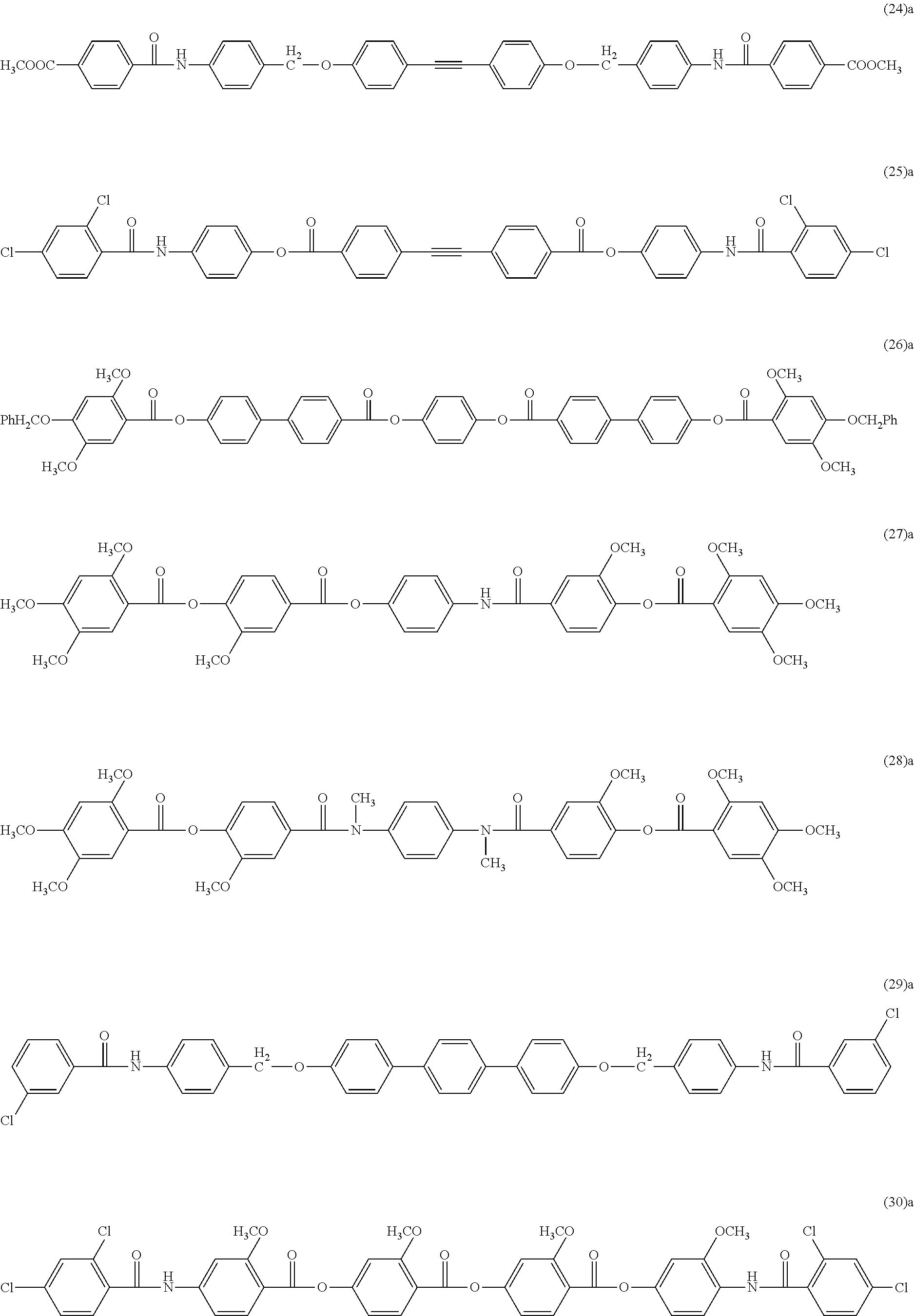

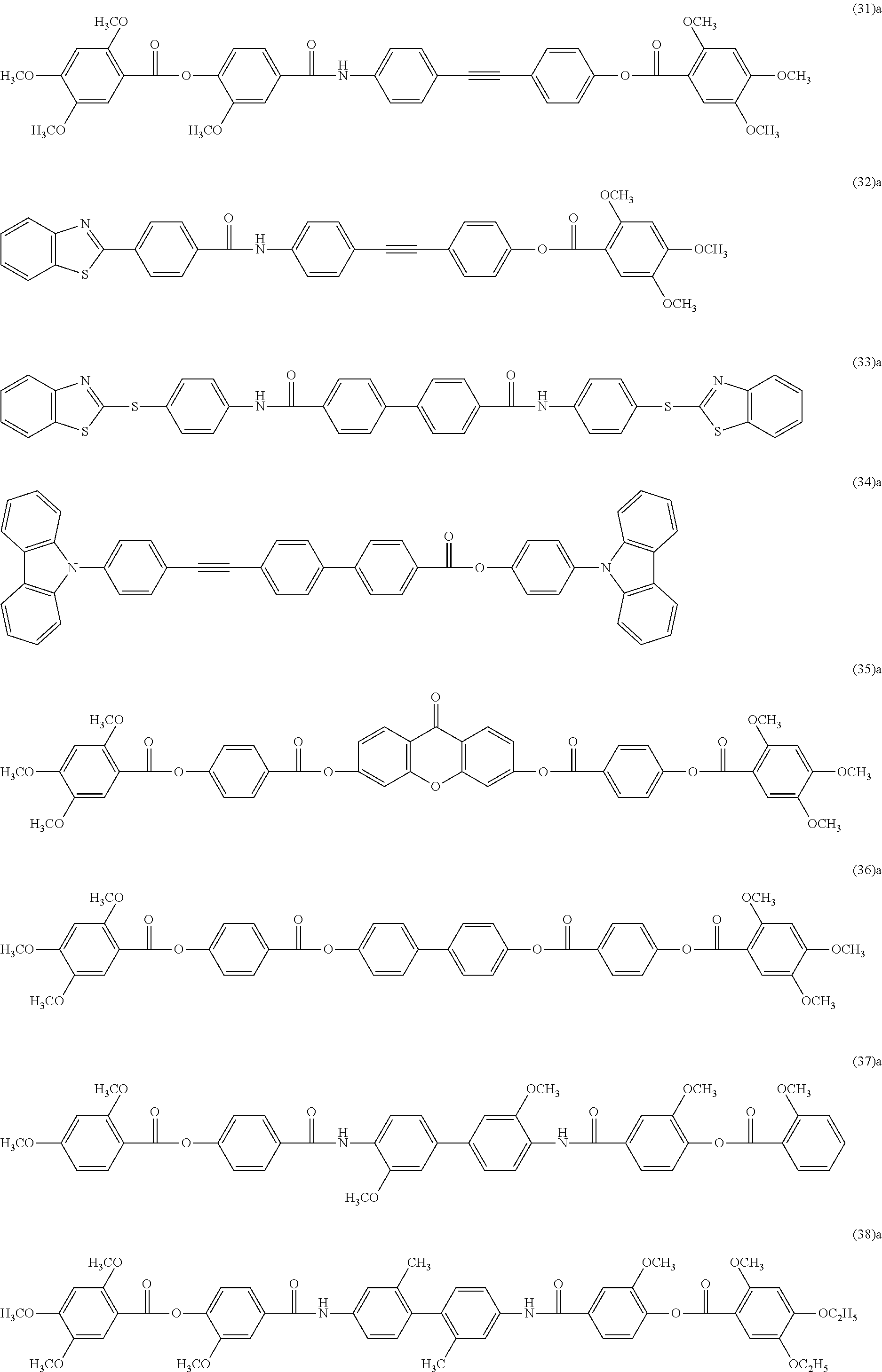

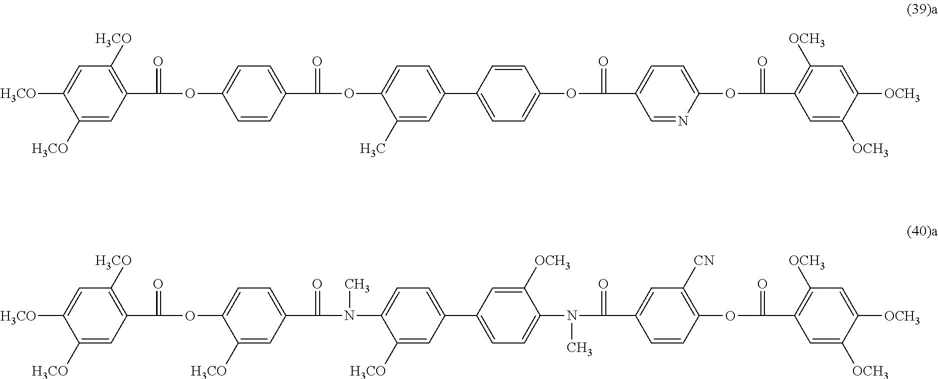

Next, a synthetic method of a compound represented by formula (4) will be described. In the following synthetic examples, materials, their amount to be used, their proportion, the processing method or processing order may be properly varied as long as they do not fall outside the scope of the invention. The invention is not specifically limited to the following synthetic examples.

### Synthetic Example 3

### Synthesis of Exemplified Compound (1)a

Exemplified Compound (1)a of formula (4) was synthesized according to the following reaction scheme.

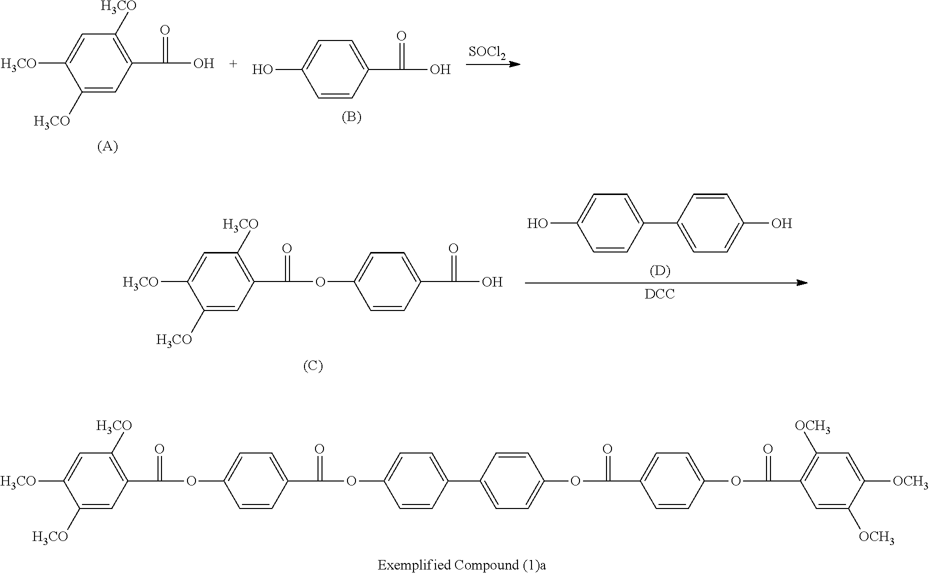

### —Synthesis of Intermediate (C)—

A mixture of 300 g of 2,4,5-trimethoxybenzoic acid, 1200 ml of toluene and 12 ml of dimethylformamide was heated to 80° C., slowly added with 112.1 ml of thionyl chloride in 45 minutes, and then stirred at 80° C. for 1 hour. To the resulting mixture were slowly added a solution in which 214.8 g of 4-hydroxybenzoic acid were dissolved in 800 ml of dimethylformamide and stirred at 80° C. for 2 hours. The resulting reaction solution, after the toluene was removed, was cooled to room temperature, and added with 2500 ml of methanol to produce crystals. The crystals were filtered off to obtain 263.8 g of an intermediate (C) as white crystals (yield 56.3%).

—Synthesis of Exemplified Compound (1)a—

A mixture solution of 108.4 g of Intermediate (C), 7.24 g of dimethylaminipyridine, 32.67 g of the compound (D) above, and 500 ml of methylene chloride was heated under reflux and slowly added, in 30 minutes, with 200 ml of a methylene chloride solution containing 67.31 g of cyclohexylcarbodiimide, and further heated under reflux for 2 hours. The resulting reaction solution was cooled to room temperature and the resulting crystals (dicyclohexylurea) were filtered out and the filtrate was concentrated under reduced pressure. The resulting residue was recrystallized from methanol and the re-crystallization was repeated three times to obtain 91.42 g of Exemplified Compound (1)a of formula (4) as white crystal (Yield: 75.8%). Identification of the compound was carried out according to 1H-NMR (400 MHz).

1H-NMR (CDCl₃) δ 3.93 (s, 6H), 3.95 (s, 6H), 4.00 (s, 6H), 6.61 (s, 2H), 7.32 (d, 4H), 7.38 (d, 4H), 7.61 (s, 2H), 7.68 (d, 4H), 8.29 (d, 4H)

The resulting compound had a melting point of 199-200° C.

Next, a compound of formula (5) above will be explained.

In formula (5) above, AR₁ and AR₂ represent an aryl group or an aromatic heterocyclic ring group, and the aryl group of AR₁ or AR₂ is preferably an aryl group having a carbon atom number of from 6 to 30. The aryl group may be a single ring or may be condensed with another ring to form a condensed ring. The aryl group may have a substituent if possible. As such a substituent, there is mentioned a substituent T₃ described later.

The aryl group of AR₁ or AR₂ in formula (5) is more preferably an aryl group having a carbon atom number of from 6 to 20, and still more preferably an aryl group having a carbon atom number of from 6 to 12. As such an aryl group, there is mentioned a phenyl group, a p-methylphenyl group or naphthyl group.

The aromatic heterocyclic ring group represented by AR₁ or AR₂ in formula (5) is not specifically limited as long as it is an aromatic heterocyclic ring group having at least one selected from an oxygen atom, a nitrogen atom and a sulfur atom, but is preferably a 5- or 6-member aromatic heterocyclic ring group having at least one selected from an oxygen atom, a nitrogen atom and a sulfur atom. The aromatic heterocyclic ring group may have a substituent if possible. As such a substituent, there is mentioned a substituent T₃ described later.

In formula (5), examples of the ring of the aromatic heterocyclic ring group represented by AR₁ or AR₂ include rings of furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetraazaindene, pyrrolotriazole, and pyrazolotriazole. The aromatic heterocyclic ring is preferably a ring of benzimidazole, benzoxazole, benzothiazole or benzotriazole.

In formula (5), L₁ and L₂ independently represent —C(═O)O— or —C(═O)NR—, either of which is preferred.

The R above represents a hydrogen atom or an alkyl group. R is preferably a hydrogen atom or an alkyl group having a carbon atom number of from 1 to 6, more preferably a hydrogen atom or an alkyl group having a carbon atom number of from 1 to 4, still more preferably a hydrogen atom or a methyl group, and most preferably a hydrogen atom.

R₁, R₂, R₃, R₄, R₅, R₆, R₇, and R₈ in formula (5-A) independently represent a hydrogen atom or a substituent. As such a substituent, there is mentioned a substituent T₃ described later.

R₁, R₂, R₃, R₄, R₅, R₆, R₇, and R₈ in formula (5-A) are preferably a hydrogen atom, an alkyl group, an amino group, an alkoxy group, a hydroxyl group or a halogen atom, more preferably a hydrogen atom, an alkyl group having a carbon atom number of from 1 to 4, an alkoxy group having a carbon atom number of from 1 to 4, a hydroxyl group or a halogen atom, still more preferably a hydrogen atom, a methyl group, a methoxy group, a hydroxyl group, a chlorine atom or a fluorine atom, further still more preferably a hydrogen atom or a fluorine atom, and most preferably a hydrogen atom.

R₁₁, R₁₂, R₁₃, R₁₄, R₁₅, R₁₆, R₁₇ and R₁₈ in formula (5-B) independently represent a hydrogen atom or a substituent. As such a substituent, there is mentioned a substituent T₃ described later.

R₁₁, R₁₂, R₁₃, R₁₄, R₁₅, R₁₆, R₁₇ and R₁₈ in formula (5-B) are preferably a hydrogen atom, an alkyl group, an amino group, an alkoxy group, a hydroxyl group or a halogen atom, more preferably a hydrogen atom, an alkyl group having a carbon atom number of from 1 to 4, an alkoxy group having a carbon atom number of from 1 to 4, a hydroxyl group or a halogen atom, still more preferably a hydrogen atom, a methyl group, a methoxy group, a hydroxyl group, a chlorine atom or a fluorine atom, further still more preferably a hydrogen atom or a fluorine atom, and most preferably a hydrogen atom.

Next, the substituent T₃ above will be explained.

Examples of the substituent T₃ include an alkyl group (an alkyl group having a carbon atom number of preferably from 1 to 20, more preferably from 1 to 12 and still more preferably from 1 to 8, for example, a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.); an alkenyl group (an alkenyl group having a carbon atom number of preferably from 2 to 20, more preferably from 2 to 12 and still more preferably from 2 to 8, for example, a vinyl group, an allyl group, a 2-butenyl group, 3-pentenyl group, etc.); an alkynyl group (an alkynyl group a carbon atom number of from 2 to 20, more preferably from 2 to 12 and still more preferably from 2 to 8, for example, a propargyl group, a 3-pentynyl group, etc.); an aryl group (an aryl group having a carbon atom number of preferably from 6 to 30, more preferably from 6 to 20 and still more preferably from 6 to 12, for example, a phenyl group, a p-methylphenyl group, a naphthyl group, etc.); a substituted or unsubstituted amino group (a substituted or unsubstituted amino group having a carbon atom number of preferably from 0 to 20, more preferably from 0 to 10 and still more preferably from 0 to 6, for example, an amino group, a methylamino group, a dimethylamino group, a diethylamino group, a dibenzylamino group, etc.); an alkoxy group (an alkoxy group having a carbon atom number of preferably from 1 to 20, more preferably from 1 to 12, and still more preferably from 1 to 8, for example, a methoxy group, an ethoxy group, a butoxy group, etc.); an aryloxy group (an aryloxy group having a carbon atom number of preferably from 1 to 20, more preferably from 1 to 12, and still more preferably from 1 to 8, for example, a phenyloxy group, a 2-naphthyloxy group, etc.); an acyl group (an acyl group having a carbon atom number of preferably from 1 to 20, more preferably from 1 to 16 and still more preferably from 1 to 12, for example, an acetyl group, a benzoyl group, a formyl group, a pivaloyl group, etc.); an alkoxycarbonyl group (an alkoxycarbonyl group having a carbon atom number of preferably from 2 to 20, more preferably from 2 to 16 and still more preferably from 2 to 12, for example, a methoxycarbonyl group, an ethoxycarbonyl group, etc.); an aryloxycarbonyl group (an aryloxycarbonyl group having a carbon atom number of preferably from 7 to 20, more preferably from 7 to 16 and still more preferably from 7 to 10, for example, a phenyloxycarbonyl group, etc.); an acyloxy group (an acyloxy group having a carbon atom number of preferably from 2 to 20, more preferably from 2 to 16 and still more preferably from 2 to 10, for example, an acetoxy group, a benzoyloxy group, etc.); an acylamino group (an acylamino group having a carbon atom number of preferably from 2 to 20, more preferably from 2 to 16 and still more preferably from 2 to 10, for example, an acetylamino group and a benzoylamino group); an alkoxycarbonylamino group (an alkoxycarbonylamino group having a carbon atom number of preferably from 2 to 20, more preferably from 2 to 16 and still more preferably from 2 to 12, for example, a methoxycarbonylamino group, etc.); an aryloxycarbonylamino group (an aryloxycarbonylamino group having a carbon atom number of preferably from 7 to 20, more preferably from 7 to 16 and still more preferably from 1 to 12, for example, a phenyloxycarbonylamino group, etc.); a sulfonylamino group (a sulfonylamino group having a carbon atom number of preferably from 1 to 20, more preferably from 1 to 16 and still more preferably from 1 to 12, for example, a methanesulfonylamino group, a benzensulfonylamino group, etc.); a sulfamoyl group (a sulfamoyl group having a carbon atom number of preferably from 0 to 20, more preferably from 0 to 16 and still more preferably from 0 to 12, for example, a sulfamoyl group, a methylsulfamoyl group, a dimethylsulfamoyl group, a phenylsulfamoyl group, etc.); a carbamoyl group (a carbamoyl group having a carbon atom number of preferably from 1 to 20, more preferably from 1 to 16 and still more preferably from 1 to 12, for example, a carbamoyl group, a methylcarbamoyl group, a diethylcarbamoyl group, a phenylcarbamoyl group, etc.); an alkylthio group (an alkylthio group having a carbon atom number of preferably from 1 to 20, more preferably from 1 to 16 and still more preferably from 1 to 12, for example, a methylthio group, an ethylthio group, etc.); an arylthio group (an arylthio group having a carbon atom number of preferably from 6 to 20, more preferably from 6 to 16 and still more preferably from 6 to 12, for example, a phenylthio group, etc.); a sulfonyl group (a sulfonyl group having a carbon atom number of preferably from 1 to 20, more preferably from 1 to 16, and still more preferably from 1 to 12, for example, a mesyl group, a tosyl group, etc.); a sulfinyl group (a sulfinyl group having a carbon atom number of preferably from 1 to 20, more preferably from 1 to 16 and still more preferably from 1 to 12, for example, a methanesulfinyl group, a benzenesulfinyl group, etc.); a ureido group (a ureido group having a carbon atom number of preferably from 1 to 20, more preferably from 1 to 16 and still more preferably from 1 to 12, for example, a ureido group, a methylureido group, a phenylureido group, etc.); a phosphoric acid amide group (a phosphoric acid amide group having a carbon atom number of preferably from 1 to 20, more preferably from 1 to 16 and still more preferably from 1 to 12, for example, a diethylphosphoric acid amide group, a phenylphosphoric acid amide group, etc.); a hydroxy group; a mercapto group; a halogen atom (for example, a fluorine atom and a chlorine atom, a bromine atom and an iodine atom); a cyano group; a sulfo group; a carboxyl group; a nitro group; a hydroxamic acid group; a sulfino group; a hydrazino group; an imino group; a heterocyclic group (a heterocyclic group having a carbon atom number of preferably from 1 to 30, and more preferably from 1 to 12, in which examples of the hetero atom include a nitrogen atom, an oxygen atom and a sulfur atom, for example, an imidazolyl group, a pyridyl group, a quinolyl group, a furyl group, a piperidyl group, a morpholino group, a benzoxazolyl group, a benzimidazolyl group, a benzthiazolyl group, etc.); and a silyl group (a silyl group having a carbon atom number of preferably from 3 to 40, more preferably from 3 to 30 and still more preferably from 3 to 24, for example, a trimethylsilyl group, a triphenylsilyl group, etc.). These substituents T₃ may further be substituted.

Two or more substituents T₃s may be the same of different. If possible, the substituents may combine with each other to form a ring.

The compounds represented by formula (5) will be listed below, but the invention is not specifically limited thereto.

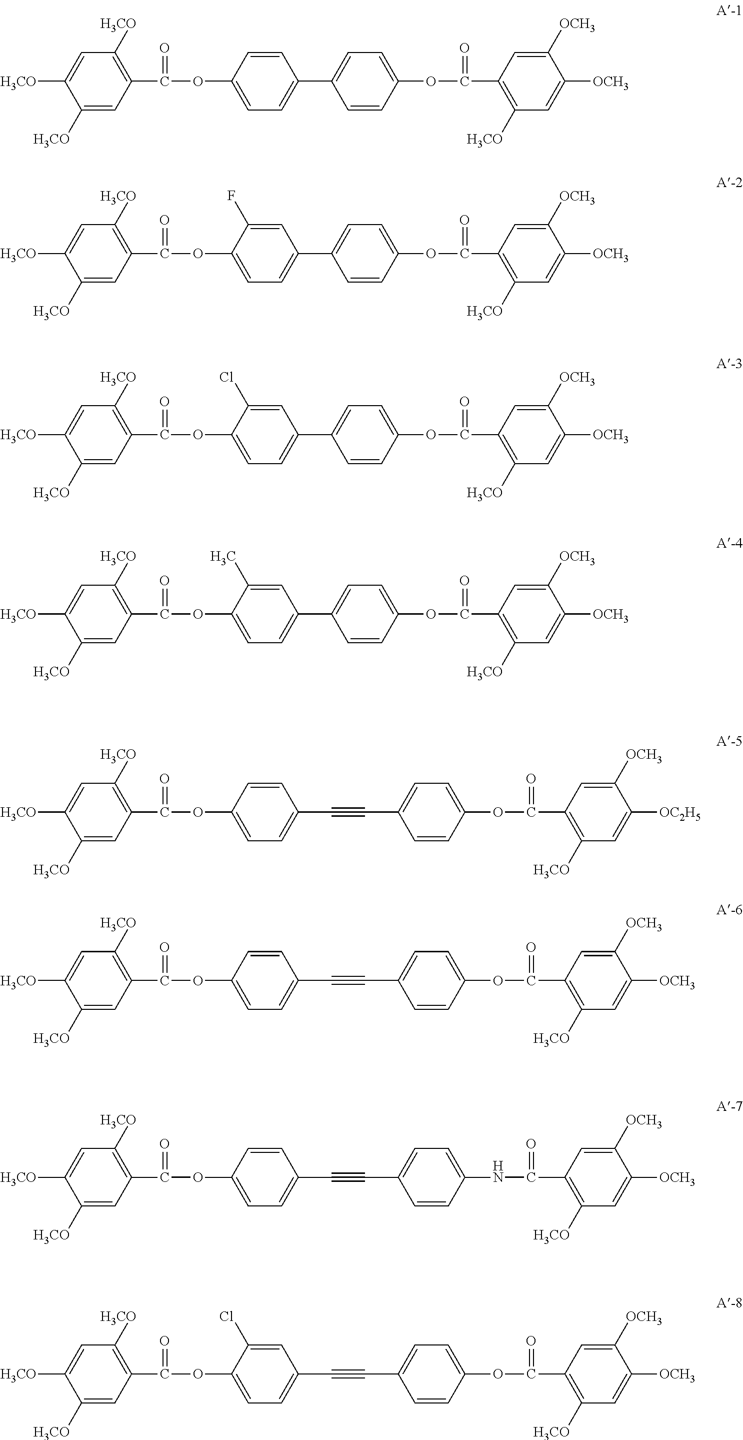

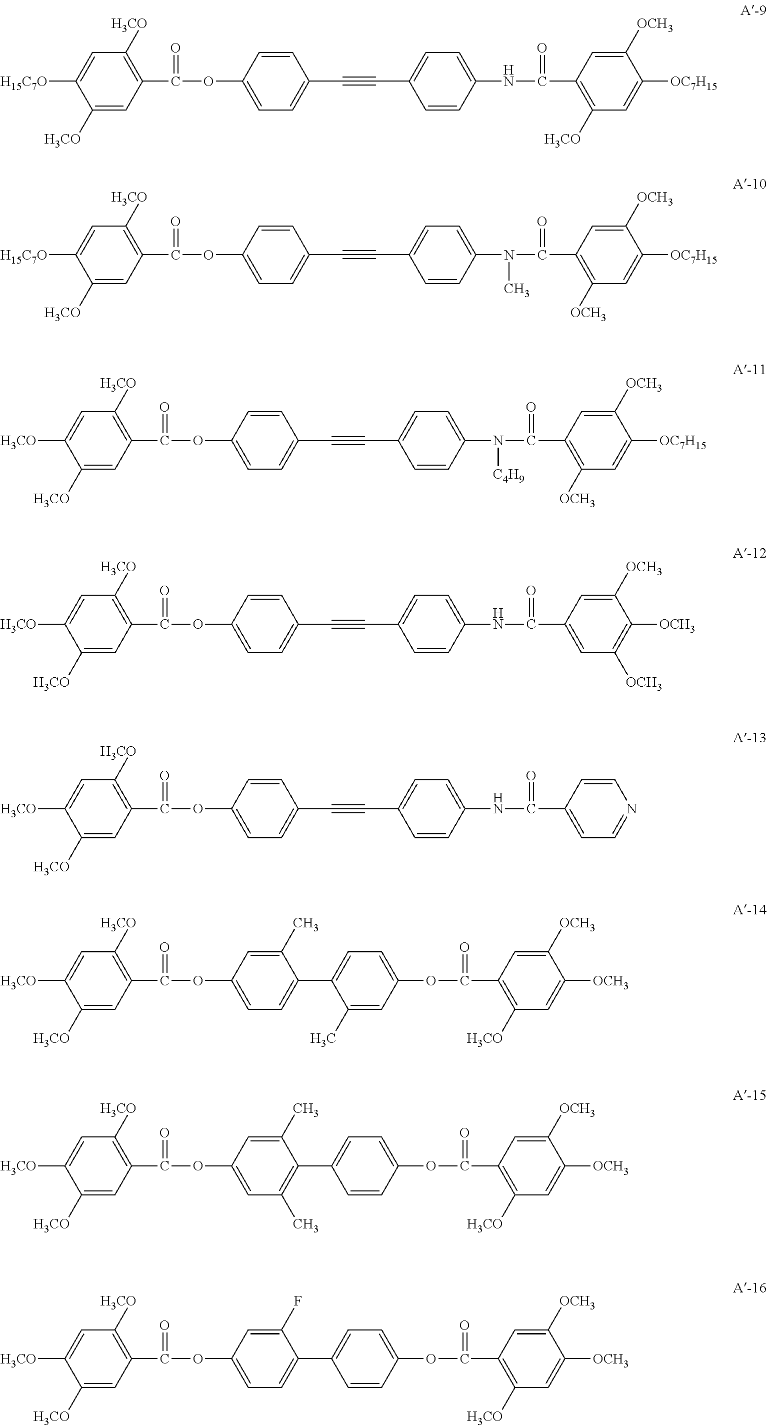

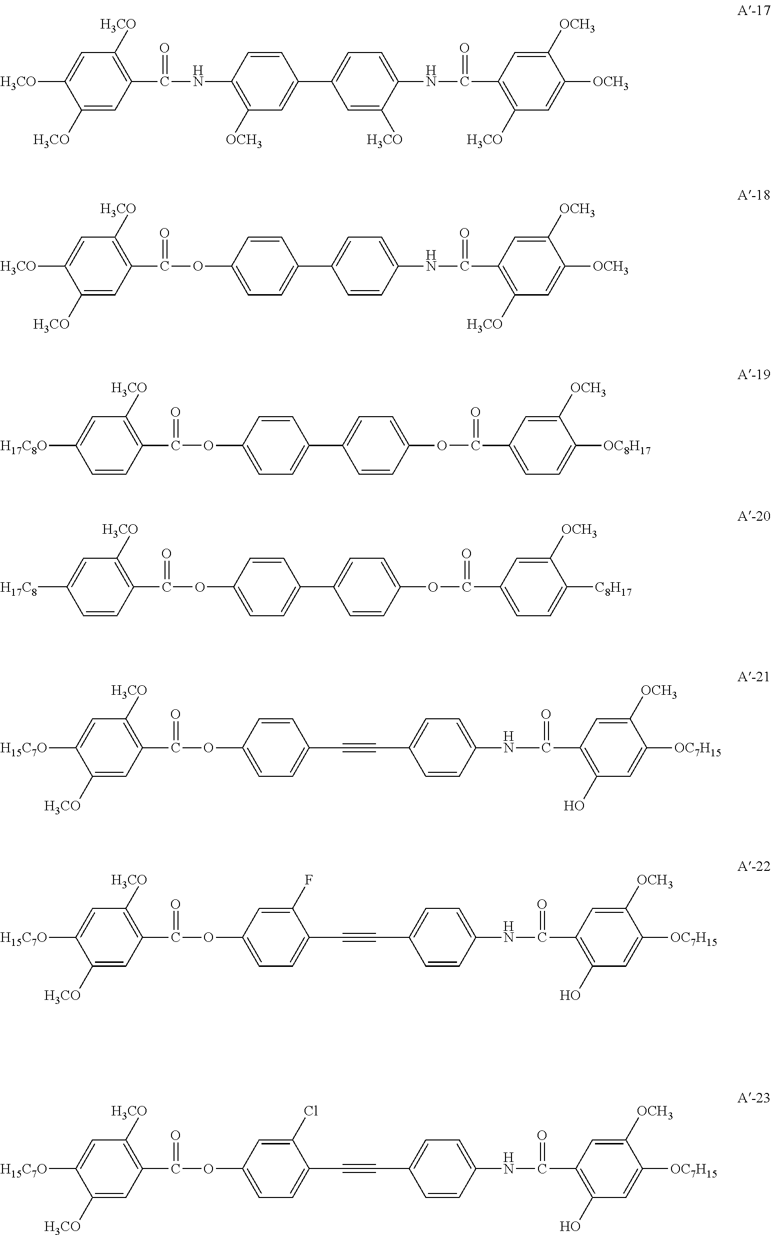

The compound represented by formula (5) can be synthesized by a conventional esterification reaction of a substituted benzoic acid and a phenol derivative or a conventional amidation reaction of a substituted benzoic acid and an aniline derivative. Any reaction may be applied as long as it is an ester bond formation reaction. There is a method in which an acid chloride derived from a substituted benzoic acid is condensed with phenol or an aniline derivative or a method in which a substituted benzoic acid is dehydration condensed with phenol or an aniline derivative in the presence of a condensing agent or a catalyst.

In the invention, a method is preferred from the viewpoint of a manufacturing process and the like, in which an acid chloride derived from a substituted benzoic acid is condensed with phenol or an aniline derivative.

Next, a synthetic method of a compound represented by formula (5) will be described. In the following synthetic examples, materials, their amount to be used, their proportion, the processing method or processing order may be properly varied as long as they do not fall outside the scope of the invention.

### Synthetic Example 4

### Synthesis of Exemplified Compound A′-1

A mixture of 40.1 g (189 minimal) of 2,4,5-trimethoxybenzoic acid, 16.75 g (90 millimol) of 4,4′-dihydroxybiphenyl, 200 ml of toluene and 2 ml of dimethylformamide was heated to 70° C., slowly added with 23.6 g (198 millimol) of thionyl chloride, and stirred at 70° C. for 2.5 hours. The resulting reaction solution was cooled to room temperature, and added with 300 ml of methanol to produce crystals. The crystals were filtered off to obtain 48.4 g of the objective compound as white crystals (yield 94%). Identification of this compound was carried out according to 1H-NMR (400 MHz).

1H-NMR (CDCl₃) δ 3.93 (s, 6H), 3.95 (s, 6H), 3.99 (s, 6H), 6.58 (s, 2H), 7.28 (d, 4H), 7.62 (m, 6H)

The resulting compound had a melting point of 227-229° C.

In the invention, the addition amount of the compounds represented by formulae (1) through (5) is properly selected as long as the effects of the invention are not jeopardized, but is ordinarily from 1.0 to 30 parts by mass, and preferably from 2.0 to 20 parts by mass based on the 100 parts by mass of cellulose ester. These compounds may be used as an admixture of two or more kinds thereof.

In the second protective film in the invention, compounds represented by formulae (1) through (5) are employed and the stretching processing above is properly carried out in order to obtain optical compensation function, whereby the retardation in-plane (Ro) and the retardation in the thickness direction (Rth) of the second protective film are ordinarily adjusted to from 0 to 100 nm and from −150 to 400 nm, respectively, and preferably to from 50 to 100 nm and from 70 to 400 nm, respectively.

### <<Polarizing Plate>>

The polarizing plate used in the invention can be manufactured according to a conventional method. It is preferred that a polarizer, which is prepared by immersing and stretching in an iodine solution, is sandwiched between the first protective film and the second protective film subjected to saponification treatment, so that the cellulose ester resin layer (A) of the first protective film faces the polarizer.

A polarizer, which is a major constitutional component of the polarizing plate, is an element which transmits only light with a polarized wave plane in a specific direction. The representative polarizing film, which is presently known, is a polyvinyl alcohol polarizing film including one dyed with iodine or with dichroic dyes.

Generally, the polarizer is prepared as follows. A polyvinyl alcohol film is prepared employing an aqueous polyvinyl alcohol solution. The resulting film is uniaxially stretched, followed by dyeing, or is dyed, then uniaxially stretched and subjected to durability increasing treatment, employing preferably boron compounds.

### <<Liquid Crystal Display Device>>

Incorporation of a polarizing plate employing the first and second protective films in the invention in a liquid crystal display can produce a liquid crystal display which excels in various kinds of visibility. The polarizing plate in the invention is adhered to a liquid crystal cell through an adhesion layer and the like. It is preferred that the polarizing plate is adhered to a liquid crystal cell so that the second protective film of the polarizing plate faces the liquid crystal cell.

The polarizing plate in present invention is preferably employed in a reflection type, transmission type or semi-transmission type LCD, or in LCDs of various driving systems such as a TN type, an STN type, an OCB type, an HAN type, a VA type (a PVA type and an MVA type) and an IPS type.

Particularly, no white spots occur at the periphery of the screen in a large screen display particularly a screen of at least 30 type, especially of 30 to 54 type, and its effect is maintained over a long term. Further, the polarizing plate exhibits the advantageous effects in that color unevenness, glittering of wavy unevenness is minimized and eyes do not feel tired after watching the screen for a long hour.

### EXAMPLES

Next, the present invention will be explained employing examples, but the invention is not specifically limited thereto.

### Example 1

Acryl resin A-AC1 and Acryl resin A-AC2 as shown in Table 1 and Acryl resins B-AC1 through B-AC3 as shown in Table 2 were prepared according to a conventional method.

TABLE 1

| Acryl Resin | MMA | MA | Molecular Weight |
|---|---|---|---|
| A-AC1 | 90 | 10 | 70000 |
| A-AC2 | 90 | 10 | 280000 |

TABLE 2

| Acryl Polymer | MMA | ACMO | HEMA | MA | Molecular Weight |
|---|---|---|---|---|---|
| B-AC1 | 70 | — | 10 | 20 | 5000 |
| B-AC2 | 70 | 30 | — | — | 6000 |
| B-AC3 | 90 | — | — | 10 | 8000 |

### (Abbreviated Monomer Names in Tables 1 and 2)

MMA: Methyl methacrylate
MA: Methyl methacrylate

### ACMO: N-Acryloylmorpholine

### HEMA: 2-Hydroxyethyl Methacrylate

### <Preparation of Polarizing Plate 101>

### (Preparation of First Protective Film)

Acryl resin A-AC1 of 55 parts by mass, 45 parts by mass of cellulose ester resin, cellulose acetate propionate (with a degree of acetyl substitution of 0.1, a degree of propionyl substitution (Pr substitution) of 2.60, and a degree of total acyl substitution of 2.70, trade name, CAP-482-20, manufactured by Eastman Chemical Co., Ltd.), and 0.2 parts by mass of phosphorous-containing antioxidant (Irgafos 168: manufactured by Ciba Japan Co., Ltd.) were mixed to prepare an acryl resin layer (B) melt composition.

Further, 80 parts by mass of cellulose acetate propionate (with a degree of acetyl substitution of 1.60, a degree of propionyl substitution of 1.20, and a degree of total acyl substitution of 2.80, and with a number average molecular weight of 60000), 20 parts by mass of Acryl resin B-AC1, 1.5 parts by mass of Tinivin 928 (manufactured by Ciba Japan Co., Ltd.), 0.01 parts by mass of ADK STAB PEP-36 (ADEKA Co., Ltd.), 0.5 parts by mass of (Irganox 1010 (manufactured by Ciba Japan Co., Ltd.), 0.2 parts by mass of Sumilizer GS (manufactured by Sumitomo Chemical Co., Ltd.), and 0.1 parts by mass of Seahostar KEP-30 (manufactured by Nippon Syokubai Co., Ltd.) were mixed to prepare an acryl resin layer (A) melt composition.

Each of the above two melt compositions was dried in a vacuum nowter mixer at 70° C. and at 1 Torr for hours while mixing, and melted and mixed at 250° C. using a twin screw extruder, whereby pellets were obtained. In this case, to reduce heat generation due to shearing at the time of kneading, an all-screw type screw was utilized and a kneading disk was not. Further, vacuum suction was carried out through a vent hole, and volatile components generated during kneading were removed by the vacuum suction. To avoid absorption of moisture into the resin, a dry nitrogen atmosphere was used in the space between a feeder or a hopper for supplying to the extruder and the cooling section downstream the extrusion die.

As shown in FIG. 3, the pellets of the acryl resin layer (B) melt composition are extruded from a single screw extruder and pellets of the cellulose ester resin layer (A) melt composition are extruded from a twin screw extruder to form a laminate on a T die so that the cellulose ester layer (A) contacted the first cooling roller, the resulting laminate was melt-extruded at 240° C. in the form of film on a first cooling roller whose surface temperature was 100° C., and conveyed on a second cooling roller so that the surface temperature Tb was 95° C. Thus, a cast film with a total thickness of 220 μm composed of two layers was obtained according to a co-extrusion method. In this case, the T-die used had a lip clearance of 1.5 mm and an average surface roughness of Ra 0.01 μm at a lip section. Further, the film was pressed on the first cooling roll at a linear pressure of 10 kg/cm through an elastic touch roll having a 2 mm thick metal surface.

The first cooling roll and second cooling roll were made of stainless steel having a diameter of 40 cm, and the surface was subjected to hard chromium plating. A temperature adjusting oil was circulated inside the roll to control the roll surface temperature. The elastic touch roll had a diameter of 20 cm and the inner sleeve and outer sleeve were made of stainless steel. The surface of the outer sleeve was subjected to hard chromium plating. The outer sleeve had a wall thickness of 2 mm, and a temperature adjusting oil was circulated in the space between the inner sleeve and outer sleeve, whereby the surface temperature of the elastic touch roll was controlled.

The resulting film was heated at 160° C., stretched in the conveyance direction by a magnification of 1.3 employing rollers having a different rotational speed, and introduced into a tenter having a preheating zone, a stretching zone, a retaining zone, and a cooling zone (as well as a neutral zone to ensure heat insulation between the zones), which is a device for stretching in the transverse direction, and stretched in the transverse direction by a magnification of 1.3 at 160° C. After that, the film was cooled to 70° C., and released from the clip. Then, the clip holding section was trimmed off. Thus, a first protective film with a width of 2500 mm and a thickness of 80 μm was obtained.

### (Preparation of Second Protective Film)

One hundred parts by mass of cellulose acetate propionate (with a degree of acetyl substitution of 1.90, a degree of propionyl substitution of 0.80, and a degree of total acyl substitution of 2.70, and with a number average molecular weight of 70000), 6 parts by mass of a retardation adjusting agent Exemplified Compound I-(20), 10 parts by mass of a plasticizer trimethylolpropane tribenzoate, 1.5 parts by mass of Tinivin 928 (manufactured by Ciba Japan Co., Ltd.), 0.01 parts by mass of ADK STAB PEP-36 (ADEKA Co., Ltd.), 0.5 parts by mass of Irganox 1010 (manufactured by Ciba Japan Co., Ltd.), 0.2 parts by mass of Sumilizer GS (manufactured by Sumitomo Chemical Co., Ltd.), and 0.1 parts by mass of Seahostar KEP-30 (manufactured by Nippon Syokubai Co., Ltd.) were mixed to prepare a second protective film melt composition.

The resulting melt composition was melted and mixed at 230° C. using a twin screw extruder to obtain pellets. The pellets had a glass transition temperature Tg of 137° C.

The pellets were melted at 250° C. under a nitrogen atmosphere, extruded in the form of a film onto a first cooling roller from the casting die, and pressed onto the first cooling roller through a touch roller.

Heat bolts were adjusted so that the gap width of the casting die was 0.5 mm at a portion 30 mm or less distant from the end in the width direction of the film and 1 mm at the other portion. Water of 80° C. was flown as a cooling water inside the touch roller. The line pressure of the touch roller against the first cooling roller was set to 14.7 N/cm. Further, the film was introduced into a tenter, stretched at 160° C. by 1.3 times in the transverse direction, and cooled to 30° C. while being relaxed by 3% in the transverse direction. Then the film was released from the clips and the clip holding sections were trimmed off. Both ends of the film being knurled to a width of 10 mm and a height of 5 μm, the film was wound around the core at a winding tension of 220 N/m and a taper of 40%. The extrusion amount and pulling rate were adjusted so that the film thickness was 80 μm, and the finished film was slit to give a width of 2500 mm and wound to a film roll. Herein, the film roll length was 2500 m.

### (Preparation of Polarizing Plate)

The resulting first and second protective films were subjected to alkaline saponification under the following conditions, followed by preparation of a polarizing plate.

### (Alkaline Saponification)

| | | | |
|---|---|---|---|
| Saponification process: | 2 mol/L of sodium | 60° C. | 90 seconds |
| | hydroxide | | |
| Water washing process: | Water | 30° C. | 45 seconds |
| Neutralization process: | 10% by weight HCl | 30° C. | 45 seconds |
| Water washing process: | Water | 30° C. | 45 seconds |

After saponification, the film was subjected to water washing, neutralization, water washing in that order, and dried at 80° C.

### <Preparation of Polarizer>

A 120 μm thick long length polyvinyl alcohol film was immersed in 100 parts by mass of an aqueous solution containing 1 part by mass of iodine and 4 parts by mass of boric acid, and stretched at 50° C. in the conveyance direction by a magnification of 5 to prepare a polarizer.

The protective film obtained above was laminated on one surface of the polarizer so that the cellulose ester resin layer (A) of the protective film faced the polarizer, and the second protective film on the other surface of the polarizer, each protective film being adhered to the polarizer surface through a 5% aqueous solution of a completely saponified polyvinyl alcohol as an adhesive, and dried. Thus, a polarizing Plate 101 was prepared.

### <Preparation of Polarizing Plate 102 Through 120>

Polarizing Plates 102 through 120 were prepared in the same manner as Polarizing Plate 101, except that the content of the cellulose ester resin and acryl resin in the cellulose ester resin layer (A) of the first protective film, the content of the cellulose ester resin and acryl resin in the cellulose ester resin layer (B) of the first protective film, and the content or kinds of the retardation adjusting agent in the second protective film were changed as shown in Table 3.

### <<Evaluation>>

### (Preparation of Liquid Crystal Display)

The polarizing plate on the viewer side provided in, a VA type liquid crystal display, a 15 type Display VL-150SD manufactured by Fujitsu Co., Ltd. were peeled off, and each of the above-obtained polarizing plate was laminated on the glass surface of the liquid crystal cell (VA type). Thus, a liquid crystal display was prepared. Herein, the lamination of the polarizing plate was carried out so that the absorption axis was in the direction same as that of the polarizing plate originally provided.

### (Measurement of Retardation)

The retardation of the second protective film was measured according to the following procedures.

The retardation was measured at 23° C. and at 55% RH with light having a wavelength of 590 nm, employing KOBRA-21ADH produced by Oji Keisoku Kiki Co., Ltd. The retardation in the thickness direction was calculated employing the refractive index value of each layer measured through an Abbe's refractometer.

Ro=(nx−ny)×d

Rt=[(nx+ny)/2−nz]×d

wherein nx represents the refractive index in plain in the delayed phase axis of the film; ny represents the refractive index in plain in the direction perpendicular to the delayed phase axis of the film; nz represents the refractive index in the thickness direction of the film; and d represents the thickness (nm) of the film.

### (Saponification Property)

A polyvinyl alcohol film having a thickness of 120 μm was immersed in an aqueous solution composed of 1 part by mass of iodine, 2 parts by mass of potassium iodide and 4 parts by mass of boric acid, and stretched at 50° C. by a magnification of 4 to prepare a polarizer.

The protective film sample was alkali-treated at 40° C. for 60 minutes in a 2.5N sodium hydroxide aqueous solution, washed with water and dried. Thus, the surface of the protective film sample was subjected to saponification treatment.

The resulting protective film was adhered to both surfaces of the polarizer through an aqueous solution containing 5% of a completely saponified polyvinyl alcohol as an adhesive so that the alkali-treated surface of the protective film faced the polarizer surfaces. Thus, a polarizing plate for evaluation with a protective film was prepared.

Subsequently, the polarizing plate for evaluation was stored at 80° C. and at 80% RH for 1000 hours. After that, adhesion at the interface between the polarizer and the protective film was observed and evaluated according to the following criteria.

A: No peeling was observed.
B: A slight peeling was observed, which was not practically problematic.
C: Some peeling was observed, which was practically problematic.
D: Apparent peeling occurred.

Rankings A and B were judged as excellent in saponification property without any practical problem.

### (Evaluation of Cloudy Unevenness)

The cloudy unevenness is defect that cloudy unevenness which appears blurry occurs on the screen of a liquid crystal display, and is likely to be observed when white is displayed on the screen. The cloudy unevenness is difficult to be observed in a liquid crystal display immediately after manufacture, however, it is likely to occur in a liquid crystal display after long term aging. Each of the polarizing plates prepared above was stored at 80° C. for 30 days (conditions corresponding to accelerated aging). Separately, each of the polarizing plates prepared above was stored at 50° C. for 30 days (under less accelerated aging). Employing the stored polarizing plate, a liquid crystal display was prepared and when white was displayed on the entire screen of the liquid crystal display, the cloudy unevenness occurring on the screen of the display was visually observed. The evaluation was carried out in terms of the area (%) in which cloudy unevenness occurred relative to the entire screen area.

### (Evaluation of Viewing Angle)

The viewing angle of the liquid crystal display was determined at 23° C. and at 55% RH employing EZ-Contrast 160D produced by ELDIM Co., Ltd.

### <Viewing Angle>

A: Viewing angle was extremely wide.
B: Viewing angle was wide.
C: Viewing angle was narrow.
D: Viewing angle was extremely narrow.

TABLE 3

First Protective Film

| | Acryl Resin | | Cellulose Ester | | | | | | |
|---|---|---|---|---|---|---|---|---|---|
| | Layer (B) | | Resin Layer (A) | | | | | | |
| | | Cellulose | Cellulose | | Second Protective Film | | | | |
| | Acryl | Ester | Ester | Acryl | Retardation Adjusting Agent | | | | |
| | Resin | Resin | Resin | Resin | | Content | | | |
| Polarizing | (Parts by | (Parts by | (Parts by | (Parts by | | (Parts by | Ro | Rth | |
| plate No. | Mass) | Mass) | Mass) | Mass) | Kinds | Mass) | (nm) | (nm) | Remarks |
| 101 | 55 | 45 | 80 | 20 | *Ex. Compd. I-(2) | 6 | 60 | 250 | Inv. |
| 102 | 75 | 25 | 80 | 20 | Ex. Compd. I-(2) | 6 | 60 | 250 | Inv. |
| 103 | 75 | 25 | 80 | 20 | — | — | 5 | 20 | Comp. |
| 104 | 99 | 1 | 80 | 20 | Ex. Compd. I-(2) | 6 | 60 | 250 | Inv. |
| 105 | 65 | 35 | 99 | 1 | Ex. Compd. I-(2) | 6 | 60 | 250 | Inv. |
| 106 | 65 | 35 | 55 | 45 | Ex. Compd. I-(2) | 6 | 60 | 250 | Inv. |
| 107 | 65 | 35 | 40 | 60 | Ex. Compd. I-(2) | 6 | 60 | 250 | Comp. |
| 108 | 65 | 35 | 80 | 20 | Ex. Compd. I-(2) | 6 | 60 | 250 | Inv. |
| 109 | 40 | 60 | 80 | 20 | Ex. Compd. I-(2) | 6 | 60 | 250 | Comp. |
| 110 | 100 | — | 100 | — | Ex. Compd. I-(2) | 6 | 60 | 250 | Comp. |
| 111 | 55 | 45 | 80 | 20 | Ex. Compd. A-12 | 8 | 60 | 240 | Inv. |
| 112 | 75 | 25 | 80 | 20 | Ex. Compd. A-12 | 8 | 60 | 240 | Inv. |
| 113 | 75 | 25 | 80 | 20 | — | — | 6 | 30 | Comp. |
| 114 | 99 | 1 | 80 | 20 | Ex. Compd. A-12 | 8 | 60 | 240 | Inv. |
| 115 | 65 | 35 | 99 | 1 | Ex. Compd. A-12 | 8 | 60 | 240 | Inv. |
| 116 | 65 | 35 | 55 | 45 | Ex. Compd. A-12 | 8 | 60 | 240 | Inv. |
| 117 | 65 | 35 | 30 | 70 | Ex. Compd. A-12 | 8 | 60 | 240 | Comp. |
| 118 | 65 | 35 | 80 | 20 | Ex. Compd. A-12 | 8 | 60 | 240 | Inv. |
| 119 | 100 | — | 80 | 20 | Ex. Compd. A-12 | 8 | 60 | 240 | Comp. |
| 120 | 100 | — | 100 | — | Ex. Compd. A-12 | 8 | 60 | 240 | Comp. |

Evaluation

| Polarizing | | Cloudy | Cloudy | | |
|---|---|---|---|---|---|
| plate | Saponification | Unevenness | Unevenness | Viewing | |
| No. | Property | (80° C., 30 days) | (50° C., 30 days) | Angle | Remarks |
| 101 | A | 0 | 0 | A | Inv. |
| 102 | A | 0 | 0 | A | Inv. |
| 103 | A | 0 | 0 | D | Comp. |
| 104 | A | 0 | 0 | A | Inv. |
| 105 | A | 0 | 0 | A | Inv. |
| 106 | B | 0 | 0 | A | Inv. |
| 107 | D | 12 | 6 | B | Comp. |
| 108 | A | 0 | 0 | A | Inv. |
| 109 | A | 20 | 11 | B | Comp. |
| 110 | A | 12 | 5 | B | Comp. |
| 111 | A | 0 | 0 | A | Inv. |
| 112 | A | 0 | 0 | A | Inv. |
| 113 | A | 0 | 0 | D | Comp. |
| 114 | A | 0 | 0 | A | Inv. |
| 115 | A | 0 | 0 | A | Inv. |
| 116 | B | 0 | 0 | A | Inv. |
| 117 | D | 12 | 5 | B | Comp. |
| 118 | A | 0 | 0 | A | Inv. |
| 119 | A | 12 | 6 | B | Comp. |
| 120 | A | 12 | 6 | B | Comp. |

Inv.: Inventive,
Comp.: Comparative
*Ex. Compd.: Exemplified Compound

As is apparent from Table 3, the inventive polarizing plates 101, 102, 104 through 106, 108, 111, 112, 114 through 116, and 118 are excellent polarizing plates with excellent saponification property without occurrence of cloudy unevenness as compared with the comparative polarizing plates.

Particularly, the comparative polarizing plates 103 and 113 were low in Ro and Rth and narrow in viewing angle, since the second protective film did not contain a retardation adjusting agent.

### Example 2

### Preparation of Polarizing Plates 201 Through 209 and 211 Through 215

Polarizing Plates 201 through 209 and 211 through 215 were prepared in the same manner as in inventive polarizing plate 101 in the invention of Example 1 above, except that as shown in Table 4, cellulose ester resins (a degree of a propionyl substitution being varied), acryl resins (A-AC-1 and A-AC-2, and B-AC1 through B-AC-3) and resins such as CAB, PMMA, Polystyrene, polyester, polycycloolefin and polycarbonate were used in the first protective film and kinds or addition amount of the retardation adjusting agent were varied in the second protective film.

Ones, in which the retardation adjusting agent was added to the second protective film, had an Ro of 50±5 nm and an Rth of 240±10 nm.

### (Abbreviated Material Names in Table 4)

### CAP: Cellulose Acetate Propionate

CAB: Cellulose Acetate Butyrate (with a degree of acetyl substitution of 1.0 and a degree of butyryl substitution of 1.7)
PMMA: Polymethyl methacrylate (Dianal BR83 produced by Mitsubishi Rayon Co., Ltd.)
Polystyrene: Daylark D322 (produced by Nova Chemicals Co., Ltd.)
Polyester: ECDEL 9966 (produced by Eastman Chemicals Co., Ltd.)
Polycycloolefin: ZEONOR 1420R (produced by Nippon Zeon Co., Ltd.)
Polyca: Polycarbonate resin Panlite (produced by Tejin Kasei Co., Ltd.)

### <Preparation of Polarizing Plate 210>

Only the second protective film was manufactured according to the solution casting method as described below, and combined with the first protective film manufactured according to the melt casting method as shown in Table 4, thereby preparing a polarizing plate.

### (Microparticle Dispersion)

| | |
|---|---|
| Microparticles | 11 parts by mass |
| (Aerosil R972V, manufactured by | |
| Nippon Aerosil Co. Ltd.) | |
| Ethanol | 89 parts by mass |

The above composition, after having been mixed by a dissolver for 50 minutes, was homogenized by use of a Manton-Gaulin homogenizer to obtain a microparticle dispersion.

### (In-Line Additive Solution)

Cellulose ester A was added into a dissolution tank charged with methylene chloride, completely dissolved with heating, and filtered through Azumi filter paper No. 244 manufactured by Azumi Filter Paper Co., Ltd.

The resulting cellulose ester solution after filtration was gradually added with the microparticle dispersion while sufficiently stirring. Further, dispersion was per formed employing an attritor so that the secondary particle size reached a predetermined size. The resulting dispersion was filtered through FINEMET NF manufactured by Nippon Seisen Co., Ltd., whereby an in-line additive solution was prepared.

| | |
|---|---|
| Methylene chloride | 99 parts by mass |
| Cellulose acetate propionate | 4 parts by mass |
| (with an acetyl substitution degree of 1.90, | |
| a propionyl substitution degree of 0.80, a total | |
| acyl substitution degree of 2.70, and with a | |
| number average molecular weight of 70000) | |
| Microparticle dispersion | 11 parts by mass |

A main dope solution having the following composition was prepared. Firstly, methylene chloride and ethanol were added into a pressure dissolution tank. Cellulose ester A was added to the solvent mixture of the pressure dissolution tank with stirring, completely dissolved while heating with stirring, and filtered by use of Azumi Filter Paper No. 244. manufactured by Azumi Filter Paper Co., Ltd., whereby a main dope solution was prepared.

### <Composition of Main Dope>

| | |
|---|---|
| Methylene chloride | 380 parts by mass |
| Ethanol | 70 parts by mass |
| Cellulose acetate propionate | 100 parts by mass |
| (with an acetyl substitution degree of 1.90, | |
| a propionyl substitution degree of 0.80, a total | |
| acyl substitution degree of 2.70, and with a | |
| number average molecular weight of 70000) | |
| Trimethylolpropane tribenzoate | 10 parts by mass |
| Retardation adjusting agent | 8 parts by mass |
| (Exemplified Compound A-12) | |

The above composition was incorporated into a closed vessel, completely dissolved while heating and stirring, and filtered by use of Azumi Filter Paper No. 24 manufactured by Azumi Filter Paper Co., Ltd., whereby a dope solution was prepared.

The dope solution was filtered in a casting line through FINEMET NF, manufactured by Nippon Seisen Co., Ltd. The inline additive solution was filtered in an inline additive solution line through FINEMET NF, manufactured by Nippon Seisen Co., Ltd. Two parts by mass of the filtered inline additive solution was added to 100 parts by mass of the filtered dope solution, sufficiently mixed in an inline mixer (Toray static type inline mixer, Hi-Mixer SWJ), and uniformly cast at a temperature of 35° C. on a stainless band support with a width of 2 m of a belt casting apparatus. The solvent of the resulting cast web on the stainless band support being evaporated to give a residual solvent amount of 120%, thee cast web was peeled from the stainless belt support. The peeled cellulose ester web, after evaporating the solvent at 50° C., was slit into a width of 1.65 m, then stretched in the transverse direction at 160° C. at a stretching magnification of 1.4 times in a tenter, and further stretched in the conveyance direction with tension applied at a stretching magnification of 1.0 (0%) so that the web did not contract. The web was dried while being transported with plural number of rolls in a drying zone of 120° C., slit into a width of 1500 mm, and subjected to a knurling processing to form knurls with a width of 15 mm and an average height of 10 μm on both ends of the web, whereby a film with an average thickness of 80 μm was prepared. The roll length of the film was 2500 m.

The resulting polarizing plates were evaluated in the same manner as in Example 1, and the results were shown in Table 5.

TABLE 4

| | First Protective Film | | | | | | | | | | | | | | |
|---|---|---|---|---|---|---|---|---|---|---|---|---|---|---|---|
| | Acryl Resin Layer (B) | | | | | | | Cellulose Ester Resin Layer (A) | | | | | | | |
| | Acryl Resin | | Cellulose Ester Resin | | | | | Cellulose Ester Resin | | | | Acryl Resin | | | |
| Polarizing | | Parts | | | | Parts | | | | | Parts | | Parts | | |
| plate | | by | | | | by | a) | | | | by | | by | a) | |
| No. | Kinds | Mass | Kinds | b) | c) | Mass | μm | Kinds | b) | c) | Mass | Kinds | Mass | μm | Remarks |
| 201 | A-AC1 | 70 | CAP | 2.7 | 2.6 | 30 | 16 | CAP | 2.8 | 1.2 | 85 | B-AC1 | 15 | 64 | Inv. |
| 202 | A-AC1 | 70 | CAP | 2.7 | 2.6 | 30 | 16 | CAP | 2.8 | 1.2 | 85 | B-AC1 | 15 | 64 | Inv. |
| 203 | A-AC1 | 70 | CAP | 2.7 | 2.6 | 30 | 16 | CAP | 2.8 | 1.2 | 85 | B-AC1 | 15 | 64 | Inv. |
| 204 | A-AC1 | 70 | CAP | 2.7 | 2.6 | 30 | 16 | CAP | 2.8 | 1.2 | 85 | B-AC1 | 15 | 64 | Inv. |
| 205 | A-AC1 | 60 | CAP | 2.7 | 2.6 | 40 | 16 | CAP | 2.8 | 1.2 | 70 | B-AC1 | 30 | 64 | Inv. |
| 206 | A-AC1 | 90 | CAP | 2.7 | 2.6 | 10 | 16 | CAP | 2.8 | 1.2 | 95 | B-AC1 | 5 | 64 | Inv. |
| 207 | A-AC1 | 70 | CAP | 2.7 | 2.6 | 30 | 16 | CAP | 2.7 | 2.6 | 70 | B-AC3 | 30 | 64 | Inv. |
| 208 | A-AC2 | 70 | CAP | 2.7 | 2.6 | 30 | 16 | CAP | 2.8 | 1.2 | 85 | B-AC2 | 15 | 64 | Inv. |
| 209 | A-AC1 | 55 | CAP | 2.7 | 2.6 | 45 | 16 | CAP | 2.8 | 1.2 | 55 | B-AC1 | 45 | 64 | Inv. |
| 210 | A-AC1 | 70 | CAP | 2.7 | 2.6 | 30 | 16 | CAP | 2.8 | 1.2 | 85 | B-AC1 | 15 | 64 | Inv. |
| 211 | A-AC1 | 70 | CAP | 2.7 | 2.5 | 30 | 64 | CAP | 2.8 | 1.5 | 85 | B-AC1 | 15 | 16 | Inv. |
| 212 | A-AC1 | 70 | CAP | 2.7 | 2.5 | 30 | 40 | CAP | 2.8 | 1.5 | 85 | B-AC1 | 15 | 40 | Inv. |
| 213 | PMMA | 100 | — | — | — | — | 33.6 | CAB | 2.7 | — | 100 | — | — | 46.4 | Comp. |
| 214 | Polystyrene | 100 | — | — | — | — | 40 | Polycycloolefin | | | 100 | — | — | 40 | Comp. |
| 215 | Polyester | 100 | — | — | — | — | 12 | Polyca | | | 100 | — | — | 68 | Comp. |

Second Protective Film

| | |
|---|---|
| Polarizing | Retardation Adjusting Agent |

| plate No. | Kinds | *Parts by Mass | Casting Method | Remarks |
|---|---|---|---|---|
| 201 | Exemplified Compound A-12 | 8 | Melt Casting | Inv. |
| 202 | Exemplified Compound I-(2) | 6 | Melt Casting | Inv. |
| 203 | Exemplified Compound (41′) | 5 | Melt Casting | Inv. |
| 204 | Exemplified Compound (1)a | 8 | Melt Casting | Inv. |
| 205 | Exemplified Compound A-12 | 8 | Melt Casting | Inv. |
| 206 | Exemplified Compound A-12 | 8 | Melt Casting | Inv. |
| 207 | Exemplified Compound A-12 | 8 | Melt Casting | Inv. |
| 208 | Exemplified Compound A-12 | 8 | Melt Casting | Inv. |
| 209 | Exemplified Compound A-12 | 8 | Melt Casting | Inv. |
| 210 | Exemplified Compound A-12 | 8 | Solution Casting | Inv. |
| 211 | Exemplified Compound A-12 | 8 | Melt Casting | Inv. |
| 212 | Exemplified Compound A-12 | 8 | Melt Casting | Inv. |
| 213 | Exemplified Compound A-12 | 8 | Melt Casting | Comp. |
| 214 | Exemplified Compound A-12 | 8 | Melt Casting | Comp. |
| 215 | Exemplified Compound A-12 | 8 | Melt Casting | Comp. |

Inv.: Inventive,
Comp.: Comparative
a) Thickness,
b) Total Substitution Degree
c) Pr Substitution Degree
*The content is an amount based on 100 parts by mass of cellulose ester.

TABLE 5

| Polarizing | Saponification | Cloudy Unevenness | Cloudy Unevenness | Viewing | |
|---|---|---|---|---|---|
| plate No. | Property | (80° C. for 30 days) | (50° C. for 30 days) | Angle | Remarks |
| 201 | A | 0 | 0 | A | Inv. |
| 202 | A | 0 | 0 | A | Inv. |
| 203 | A | 0 | 0 | A | Inv. |
| 204 | A | 0 | 0 | A | Inv. |
| 205 | A | 0 | 0 | A | Inv. |
| 206 | A | 0 | 0 | A | Inv. |
| 207 | A | 0 | 0 | A | Inv. |
| 208 | A | 0 | 0 | A | Inv. |
| 209 | B | 0 | 0 | B | Inv. |
| 210 | A | 2 | 1 | B | Inv. |
| 211 | A | 0 | 0 | A | Inv. |
| 212 | A | 0 | 0 | A | Inv. |
| 213 | D | 12 | 7 | B | Comp. |
| 214 | D | 12 | 6 | B | Comp. |
| 215 | D | 12 | 8 | B | Comp. |

Inv.: Inventive,
Comp.: Comparative

As is apparent from Table 5, the inventive polarizing plates 201 through 209 and the inventive polarizing plates 211 and 211 provide a large viewing angle and do not produce cloudy unevenness.

The polarizing plate 210, in which the second protective film was prepared according to a solution casting method, produces slight cloudy unevenness but provides a large viewing angle, which is practically non-problematic.

### Example 3

The following hard coat layer was coated on the acryl resin layer (B) of the first protective film prepared in Example 2. Thus, a first protective film with a hard coat layer was prepared. A polarizing plate was prepared employing the first protective film with a hard coat layer and the second protective film prepared in Example 2 and installed in a liquid crystal display.

It has proved that the inventive polarizing plate having the following hard coat layer provides a surface pencil hardness of 4H, a large viewing angle and high scratch resistance without producing cloudy unevenness.

### <Hard Coat Layer>

The following hard coat layer composition was coated on the acryl resin layer (B) of the first protective film and dried 80° C. for one minute to give a dry thickness of 3.5 μm.

Subsequently, the hard coat layer was cured at 150 mJ/cm², employing a high pressure mercury lamp (80 W), thereby prepare a hard coat film with a hard coat layer. The refractive index of the hard coat layer was 1.50.

### <Hard Coat Layer Composition>

| | |
|---|---|
| Dipentaerithritol hexaacrylate | 108 parts by mass |
| (containing about 20% of di- or polymer) | |
| IRGACURE 184 (produced by Ciba Japan Co., Ltd.) | 2 parts by mass |
| Propylene glycol monomethyl ether | 180 parts by mass |
| Ethyl acetate | 120 parts by mass |

### EXPLANATION OF SYMBOLS

1. Extruder
2. Filter
4. Dice
5. Rotation Support (First Cooling Roller)
6. Pressing Support (Touch Roller)
7. Rotation Support (Second Cooling Roller)
8. Rotation Support (Third Cooling Roller)
9. Peeling Roller
10. Cellulose Ester Film
11, 13, 14, 15 Transporting rollers
12 Stretching Device
16 Wind-up Device
51 Lip Adjusting Bolt
52 Extrusion Section A
53 Extrusion Section B
54 Extrusion Section C
55 Manifold A
56 Manifold B
57 Manifold C
58 Feed Block
59 Chalk Bar
60 Adjusting Bolt

1. A polarizing plate comprising a first protective film, a second protective film and a polarizer sandwiched between the first and second protective films,
wherein the first protective film is a laminated film composed of a cellulose ester resin layer (A) and an acryl resin layer (B), the cellulose ester resin layer (A) being a layer containing from 55 to 99% by mass of a first cellulose ester resin and from 1 to 45% by mass of a first acryl resin, provided that the total content of the first cellulose ester resin and the first acryl resin in the cellulose ester resin layer (A) is 100% by mass, and the acryl resin layer (B) being a layer containing from 1 to 45% by mass of a second cellulose ester resin and from 55 to 99% by mass of a second acryl resin, provided that the total content of the second cellulose ester resin and the second acryl resin in the cellulose ester resin layer (B) is 100% by mass, and
wherein the second protective film contains a third cellulose ester resin and a retardation adjusting agent, the cellulose ester resin layer (A) facing the polarizer.

2. A liquid crystal display, wherein the polarizing plate of claim 1 is provided on a liquid crystal cell, so that the second protective film of the polarizing plate faces the liquid crystal cell.

3. A method of manufacturing a protective film for a polarizing plate wherein the first and second protective films of the polarizing plate of claim 1 are manufactured according to a melt casting method.

4. The polarizing plate of claim 1, wherein the acryl resin layer (B) contains from 1 to 40% by mass of the second cellulose ester resin and from 60 to 99% by mass of the second acryl resin, and the cellulose ester resin layer (A) contains from 60 to 99% by mass of the first cellulose ester resin and from 1 to 40% by mass of the first acryl resin.

5. The polarizing plate of claim 1, wherein the first acryl resin includes a methacryl resin comprising 50 to 99% by mass of a methyl methacrylate unit and 1 to 50% by mass of another copolymerizable monomer unit.

6. The polarizing plate of claim 1, wherein the second acryl resin includes a methacryl resin comprising 50 to 99% by mass of a methyl methacrylate unit and 1 to 50% by mass of another copolymerizable monomer unit.

7. The polarizing plate of claim 1, wherein the first cellulose ester resin includes cellulose acetate propionate.

8. The polarizing plate of claim 1, wherein the second cellulose ester resin includes cellulose acetate propionate.

9. The polarizing plate of claim 1, wherein the third cellulose ester resin includes cellulose acetate propionate.

10. The polarizing plate of claim 1, wherein the second protective film contains the retardation adjusting agent in an amount of from 1.0 to 30 parts by mass, based on the 100 parts by mass of the cellulose ester.

11. The polarizing plate of claim 1, wherein the retardation adjusting agent is selected from a compound represented by formulae (1), (2), (3), (4), and (5): 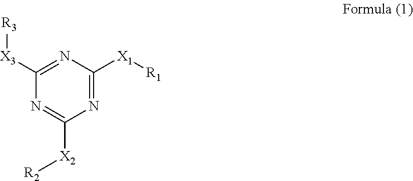
wherein R₁, R₂ and R₃ independently represent an aromatic ring group or a heterocyclic ring group; X₁ represents a single bond, —NR₄—, —O— or —S—; X₂ is a single bond, —NR₅—, —O— or —S—; X₃ is a single bond, —NR₆—, —O— or —S—; and R₄, R₅ and R₆ independently represent a hydrogen atom, a substituted or unsubstituted alkyl group, a substituted or unsubstituted alkenyl group, a substituted or unsubstituted aryl group or a substituted or unsubstituted heterocyclic ring group;
AR₁-L₁-AR₂ Formula (2)
wherein AR₁ and AR₂ independently represent an aromatic group; and L₁ represents a divalent linkage group selected from the group consisting of an alkylene group, an alkynylene group, an alkynylene group, —O—, —CO— and a combination thereof; 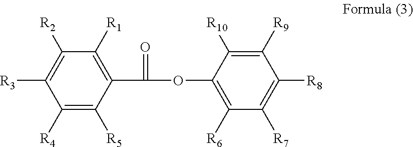
wherein R₁ through R₇, R₉ and R₁₀ independently represent a hydrogen atom or a substituent, provided that at least one of R₁ through R₅ is an electron donating group; and R₈ represents a hydrogen atom, an alkyl group having a carbon atom number of from 1 to 4, an alkenyl group having a carbon atom number of from 2 to 6, an alkynyl group having a carbon atom number of from 2 to 6, an aryl group having a carbon atom number of from 6 to 12, an alkoxy group having a carbon atom number of from 1 to 12, an aryloxy group having a carbon atom number of from 6 to 12, an alkoxycarbonyl group having a carbon atom number of from 2 to 12, an acylamino group having a carbon atom number of from 2 to 12, a cyano group or a halogen atom;
AR₁-L₁-(AR₂-L₂)n-AR₃ Formula (4)
wherein AR₁ and AR₃ independently represent an aryl group, an arylcarbonyl group or an aromatic heterocyclic ring group; AR₂ represents an arylene group or an aromatic heterocyclic ring group; L₁ and L₂ independently represent a single bond or a divalent linkage group; and n is an integer of 3 or more, provided that AR₂ and L₂ may be the same or different;
AR₁-L₁-X-L₂-AR₂ Formula (5)
wherein AR₁ and AR₂ independently represent an aryl group or an aromatic heterocyclic ring group; L₁ and L₂ independently represent —C(═O)O— or —C(═O)NR— in which R represents a hydrogen atom or an alkyl group; and X represents a divalent linkage group represented by the following formula (5-A) or (5-B), 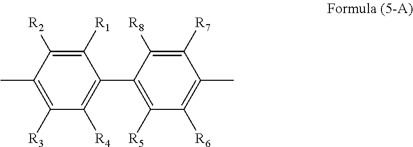
wherein R₁, R₂, R₃, R₄, R₅, R₆, R₇ and R₈ independently represent a hydrogen atom or a substituent, 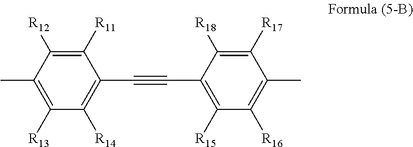
wherein R₁₁, R₁₂, R₁₂, R₁₄, R₁₅, R₁₆, R₁₇ and R₁₈ independently represent a hydrogen atom or a substituent.
